(19) United States
(12) Patent Application Publication
(10) Pub. No.: US 2026/0136007 A1
(43) Pub. Date: May 14, 2026

(54) ADAPTIVE FILTERING UNIT FOR ADAPTIVE LOOP FILTER IN VIDEO CODING

(71) Applicants: Douyin Vision Co., Ltd., Beijing (CN); Bytedance Inc., Los Angeles, CA (US)

(72) Inventors: Wenbin YIN, Beijing (CN); Kai ZHANG, San Diego, CA (US); Li ZHANG, San Diego, CA (US)

(21) Appl. No.: 19/445,256

(22) Filed: Jan. 9, 2026

Related U.S. Application Data
(63) Continuation of application No. PCT/CN2024/104591, filed on Jul. 10, 2024.

(30) Foreign Application Priority Data
Jul. 10, 2023 (WO) PCT/CN2023/106522

(51) Int. Cl. H04N 19/117; H04N 19/176; H04N 19/196; H04N 19/82

(52) U.S. Cl. CPC H04N 19/117; H04N 19/176; H04N 19/196; H04N 19/82

(57) ABSTRACT

A mechanism for processing video data is disclosed. The mechanism includes to change at least one of a shape of a filtering unit and a size of the filtering unit in different sequences, different pictures, different slices, or different sub-pictures. A conversion can then be performed between a visual media data and a bitstream based on the filtering unit.

### CROSS-REFERENCE TO RELATED APPLICATIONS

This is a continuation of International Patent Application No. PCT/CN2024/104591 filed on Jul. 10, 2024, which claims the benefit of International Patent Application PCT/CN2023/106522 filed on Jul. 10, 2023. All the aforementioned patent applications are hereby incorporated by reference in their entireties.

### TECHNICAL FIELD

This patent document relates to generation, storage, and consumption of digital audio video media information in a file format.

### BACKGROUND

Digital video accounts for the largest bandwidth used on the Internet and other digital communication networks. As the number of connected user devices capable of receiving and displaying video increases, the bandwidth demand for digital video usage is likely to continue to grow.

### SUMMARY

A first aspect relates to a method for processing video data comprising: determining to change at least one of a shape of a filtering unit and a size of the filtering unit in different sequences, different pictures, different slices, or different sub-pictures; and performing a conversion between a visual media data and a bitstream based on the filtering unit.

Optionally, in any of the preceding aspects, another implementation of the aspect provides that the filtering unit is a luma-adaptive loop filter (ALF), a cross component ALF (CCALF), or a chroma-ALF.

Optionally, in any of the preceding aspects, another implementation of the aspect provides that the filtering unit which is changed is designated an adaptive filtering unit.

Optionally, in any of the preceding aspects, another implementation of the aspect provides that at least one of the shape of the filtering unit and the size of the filtering unit depend on a color component or a color format.

Optionally, in any of the preceding aspects, another implementation of the aspect provides that at least one of the shape and the size are signaled using at least one syntax element (SE) in a sequence parameter set (SPS), a picture parameter set (PPS), a picture header, a slice header, or a coding tree unit (CTU).

Optionally, in any of the preceding aspects, another implementation of the aspect provides that the SE comprises an index reflecting at least one of the size of the filtering unit and the shape of the filtering unit.

Optionally, in any of the preceding aspects, another implementation of the aspect provides that the SE is coded or binarized as a flag, a fixed length code, an exponential Golomb (EG(x)) code, a unary code, a truncated unary code, or a truncated binary code, and wherein the SE is one of signed and unsigned.

Optionally, in any of the preceding aspects, another implementation of the aspect provides that the SE is coded using at least one context model or is bypass coded.

Optionally, in any of the preceding aspects, another implementation of the aspect provides that the SE is signaled in a conditional way.

Optionally, in any of the preceding aspects, another implementation of the aspect provides that the filtering unit which is changed is designated an adaptive filtering unit, and wherein the adaptive filtering unit is used for an adaptive loop filter (ALF).

Optionally, in any of the preceding aspects, another implementation of the aspect provides that the adaptive filtering unit is applied to different color components.

Optionally, in any of the preceding aspects, another implementation of the aspect provides that the adaptive filtering unit is only applied to luma components.

Optionally, in any of the preceding aspects, another implementation of the aspect provides that the adaptive filtering unit is only applied to chroma components.

Optionally, in any of the preceding aspects, another implementation of the aspect provides that the adaptive filtering unit is applied to both luma components and chroma components.

Optionally, in any of the preceding aspects, another implementation of the aspect provides that a size of the adaptive filtering unit depends on a size of at least one of a coding tree unit (CTU), a coding unit (CU), a transform unit (TU), and a prediction unit (PU).

Optionally, in any of the preceding aspects, another implementation of the aspect provides that a width of the adaptive filtering unit is upscaled from a width of the CTU, CU, TU, or PU by a factor (uw).

Optionally, in any of the preceding aspects, another implementation of the aspect provides that the factor is 2.

Optionally, in any of the preceding aspects, another implementation of the aspect provides that a height of the adaptive filtering unit is upscaled from a height of the CTU, CU, TU, or PU by a factor (uh).

Optionally, in any of the preceding aspects, another implementation of the aspect provides that the factor is 2.

Optionally, in any of the preceding aspects, another implementation of the aspect provides that a width of the adaptive filtering unit is downscaled from a width of the CTU, CU, TU, or PU by a factor (dw).

Optionally, in any of the preceding aspects, another implementation of the aspect provides that the factor is 0.5.

Optionally, in any of the preceding aspects, another implementation of the aspect provides that a height of the adaptive filtering unit is downscaled from a height of the CTU, CU, TU, or PU by a factor (dh).

Optionally, in any of the preceding aspects, another implementation of the aspect provides that the factor is 0.5.

Optionally, in any of the preceding aspects, another implementation of the aspect provides that a size of the adaptive filtering unit depends on one or more pre-defined values.

Optionally, in any of the preceding aspects, another implementation of the aspect provides that a width of the adaptive filtering unit comprises M, where M is one of 128, 256, and 512.

Optionally, in any of the preceding aspects, another implementation of the aspect provides that a height of the adaptive filtering unit comprises M, where M is one of 128, 256, and 512.

Optionally, in any of the preceding aspects, another implementation of the aspect provides that the adaptive filtering unit depends on a size of a picture, slice, or tile.

Optionally, in any of the preceding aspects, another implementation of the aspect provides that a size of the adaptive filtering unit is different for a picture, slice, or tile with a different size or shape.

Optionally, in any of the preceding aspects, another implementation of the aspect provides that a size of the adaptive filtering unit is equal for a picture, slice, or tile with a different size or shape.

Optionally, in any of the preceding aspects, another implementation of the aspect provides that a shape of the adaptive filtering unit is different for a picture, slice, or tile with a different size or shape.

Optionally, in any of the preceding aspects, another implementation of the aspect provides that a shape of the adaptive filtering unit is equal for a picture, slice, or tile with a different size or shape.

Optionally, in any of the preceding aspects, another implementation of the aspect provides that a shape of the adaptive filtering unit is one of a plurality of different shapes.

Optionally, in any of the preceding aspects, another implementation of the aspect provides that the shape is square.

Optionally, in any of the preceding aspects, another implementation of the aspect provides that the shape is diamond.

Optionally, in any of the preceding aspects, another implementation of the aspect provides that the shape is rectangle.

Optionally, in any of the preceding aspects, another implementation of the aspect provides that each adaptive filtering unit is selectively enabled or disabled.

Optionally, in any of the preceding aspects, another implementation of the aspect provides that an indication of whether each adaptive filtering unit is on or off is signaled in the bitstream, derived, or pre-defined.

Optionally, in any of the preceding aspects, another implementation of the aspect provides that an indication of whether a luma adaptive loop filter (ALF) is on or off is signaled in the bitstream, derived, or pre-defined for each luma-ALF filtering unit.

Optionally, in any of the preceding aspects, another implementation of the aspect provides that an indication of whether a chroma adaptive loop filter (ALF) is on or off is signaled in the bitstream, derived, or pre-defined for each chroma-ALF filtering unit.

Optionally, in any of the preceding aspects, another implementation of the aspect provides that filter parameters are shared within each filtering unit.

Optionally, in any of the preceding aspects, another implementation of the aspect provides that a parameter, a parameter set, or a parameter set index is signaled in the bitstream, derived, or pre-defined for each adaptive filtering unit.

Optionally, in any of the preceding aspects, another implementation of the aspect provides that a parameter set index is signaled in the bitstream, derived, or pre-defined for each luma ALF filtering unit, and wherein the parameter set index comprises an adaptation parameter set (APS) index.

Optionally, in any of the preceding aspects, another implementation of the aspect provides that a parameter index is signaled in the bitstream, derived, or pre-defined for each luma ALF filtering unit, and wherein the parameter index comprises a filter set index, a classifier index, or a clipping index.

Optionally, in any of the preceding aspects, another implementation of the aspect provides that a parameter set index is signaled in the bitstream, derived, or pre-defined for each chroma ALF filtering unit, and wherein the parameter set index comprises an adaptation parameter set (APS) index.

Optionally, in any of the preceding aspects, another implementation of the aspect provides that a parameter index is signaled in the bitstream, derived, or pre-defined for each chroma ALF filtering unit, and wherein the parameter index comprises a filter set index, a classifier index, or a clipping index.

Optionally, in any of the preceding aspects, another implementation of the aspect provides that a decision whether or not to reference a parameter is made for each adaptive filtering unit.

Optionally, in any of the preceding aspects, another implementation of the aspect provides that the decision is signaled in the bitstream, derived, or pre-defined for each filtering unit, and wherein the parameter comprises an adaptation parameter set (APS) index or a filter index.

Optionally, in any of the preceding aspects, another implementation of the aspect provides that one or more syntax elements (SEs) are signaled in the bitstream, derived, or pre-defined to indicate whether the adaptive filtering unit is applied to the ALF.

Optionally, in any of the preceding aspects, another implementation of the aspect provides that the one or more SEs are signaled in a sequence parameter set (SPS).

Optionally, in any of the preceding aspects, another implementation of the aspect provides that the one or more SEs are signaled in a sequence parameter set (SPS), a picture header, a slice header, an adaptation parameter set (APS), a coding tree unit (CTU), a coding unit (CU), a transform unit (TU), or a prediction unit (PU).

Optionally, in any of the preceding aspects, another implementation of the aspect provides that the filtering unit which is changed is designated an adaptive filtering unit, and wherein the adaptive filtering unit is used for a cross component adaptive loop filter (CCALF).

Optionally, in any of the preceding aspects, another implementation of the aspect provides that the adaptive filtering unit is applied to different color components.

Optionally, in any of the preceding aspects, another implementation of the aspect provides that the adaptive filtering unit is only applied to one of a blue difference chroma component (Cb) and a red difference chroma component (Cr).

Optionally, in any of the preceding aspects, another implementation of the aspect provides that the adaptive filtering unit is applied to both a blue difference chroma component (Cb) and a red difference chroma component (Cr).

Optionally, in any of the preceding aspects, another implementation of the aspect provides that a size of the adaptive filtering unit depends on a size of at least one of a coding tree unit (CTU), a coding unit (CU), a transform unit (TU), and a prediction unit (PU).

Optionally, in any of the preceding aspects, another implementation of the aspect provides that a width of the adaptive filtering unit is upscaled from a width of the CTU, CU, TU, or PU by a factor (uw).

Optionally, in any of the preceding aspects, another implementation of the aspect provides that the factor is 2.

Optionally, in any of the preceding aspects, another implementation of the aspect provides that a height of the adaptive filtering unit is upscaled from a height of the CTU, CU, TU, or PU by a factor (uh).

Optionally, in any of the preceding aspects, another implementation of the aspect provides that the factor is 2.

Optionally, in any of the preceding aspects, another implementation of the aspect provides that a width of the adaptive filtering unit is downscaled from a width of the CTU, CU, TU, or PU by a factor (dw).

Optionally, in any of the preceding aspects, another implementation of the aspect provides that the factor is 0.5.

Optionally, in any of the preceding aspects, another implementation of the aspect provides that a height of the adaptive filtering unit is downscaled from a height of the CTU, CU, TU, or PU by a factor (dh).

Optionally, in any of the preceding aspects, another implementation of the aspect provides that the factor is 0.5.

Optionally, in any of the preceding aspects, another implementation of the aspect provides that a size of the adaptive filtering unit depends on one or more pre-defined values.

Optionally, in any of the preceding aspects, another implementation of the aspect provides that a width of the adaptive filtering unit comprises M, where M is one of 128, 256, and 512.

Optionally, in any of the preceding aspects, another implementation of the aspect provides that a height of the adaptive filtering unit comprises M, where M is one of 128, 256, and 512.

Optionally, in any of the preceding aspects, another implementation of the aspect provides that the adaptive filtering unit depends on a size of a picture, slice, or tile.

Optionally, in any of the preceding aspects, another implementation of the aspect provides that a size of the adaptive filtering unit is different for a picture, slice, or tile with a different size or shape.

Optionally, in any of the preceding aspects, another implementation of the aspect provides that a size of the adaptive filtering unit is equal for a picture, slice, or tile with a different size or shape.

Optionally, in any of the preceding aspects, another implementation of the aspect provides that a shape of the adaptive filtering unit is different for a picture, slice, or tile with a different size or shape.

Optionally, in any of the preceding aspects, another implementation of the aspect provides that a shape of the adaptive filtering unit is equal for a picture, slice, or tile with a different size or shape.

Optionally, in any of the preceding aspects, another implementation of the aspect provides that a shape of the adaptive filtering unit is one of a plurality of different shapes.

Optionally, in any of the preceding aspects, another implementation of the aspect provides that the shape is square.

Optionally, in any of the preceding aspects, another implementation of the aspect provides that the shape is diamond.

Optionally, in any of the preceding aspects, another implementation of the aspect provides that the shape is rectangle.

Optionally, in any of the preceding aspects, another implementation of the aspect provides that each adaptive filtering unit is selectively enabled or disabled.

Optionally, in any of the preceding aspects, another implementation of the aspect provides that an indication of whether each adaptive filtering unit is on or off is signaled in the bitstream, derived, or pre-defined.

Optionally, in any of the preceding aspects, another implementation of the aspect provides that an indication of whether a blue difference chroma cross component adaptive loop filter (Cb-CCALF) is on or off is signaled in the bitstream, derived, or pre-defined for each Cb-CCALF filtering unit.

Optionally, in any of the preceding aspects, another implementation of the aspect provides that an indication of whether a red difference chroma cross component adaptive loop filter (Cr-CCALF) is on or off is signaled in the bitstream, derived, or pre-defined for each Cr-CCALF filtering unit.

Optionally, in any of the preceding aspects, another implementation of the aspect provides that filter parameters are shared within each filtering unit.

Optionally, in any of the preceding aspects, another implementation of the aspect provides that a parameter, a parameter set, or a parameter set index is signaled in the bitstream, derived, or pre-defined for each adaptive filtering unit.

Optionally, in any of the preceding aspects, another implementation of the aspect provides that a decision whether or not to reference a parameter is made for each adaptive filtering unit.

Optionally, in any of the preceding aspects, another implementation of the aspect provides that the decision is signaled in the bitstream, derived, or pre-defined for each filtering unit, and wherein the parameter comprises an adaptation parameter set (APS) index or a filter index.

Optionally, in any of the preceding aspects, another implementation of the aspect provides that one or more syntax elements (SEs) are signaled in the bitstream, derived, or pre-defined to indicate whether the adaptive filtering unit is applied to the CCALF.

Optionally, in any of the preceding aspects, another implementation of the aspect provides that the one or more SEs are signaled in a sequence parameter set (SPS).

Optionally, in any of the preceding aspects, another implementation of the aspect provides that the one or more SEs are signaled in a sequence parameter set (SPS), a picture header, a slice header, an adaptation parameter set (APS), a coding tree unit (CTU), a coding unit (CU), a transform unit (TU), or a prediction unit (PU).

Optionally, in any of the preceding aspects, another implementation of the aspect provides that the filtering unit which is changed is designated an adaptive filtering unit, and wherein the adaptive filtering unit is used for a sample adaptive offset (SAO) filter.

Optionally, in any of the preceding aspects, another implementation of the aspect provides that the adaptive filtering unit is applied to different color components.

Optionally, in any of the preceding aspects, another implementation of the aspect provides that the adaptive filtering unit is only applied to a luma component.

Optionally, in any of the preceding aspects, another implementation of the aspect provides that the adaptive filtering unit is only applied to a chroma component.

Optionally, in any of the preceding aspects, another implementation of the aspect provides that the adaptive filtering unit is applied to both a luma component and a chroma component.

Optionally, in any of the preceding aspects, another implementation of the aspect provides that a size of the adaptive filtering unit depends on a size of at least one of a coding tree unit (CTU), a coding unit (CU), a transform unit (TU), and a prediction unit (PU).

Optionally, in any of the preceding aspects, another implementation of the aspect provides that a width of the adaptive filtering unit is upscaled from a width of the CTU, CU, TU, or PU by a factor (uw).

Optionally, in any of the preceding aspects, another implementation of the aspect provides that the factor is 2.

Optionally, in any of the preceding aspects, another implementation of the aspect provides that a height of the adaptive filtering unit is upscaled from a height of the CTU, CU, TU, or PU by a factor (uh).

Optionally, in any of the preceding aspects, another implementation of the aspect provides that the factor is 2.

Optionally, in any of the preceding aspects, another implementation of the aspect provides that a width of the adaptive filtering unit is downscaled from a width of the CTU, CU, TU, or PU by a factor (dw).

Optionally, in any of the preceding aspects, another implementation of the aspect provides that the factor is 0.5.

Optionally, in any of the preceding aspects, another implementation of the aspect provides that a height of the adaptive filtering unit is downscaled from a height of the CTU, CU, TU, or PU by a factor (dh).

Optionally, in any of the preceding aspects, another implementation of the aspect provides that the factor is 0.5.

Optionally, in any of the preceding aspects, another implementation of the aspect provides that a size of the adaptive filtering unit depends on one or more pre-defined values.

Optionally, in any of the preceding aspects, another implementation of the aspect provides that a width of the adaptive filtering unit comprises M, where M is one of 128, 256, and 512.

Optionally, in any of the preceding aspects, another implementation of the aspect provides that a height of the adaptive filtering unit comprises M, where M is one of 128, 256, and 512.

Optionally, in any of the preceding aspects, another implementation of the aspect provides that the adaptive filtering unit depends on a size of a picture, slice, or tile.

Optionally, in any of the preceding aspects, another implementation of the aspect provides that a size of the adaptive filtering unit is different for a picture, slice, or tile with a different size or shape.

Optionally, in any of the preceding aspects, another implementation of the aspect provides that a size of the adaptive filtering unit is equal for a picture, slice, or tile with a different size or shape.

Optionally, in any of the preceding aspects, another implementation of the aspect provides that a shape of the adaptive filtering unit is different for a picture, slice, or tile with a different size or shape.

Optionally, in any of the preceding aspects, another implementation of the aspect provides that a shape of the adaptive filtering unit is equal for a picture, slice, or tile with a different size or shape.

Optionally, in any of the preceding aspects, another implementation of the aspect provides that a shape of the adaptive filtering unit is one of a plurality of different shapes.

Optionally, in any of the preceding aspects, another implementation of the aspect provides that the shape is square.

Optionally, in any of the preceding aspects, another implementation of the aspect provides that the shape is diamond.

Optionally, in any of the preceding aspects, another implementation of the aspect provides that the shape is rectangle.

Optionally, in any of the preceding aspects, another implementation of the aspect provides that each adaptive filtering unit is selectively enabled or disabled.

Optionally, in any of the preceding aspects, another implementation of the aspect provides that an indication of whether each adaptive filtering unit is on or off is signaled in the bitstream, derived, or pre-defined.

Optionally, in any of the preceding aspects, another implementation of the aspect provides that filter parameters are shared within each filtering unit.

Optionally, in any of the preceding aspects, another implementation of the aspect provides that a parameter, a parameter set, or a parameter set index is signaled in the bitstream, derived, or pre-defined for each adaptive filtering unit.

Optionally, in any of the preceding aspects, another implementation of the aspect provides that a decision whether or not to reference a parameter is made for each adaptive filtering unit.

Optionally, in any of the preceding aspects, another implementation of the aspect provides that the decision is signaled in the bitstream, derived, or pre-defined for each filtering unit, and wherein the parameter comprises a merge left or a merge top.

Optionally, in any of the preceding aspects, another implementation of the aspect provides that one or more syntax elements (SEs) are signaled in the bitstream, derived, or pre-defined to indicate whether the adaptive filtering unit is applied to the SAO filter.

Optionally, in any of the preceding aspects, another implementation of the aspect provides that the one or more SEs are signaled in a sequence parameter set (SPS).

Optionally, in any of the preceding aspects, another implementation of the aspect provides that the one or more SEs are signaled in a sequence parameter set (SPS), a picture header, a slice header, an adaptation parameter set (APS), a coding tree unit (CTU), a coding unit (CU), a transform unit (TU), or a prediction unit (PU).

Optionally, in any of the preceding aspects, another implementation of the aspect provides that the filtering unit which is changed is designated an adaptive filtering unit, and wherein the adaptive filtering unit is used for a cross component sample adaptive offset (CCSAO) filter.

Optionally, in any of the preceding aspects, another implementation of the aspect provides that the adaptive filtering unit is applied to different color components.

Optionally, in any of the preceding aspects, another implementation of the aspect provides that the adaptive filtering unit is only applied to a luma component.

Optionally, in any of the preceding aspects, another implementation of the aspect provides that the adaptive filtering unit is only applied to a chroma component.

Optionally, in any of the preceding aspects, another implementation of the aspect provides that the adaptive filtering unit is applied to both a luma component and a chroma component.

Optionally, in any of the preceding aspects, another implementation of the aspect provides that a size of the adaptive filtering unit depends on a size of at least one of a coding tree unit (CTU), a coding unit (CU), a transform unit (TU), and a prediction unit (PU).

Optionally, in any of the preceding aspects, another implementation of the aspect provides that a width of the adaptive filtering unit is upscaled from a width of the CTU, CU, TU, or PU by a factor (uw).

Optionally, in any of the preceding aspects, another implementation of the aspect provides that the factor is 2.

Optionally, in any of the preceding aspects, another implementation of the aspect provides that a height of the adaptive filtering unit is upscaled from a height of the CTU, CU, TU, or PU by a factor (uh).

Optionally, in any of the preceding aspects, another implementation of the aspect provides that the factor is 2.

Optionally, in any of the preceding aspects, another implementation of the aspect provides that a width of the adaptive filtering unit is downscaled from a width of the CTU, CU, TU, or PU by a factor (dw).

Optionally, in any of the preceding aspects, another implementation of the aspect provides that the factor is 0.5.

Optionally, in any of the preceding aspects, another implementation of the aspect provides that a height of the adaptive filtering unit is downscaled from a height of the CTU, CU, TU, or PU by a factor (dh).

Optionally, in any of the preceding aspects, another implementation of the aspect provides that the factor is 0.5.

Optionally, in any of the preceding aspects, another implementation of the aspect provides that a size of the adaptive filtering unit depends on one or more pre-defined values.

Optionally, in any of the preceding aspects, another implementation of the aspect provides that a width of the adaptive filtering unit comprises M, where M is one of 128, 256, and 512.

Optionally, in any of the preceding aspects, another implementation of the aspect provides that a height of the adaptive filtering unit comprises M, where M is one of 128, 256, and 512.

Optionally, in any of the preceding aspects, another implementation of the aspect provides that the adaptive filtering unit depends on a size of a picture, slice, or tile.

Optionally, in any of the preceding aspects, another implementation of the aspect provides that a size of the adaptive filtering unit is different for a picture, slice, or tile with a different size or shape.

Optionally, in any of the preceding aspects, another implementation of the aspect provides that a size of the adaptive filtering unit is equal for a picture, slice, or tile with a different size or shape.

Optionally, in any of the preceding aspects, another implementation of the aspect provides that a shape of the adaptive filtering unit is different for a picture, slice, or tile with a different size or shape.

Optionally, in any of the preceding aspects, another implementation of the aspect provides that a shape of the adaptive filtering unit is equal for a picture, slice, or tile with a different size or shape.

Optionally, in any of the preceding aspects, another implementation of the aspect provides that a shape of the adaptive filtering unit is one of a plurality of different shapes.

Optionally, in any of the preceding aspects, another implementation of the aspect provides that the shape is square.

Optionally, in any of the preceding aspects, another implementation of the aspect provides that the shape is diamond.

Optionally, in any of the preceding aspects, another implementation of the aspect provides that the shape is rectangle.

Optionally, in any of the preceding aspects, another implementation of the aspect provides that each adaptive filtering unit is selectively enabled or disabled.

Optionally, in any of the preceding aspects, another implementation of the aspect provides that an indication of whether each adaptive filtering unit is on or off is signaled in the bitstream, derived, or pre-defined.

Optionally, in any of the preceding aspects, another implementation of the aspect provides that filter parameters are shared within each filtering unit.

Optionally, in any of the preceding aspects, another implementation of the aspect provides that a parameter, a parameter set, or a parameter set index is signaled in the bitstream, derived, or pre-defined for each adaptive filtering unit.

Optionally, in any of the preceding aspects, another implementation of the aspect provides that a decision whether or not to reference a parameter is made for each adaptive filtering unit.

Optionally, in any of the preceding aspects, another implementation of the aspect provides that the decision is signaled in the bitstream, derived, or pre-defined for each filtering unit, and wherein the parameter comprises a merge left or a merge top.

Optionally, in any of the preceding aspects, another implementation of the aspect provides that one or more syntax elements (SEs) are signaled in the bitstream, derived, or pre-defined to indicate whether the adaptive filtering unit is applied to the CCSAO filter.

Optionally, in any of the preceding aspects, another implementation of the aspect provides that the one or more SEs are signaled in a sequence parameter set (SPS).

Optionally, in any of the preceding aspects, another implementation of the aspect provides that the one or more SEs are signaled in a sequence parameter set (SPS), a picture header, a slice header, an adaptation parameter set (APS), a coding tree unit (CTU), a coding unit (CU), a transform unit (TU), or a prediction unit (PU).

Optionally, in any of the preceding aspects, another implementation of the aspect provides that the filtering unit which is changed is designated an adaptive filtering unit, and wherein the adaptive filtering unit is used for a bilateral filter (BF).

Optionally, in any of the preceding aspects, another implementation of the aspect provides that the adaptive filtering unit is applied to different color components.

Optionally, in any of the preceding aspects, another implementation of the aspect provides that the adaptive filtering unit is only applied to a luma component.

Optionally, in any of the preceding aspects, another implementation of the aspect provides that the adaptive filtering unit is only applied to a chroma component.

Optionally, in any of the preceding aspects, another implementation of the aspect provides that the adaptive filtering unit is applied to both a luma component and a chroma component.

Optionally, in any of the preceding aspects, another implementation of the aspect provides that a size of the adaptive filtering unit depends on a size of at least one of a coding tree unit (CTU), a coding unit (CU), a transform unit (TU), and a prediction unit (PU).

Optionally, in any of the preceding aspects, another implementation of the aspect provides that a width of the adaptive filtering unit is upscaled from a width of the CTU, CU, TU, or PU by a factor (uw).

Optionally, in any of the preceding aspects, another implementation of the aspect provides that the factor is 2.

Optionally, in any of the preceding aspects, another implementation of the aspect provides that a height of the adaptive filtering unit is upscaled from a height of the CTU, CU, TU, or PU by a factor (uh).

Optionally, in any of the preceding aspects, another implementation of the aspect provides that the factor is 2.

Optionally, in any of the preceding aspects, another implementation of the aspect provides that a width of the adaptive filtering unit is downscaled from a width of the CTU, CU, TU, or PU by a factor (dw).

Optionally, in any of the preceding aspects, another implementation of the aspect provides that the factor is 0.5.

Optionally, in any of the preceding aspects, another implementation of the aspect provides that a height of the adaptive filtering unit is downscaled from a height of the CTU, CU, TU, or PU by a factor (dh).

Optionally, in any of the preceding aspects, another implementation of the aspect provides that the factor is 0.5.

Optionally, in any of the preceding aspects, another implementation of the aspect provides that a size of the adaptive filtering unit depends on one or more pre-defined values.

Optionally, in any of the preceding aspects, another implementation of the aspect provides that a width of the adaptive filtering unit comprises M, where M is one of 128, 256, and 512.

Optionally, in any of the preceding aspects, another implementation of the aspect provides that a height of the adaptive filtering unit comprises M, where M is one of 128, 256, and 512.

Optionally, in any of the preceding aspects, another implementation of the aspect provides that adaptive filtering unit depends on a size of a picture, slice, or tile.

Optionally, in any of the preceding aspects, another implementation of the aspect provides that a size of the adaptive filtering unit is different for a picture, slice, or tile with a different size or shape.

Optionally, in any of the preceding aspects, another implementation of the aspect provides that a size of the adaptive filtering unit is equal for a picture, slice, or tile with a different size or shape.

Optionally, in any of the preceding aspects, another implementation of the aspect provides that a shape of the adaptive filtering unit is different for a picture, slice, or tile with a different size or shape.

Optionally, in any of the preceding aspects, another implementation of the aspect provides that a shape of the adaptive filtering unit is equal for a picture, slice, or tile with a different size or shape.

Optionally, in any of the preceding aspects, another implementation of the aspect provides that a shape of the adaptive filtering unit is one of a plurality of different shapes.

Optionally, in any of the preceding aspects, another implementation of the aspect provides that the shape is square.

Optionally, in any of the preceding aspects, another implementation of the aspect provides that the shape is diamond.

Optionally, in any of the preceding aspects, another implementation of the aspect provides thatthe shape is rectangle.

Optionally, in any of the preceding aspects, another implementation of the aspect provides that each adaptive filtering unit is selectively enabled or disabled.

Optionally, in any of the preceding aspects, another implementation of the aspect provides that an indication of whether each adaptive filtering unit is on or off is signaled in the bitstream, derived, or pre-defined.

Optionally, in any of the preceding aspects, another implementation of the aspect provides that filter parameters are shared within each filtering unit.

Optionally, in any of the preceding aspects, another implementation of the aspect provides that a parameter, a parameter set, or a parameter set index is signaled in the bitstream, derived, or pre-defined for each adaptive filtering unit.

Optionally, in any of the preceding aspects, another implementation of the aspect provides that one or more syntax elements (SEs) are signaled in the bitstream, derived, or pre-defined to indicate whether the adaptive filtering unit is applied to the CCSAO filter.

Optionally, in any of the preceding aspects, another implementation of the aspect provides that the one or more SEs are signaled in a sequence parameter set (SPS).

Optionally, in any of the preceding aspects, another implementation of the aspect provides that the one or more SEs are signaled in a sequence parameter set (SPS), a picture header, a slice header, an adaptation parameter set (APS), a coding tree unit (CTU), a coding unit (CU), a transform unit (TU), or a prediction unit (PU).

Optionally, in any of the preceding aspects, another implementation of the aspect provides that one or more of the methods are used in at least one of post-processing and pre-processing.

Optionally, in any of the preceding aspects, another implementation of the aspect provides that one or more of the methods are used jointly.

Optionally, in any of the preceding aspects, another implementation of the aspect provides that one or more of the methods are used individually.

Optionally, in any of the preceding aspects, another implementation of the aspect provides that one or more of the methods are applied to one or more of in-loop filtering tools, pre-processing, and post-processing filtering methods in video coding.

Optionally, in any of the preceding aspects, another implementation of the aspect provides that the adaptive filtering unit is applied to an in-loop filtering method.

Optionally, in any of the preceding aspects, another implementation of the aspect provides that the adaptive filtering unit is applied to the ALF.

Optionally, in any of the preceding aspects, another implementation of the aspect provides that the adaptive filtering unit is applied to the CCALF.

Optionally, in any of the preceding aspects, another implementation of the aspect provides that the adaptive filtering unit is applied to the BF.

Optionally, in any of the preceding aspects, another implementation of the aspect provides that the adaptive filtering unit is applied to the SAO filter.

Optionally, in any of the preceding aspects, another implementation of the aspect provides that the adaptive filtering unit is applied to the CCSAO filter.

Optionally, in any of the preceding aspects, another implementation of the aspect provides that the adaptive filtering unit is applied to a pre-processing filtering method.

Optionally, in any of the preceding aspects, another implementation of the aspect provides that the adaptive filtering unit is applied to a post-processing filtering method.

Optionally, in any of the preceding aspects, another implementation of the aspect provides that the filtering unit is applied to a video unit, and wherein the video unit comprises a sequence, picture, sub-picture, slice, tile, coding tree unit (CTU), CTU row, group of CTUs, coding unit (CU), prediction unit (PU), transform unit (TU), coding tree block (CTB), coding block (CB), prediction block (PB), transform block (TB), or any other region that contains more than one luma or chroma sample or pixel.

Optionally, in any of the preceding aspects, another implementation of the aspect provides that whether to and/or how to apply the one or more of the methods is signalled in the bitstream.

Optionally, in any of the preceding aspects, another implementation of the aspect provides that whether to and/or how to apply the one or more ofthe methods is signalled at a sequence level, group of pictures level, picture level, slice level, or tile group level, or is signalled in a sequence header, picture header, sequence parameter set (SPS), video parameter set (VPS), decoding parameter set (DPS), decoding capability information (DCI), picture parameter set (PPS), adaptation parameter set (APS), slice header, or tile group header.

Optionally, in any of the preceding aspects, another implementation of the aspect provides that whether to and/or how to apply the one or more of the methods is signalled in a prediction block (PB), transform block (TB), coding block (CB), prediction unit (PU), transform unit (TU), coding unit (CU), virtual pipeline data unit (VPDU), coding tree unit (CTU), CTU row, slice, tile, sub-picture, or other region that contains more than one sample or pixel.

Optionally, in any of the preceding aspects, another implementation of the aspect provides that whether to and/or how to apply the one or more of the methods is dependent on coded information, and wherein the coded information comprises a block size, a color format, a single tree partitioning, a dual tree partitioning, a color component, a slice type, or a picture type.

Optionally, in any of the preceding aspects, another implementation of the aspect provides that the conversion includes encoding the media data into a bitstream.

Optionally, in any of the preceding aspects, another implementation of the aspect provides that the conversion includes decoding the media data from a bitstream.

A second aspect relates to an apparatus for processing video data comprising: a processor; and a non-transitory memory with instructions thereon, wherein the instructions upon execution by the processor, cause the processor to perform any of the disclosed methods.

A third aspect relates to a non-transitory computer readable medium comprising a computer program product for use by a video coding device, the computer program product comprising computer executable instructions stored on the non-transitory computer readable medium such that when executed by a processor cause the video coding device to perform any of the disclosed methods.

A fourth aspect relates to a non-transitory computer-readable recording medium storing a bitstream of a video which is generated by a method performed by a video processing apparatus, wherein the method comprises: determining to change at least one of a shape of a filtering unit and a size of the filtering unit in different sequences, different pictures, different slices, or different sub-pictures; and generating the bitstream with the filtering unit as changed.

A fifth aspect relates to a method for storing bitstream of a video comprising: determining to change at least one of a shape of a filtering unit and a size of the filtering unit in different sequences, different pictures, different slices, or different sub-pictures; generating the bitstream with the filtering unit as changed; and storing the bitstream in a non-transitory computer-readable recording medium.

A sixth aspect relates to a method, apparatus, or system described in the present disclosure.

For the purpose of clarity, any one of the foregoing embodiments may be combined with any one or more of the other foregoing embodiments to create a new embodiment within the scope of the present disclosure.

These and other features will be more clearly understood from the following detailed description taken in conjunction with the accompanying drawings and claims.

### BRIEF DESCRIPTION OF THE DRAWINGS

For a more complete understanding of this disclosure, reference is now made to the following brief description, taken in connection with the accompanying drawings and detailed description, wherein like reference numerals represent like parts.

FIG. 1 illustrates an example of nominal vertical and horizontal locations of 4:2:2 luma and chroma samples in a picture.

FIG. 2 illustrates an example encoder block diagram.

FIG. 3 illustrates an example picture partitioned into raster scan slices.

FIG. 4 illustrates an example picture partitioned into rectangular scan slices.

FIG. 5 illustrates an example picture partitioned into bricks.

FIGS. 6A-6C illustrate examples of coding tree blocks (CTBs) crossing picture borders.

FIG. 7 illustrates an example of intra prediction modes.

FIG. 8 illustrates an example of block boundaries in a picture.

FIG. 9 illustrates an example of pixels involved in filter usage.

FIG. 10 illustrates an example of filter shapes for adaptive loop filter (ALF).

FIG. 11 illustrates an example of transformed coefficients for 5×5 diamond filter support.

FIG. 12 illustrates an example of relative coordinates for 5×5 diamond filter support.

FIG. 13 is a block diagram showing an example video processing system.

FIG. 14 is a block diagram of an example video processing apparatus.

FIG. 15 is a flowchart for an example method of video processing.

FIG. 16 is a block diagram that illustrates an example video coding system.

FIG. 17 is a block diagram that illustrates an example encoder.

FIG. 18 is a block diagram that illustrates an example decoder.

FIG. 19 is a schematic diagram of an example encoder.

### DETAILED DESCRIPTION

It should be understood at the outset that although an illustrative implementation of one or more embodiments are provided below, the disclosed systems and/or methods may be implemented using any number of techniques, whether currently known or yet to be developed. The disclosure should in no way be limited to the illustrative implementations, drawings, and techniques illustrated below, including the exemplary designs and implementations illustrated and described herein, but may be modified within the scope of the appended claims along with their full scope of equivalents.

Section headings are used in the present document for ease of understanding and do not limit the applicability of techniques and embodiments disclosed in each section only to that section. Furthermore, the techniques described herein are applicable to other video codec protocols and designs.

### 1. INITIAL DISCUSSION

This document is related to video coding technologies. Specifically, it is related to in-loop filter and other coding tools in image/video coding. The ideas may be applied individually or in various combinations to video codecs, such as High Efficiency Video Coding (HEVC), Versatile Video Coding (VVC), or other video coding technologies.

### 2. ABBREVIATIONS

The present disclosure includes the following abbreviations. Advanced video coding (Rec. ITU-T H.2641 ISO/IEC 14496-10) (AVC), coded picture buffer (CPB), clean random access (CRA), coding tree unit (CTU), coded video sequence (CVS), decoded picture buffer (DPB), decoding parameter set (DPS), general constraints information (GCI), high efficiency video coding, also known as Rec. ITU-T H.265 I ISO/IEC 23008-2, (HEVC), Joint exploration model (JEM), motion constrained tile set (MCTS), network abstraction layer (NAL), output layer set (OLS), picture header (PH), picture parameter set (PPS), profile, tier, and level (PTL), picture unit (PU), reference picture resampling (RPR), raw byte sequence payload (RBSP), supplemental enhancement information (SEI), slice header (SH), sequence parameter set (SPS), video coding layer (VCL), video parameter set (VPS), versatile video coding, also known as Rec. ITU-T H.266| ISO/IEC 23090-3, (VVC), VVC test model (VTM), video usability information (VUI), transform unit (TU), coding unit (CU), deblocking filter (DF), sample adaptive offset (SAO), adaptive loop filter (ALF), coding block flag (CBF), quantization parameter (QP), rate distortion optimization (RDO), and bilateral filter (BF).

### 3. VIDEO CODING STANDARDS

Video coding standards have evolved primarily through the development of the International Telecommunication Union (ITU) telecommunication standardization sector (ITU-T) and International Organization for Standardization (ISO)/International Electrotechnical Commission (IEC) standards. The ITU-T produced H.261 and H.263, ISO/IEC produced motion picture experts group (MPEG)-1 and MPEG-4 Visual, and the two organizations jointly produced the H.262/MPEG-2 Video and H.264/MPEG-4 Advanced Video Coding (AVC) and H.265/HEVC [1] standards. Since H.262, the video coding standards are based on the hybrid video coding structure wherein temporal prediction plus transform coding are utilized. To explore the future video coding technologies beyond HEVC, the Joint Video Exploration Team (JVET) was founded by video coding experts group (VCEG) and MPEG jointly. Many methods have been adopted by JVET and put into the reference software named Joint Exploration Model (JEM) [2]. The JVET was renamed to be the Joint Video Experts Team (JVET) when the Versatile Video Coding (VVC) project officially started. VVC is a coding standard, targeting at 50% bitrate reduction as compared to HEVC. The VVC working draft and VVC test model (VTM) are continuously updated.

An example version of the VVC draft, i.e., Versatile Video Coding (Draft 10) may be found at: https://jvet-experts.org/doc_end_user/documents/19_Teleconference/wg11/JVET-S2001-v17.zip. An example version of the reference software ofVVC, named as VTM, could be found at: https://vcgit.hhi.fraunhofer.de/jvet-u-ee2/VVCSoftware_VTM/-/tree/VTM-11.2.

International Telecommunication Union Telecommunication Standardization Sector (ITU-T) video coding experts group (VCEG) and International Organization for Standardization and the International Electrotechnical Commission (ISO/IEC) Moving Picture Experts Group (MPEG)joint technical committee (JTC) 1/subcommittee (SC) 29/working group (WG) 11 are studying the potential need for standardization of future video coding technology with a compression capability that significantly exceeds that of the current VVC standard. Such future standardization action could either take the form of extended extension(s) of VVC or an entirely new standard. The groups are working together on this exploration activity in a joint-collaboration effort known as the Joint Video Exploration Team (JVET) to evaluate compression technology designs proposed by their experts in this area. The first Exploration Experiments (EE) are established by JVET and reference software named Enhanced Compression Model (ECM) is in use. The test model ECM is updated continuously.

### 3.1 Color Space and Chroma Subsampling

Color space, also known as the color model (or color system), is a mathematical model which describes the range of colors as tuples of numbers, for example as 3 or 4 values or color components (e.g. RGB). Generally speaking, a color space is an elaboration of the coordinate system and sub-space. For video compression, the most frequently used color spaces are luma, blue difference chroma, and red difference chroma (YCbCr) and red, green, blue (RGB).

YCbCr, Y′CbCr, or Y Pb/Cb Pr/Cr, also written as YCBCR or Y′CBCR, is a family of color spaces used as a part of the color image pipeline in video and digital photography systems. Y′ is the luma component and CB and CR are the blue-difference and red-difference chroma components. Y′ (with prime) is distinguished from Y, which is luminance, meaning that light intensity is nonlinearly encoded based on gamma corrected RGB primaries.

Chroma subsampling is the practice of encoding images by implementing less resolution for chroma information than for luma information, taking advantage of the human visual system's lower acuity for color differences than for luminance.

3.1.1 4:4:4

In 4:4:4, each of the three Y′CbCr components have the same sample rate. Thus there is no chroma subsampling. This scheme is sometimes used in high-end film scanners and cinematic postproduction.

3.1.2 4:2:2

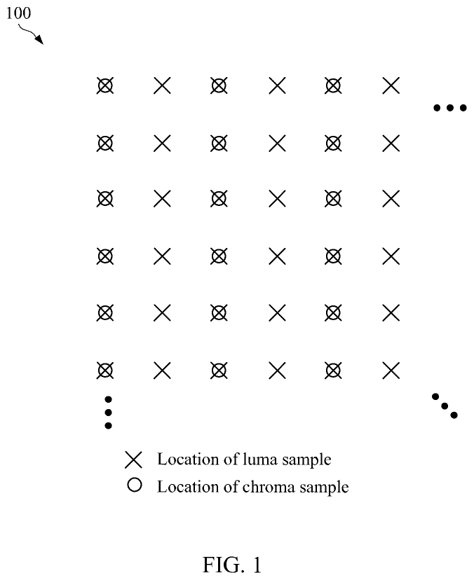

In 4:3:2, the two chroma components are sampled at half the sample rate of luma. The horizontal chroma resolution is halved while the vertical chroma resolution is unchanged. This reduces the bandwidth of an uncompressed video signal by one-third with little to no visual difference. An example of nominal vertical and horizontal locations of 4:2:2 color format is depicted in FIG. 1.

3.1.3 4:2:0

In 4:2:0, the horizontal sampling is doubled compared to 4:1:1, but as the blue difference chroma (Cb) and red difference chroma (Cr) channels are only sampled on each alternate line in this scheme, the vertical resolution is halved. The data rate is thus the same. Cb and Cr are each subsampled at a factor of 2 both horizontally and vertically. There are three variants of 4:2:0 schemes, having different horizontal and vertical siting.

In MPEG-2, Cb and Cr are cosited horizontally. Cb and Cr are sited between pixels in the vertical direction (sited interstitially). In Joint Photographic Experts Group (JPEG)/JPEG File Interchange Format (JFIF), H.261, and MPEG-1, Cb and Cr are sited interstitially, halfway between alternate luma samples. In 4:2:0 DV, Cb and Cr are co-sited in the horizontal direction. In the vertical direction, they are co-sited on alternating lines.

TABLE 1
SubWidthC and SubHeightC values derived from
chroma_format_idc and separate_colour_plane_flag

| chroma_{—} | separate_{—} | | | |
|---|---|---|---|---|
| format_{—} | colour_plane_{—} | Chroma | | |
| idc | flag | format | SubWidthC | SubHeightC |
| 0 | 0 | Monochrome | 1 | 1 |
| 1 | 0 | 4:2:0 | 2 | 2 |
| 2 | 0 | 4:2:2 | 2 | 1 |
| 3 | 0 | 4:4:4 | 1 | 1 |
| 3 | 1 | 4:4:4 | 1 | 1 |

### 3.2 Example Coding Flow of a Video Codec

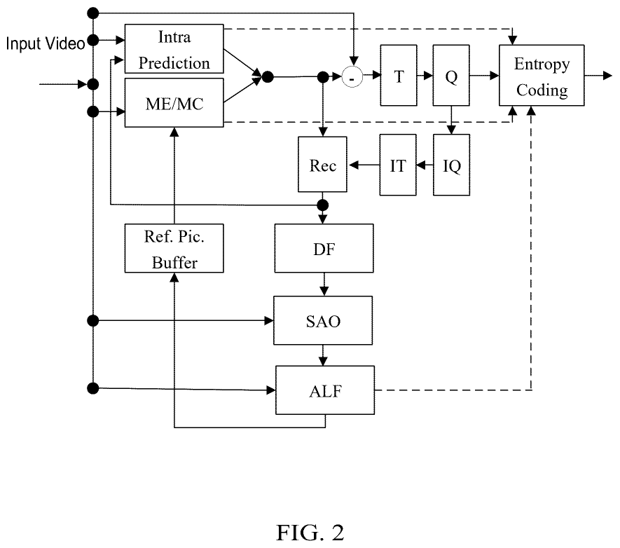

FIG. 2 shows an example of encoder block diagram of VVC, which contains three in-loop filtering blocks: deblocking filter (DF), sample adaptive offset (SAO) and ALF. Unlike DF, which uses pre-defined filters, SAO and ALF utilize the original samples of the current picture to reduce the mean square errors between the original samples and the reconstructed samples by adding an offset and by applying a finite impulse response (FIR) filter, respectively, with coded side information signaling the offsets and filter coefficients. ALF is located at the last processing stage of each picture and can be regarded as a tool trying to catch and fix artifacts created by the previous stages.

### 3.3 Definitions of Video/Coding Units

A picture is divided into one or more tile rows and one or more tile columns. A tile is a sequence of CTUs that covers a rectangular region of a picture. A tile may be divided into one or more bricks, each of which includes a number of CTU rows within the tile. A tile that is not partitioned into multiple bricks may also be referred to as a brick. However, a brick that is a true subset of a tile may not be referred to as a tile. A slice either contains several tiles of a picture or several bricks of a tile.

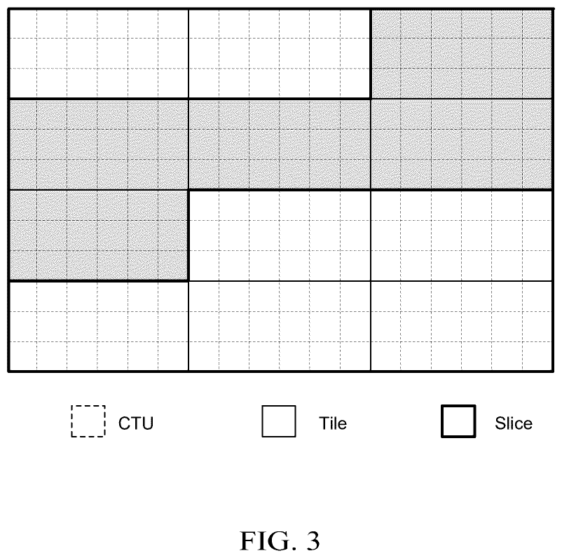

Two modes of slices are supported, namely the raster-scan slice mode and the rectangular slice mode. In the raster-scan slice mode, a slice contains a sequence of tiles in a tile raster scan of a picture. In the rectangular slice mode, a slice contains a number of bricks of a picture that collectively form a rectangular region of the picture. The bricks within a rectangular slice are in the order of brick raster scan of the slice. FIG. 3 shows an example of raster-scan slice partitioning of a picture, where the picture is divided into 12 tiles and 3 raster-scan slices.

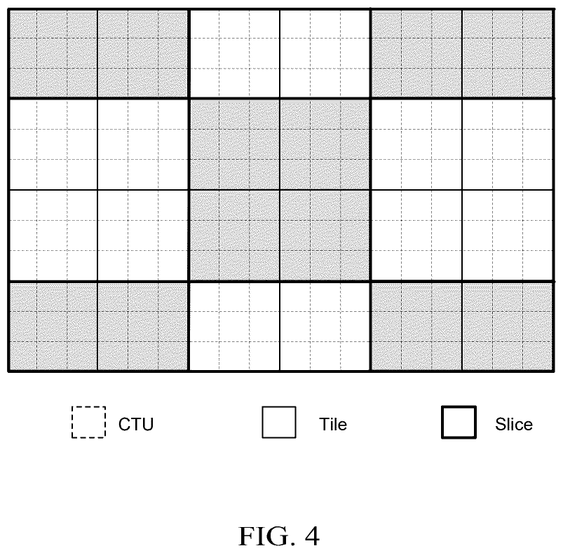

FIG. 4 shows an example of rectangular slice partitioning of a picture, where the picture is divided into 24 tiles (6 tile columns and 4 tile rows) and 9 rectangular slices.

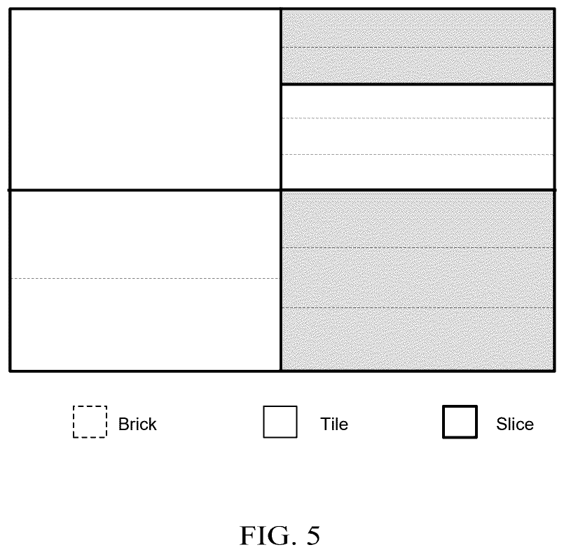

FIG. 5 shows an example of a picture partitioned into tiles, bricks, and rectangular slices, where the picture is divided into 4 tiles (2 tile columns and 2 tile rows), 11 bricks (the top-left tile contains 1 brick, the top-right tile contains 5 bricks, the bottom-left tile contains 2 bricks, and the bottom-right tile contain 3 bricks), and 4 rectangular slices.

### 3.3.1 CTU/CTB Sizes

In VVC, the CTU size, signaled in a sequence parameter set (SPS) by the syntax element log 2_ctu_size_minus2, could be as small as 4×4.

7.3.2.3 Sequence parameter set RBSP syntax

| | Descriptor |
|---|---|
| seq_parameter_set_rbsp( ) { | |
| sps_decoding_parameter_set_id | u(4) |
| sps_video_parameter_set_id | u(4) |
| sps_max_sub_layers_minus1 | u(3) |
| sps_reserved_zero_5bits | u(5) |
| profile_tier_level( sps_max_sub_layers_minus1 ) | |
| gra_enabled_flag | u(1) |
| sps_seq_parameter_set_id | ue(v) |
| chroma_format_idc | ue(v) |
| if( chroma_format_idc = = 3 ) | |
| separate_colour_plane_flag | u(1) |
| pic_width_in_luma_samples | ue(v) |
| pic_height_in_luma_samples | ue(v) |
| conformance_window_flag | u(1) |
| if( conformance_window_flag ) { | |
| conf_win_left_offset | ue(v) |
| conf_win_right_offset | ue(v) |
| conf_win_top_offset | ue(v) |
| conf_win_bottom_offset | ue(v) |
| } | |
| bit_depth_luma_minus8 | ue(v) |
| bit_depth_chroma_minus8 | ue(v) |
| log2_max_pic_order_cnt_lsb_minus4 | ue(v) |
| sps_sub_layer_ordering_info_present_flag | u(1) |
| for( i = ( sps_sub_layer_ordering_info_present_flag ? 0 : | |
| sps_max_sub_layers_minus1 ); | |
| i <= sps_max_sub_layers_minus1; i++ ) { | |
| sps_max_dec_pic_buffering_minus1[ i ] | ue(v) |
| sps_max_num_reorder_pics[ i ] | ue(v) |
| sps_max_latency_increase_plus1[ i ] | ue(v) |
| } | |
| long_term_ref_pics_flag | u(1) |
| sps_idr_rpl_present_flag | u(1) |
| rpl1_same_as_rp10_flag | u(1) |
| for( i = 0; i < !rpl1_same_as_rp10_flag ? 2 : 1; i++ ) { | |
| num_ref_pic_lists_in_sps[ i ] | ue(v) |
| for( j = 0; j < num_ref_pic_lists_in_sps[ i ]; j++) | |
| ref_pic_list_struct( i, j ) | |
| } | |
| qtbtt_dual_tree_intra_flag | u(1) |
| log2_ctu_size_minus2 | ue(v) |
| log2_min_luma_coding_block_size_minus2 | ue(v) |
| partition_constraints_override_enabled_flag | u(1) |
| sps_log2_diff_min_qt_min_cb_intra_slice_luma | ue(v) |
| sps_log2_diff_min_qt_min_cb_inter_slice | ue(v) |
| sps_max_mtt_hierarchy_depth_inter_slice | ue(v) |
| sps_max_mtt_hierarchy_depth_intra_slice_luma | ue(v) |
| if( sps_max_mtt_hierarchy_depth_intra_slice_luma != 0 ) { | |
| sps_log2_diff_max_bt_min_qt_intra_slice_luma | ue(v) |
| sps_log2_diff_max_tt_min_qt_intra_slice_luma | ue(v) |
| } | |
| if( sps_max_mtt_hierarchy_depth_inter_slices != 0 ) { | |
| sps_log2_diff_max_bt_min_qt_inter_slice | ue(v) |
| sps_log2_diff_max_tt_min_qt_inter_slice | ue(v) |
| } | |
| if( qtbtt_dual_tree_intra_flag ) { | |
| sps_log2_diff_min_qt_min_cb_intra_slice_chroma | ue(v) |
| sps_max_mtt_hierarchy_depth_intra_slice_chroma | ue(v) |
| if ( sps_max_mtt_hierarchy_depth_intra_slice_chroma != 0 ) { | |
| sps_log2_diff_max_bt_min_qt_intra_slice_chroma | ue(v) |
| sps_log2_diff_max_tt_min_qt_intra_slice_chroma | ue(v) |
| } | |
| } | |
| ... | |
| rbsp_trailing_bits( ) | |
| } | |

log 2_ctu_size_minus2 plus 2 specifies the luma coding tree block size of each CTU. log 2_min_luma coding_block_size_minus2 plus 2 specifies the minimum luma coding block size. The variables CtbLog 2SizeY, CtbSizeY, MinCbLog 2SizeY, MinCbSizeY, MinThLog 2SizeY, MaxThLog 2SizeY, MinThSizeY, MaxThSizeY, PicWidthlnCtbsY, PicHeighthiCtbsY, PicSizelnCtbsY, PicWidthlnMinCbsY, PicHeightInMinCbsY, PicSizeInMinCbsY, PicSizeInSamplesY, PicWidthInSamplesC and PicHeightInSamplesC are derived as follows:

$$Ctb Log 2 SizeY = log2\_ctu \_size \_minus2 + 2 \qquad ( 7 - 9 )$$

$$CtbSizeY = 1 ≪ Ctb Log 2 SizeY \qquad ( 7 - 10 )$$

$$Min Cb Log 2 SizeY = log2\_min \_luma \_coding \_block \_size \_minus2 + 2 \qquad ( 7 - 11 )$$

$$Min CbSizeY = 1 ≪ Min Cb Log 2 SizeY \qquad ( 7 - 12 )$$

$$Min Tb Log 2 Size Y = 2 \qquad ( 7 - 13 )$$

$$Max Tb Log 2 SizeY = 6 \qquad ( 7 - 14 )$$

$$Min TbSizeY = 1 ≪ Min Tb Log 2 SizeY \qquad ( 7 - 15 )$$

$$Max Tb SizeY = 1 ≪ Max Tb Log 2 SizeY \qquad ( 7 - 16 )$$

$$PicWidthInCtbsY = Ceil ( pic\_width \_in \_luma \_samples \div CtbSizeY ) \qquad ( 7 - 17 )$$

$$PicHeightInCtbsY = Ceil ( pic\_height \_in \_luma \_samples \div CtbSizeY ) \qquad ( 7 - 18 )$$

$$PicSizeInCtbsY = PicWidthInCtbsY * PicHeightInCtbsY \qquad ( 7 - 19 )$$

$$PicWidthIn Min CbsY = pic\_width \_in \_luma \_samples / Min Cb SizeY \qquad ( 7 - 20 )$$

$$PicHeightIn Min CbsY = pic\_height \_in \_luma \_samples / Min Cb SizeY \qquad ( 7 - 21 )$$

$$PicSizeIn Min CbsY = PicWidthIn Min CbsY * PicHeightIn Min CbsY \qquad ( 7 - 22 )$$

$$PicSizeInSamplesY = pic\_width \_in \_luma \_samples * pic\_height \_in \_luma \_samples \qquad ( 7 - 23 )$$

$$PicWidthInSamplesC = pic\_width \_in \_luma \_samples / SubWidthC \qquad ( 7 - 24 )$$

$$PicHeightInSamplesC = pic\_height \_in \_luma \_samples / SubHeightC \qquad ( 7 - 25 )$$

### 3.3.2 CTUs in One Picture

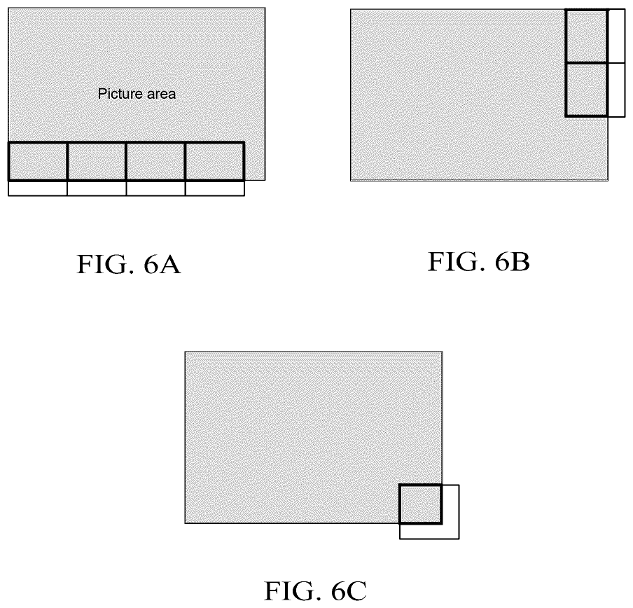

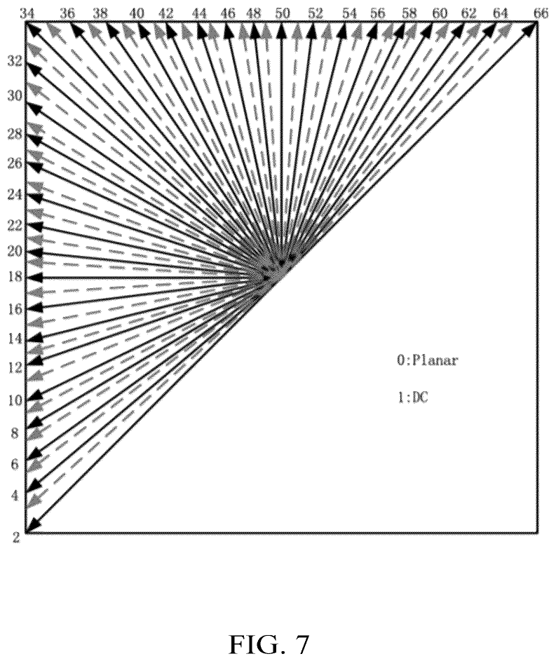

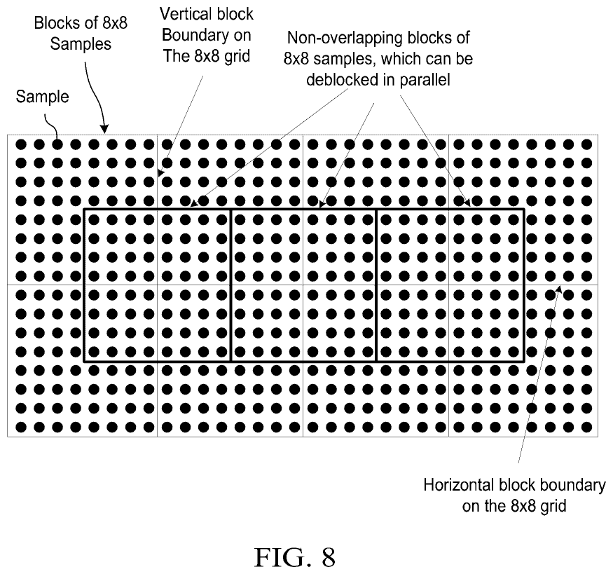

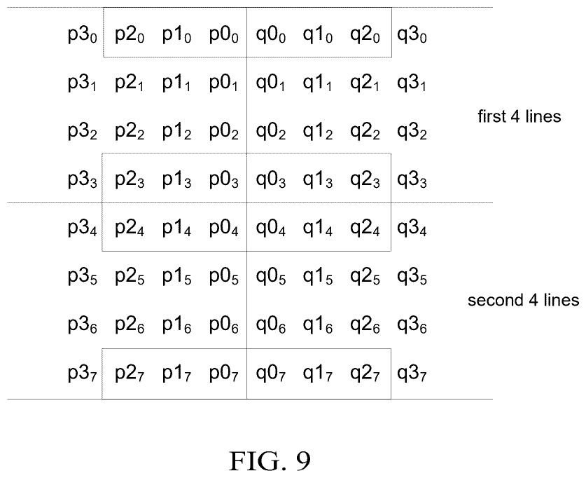

FIGS. 6A-6C illustrate examples of CTBs crossing picture borders. FIG. 6A illustrates CTBs crossing the bottom picture border, FIG. 6B illustrates CTBs crossing the right picture border, and FIG. 6C illustrates CTBs crossing both the bottom picture border and the right picture border.

Suppose the CTB/largest coding unit (LCU) size indicated by M×N (typically M is equal to N), and for a CTB located at picture border (or tile or slice or other types of borders, picture border is taken as an example) border, K×L samples are within picture border wherein either K<M or L<N. For those CTBs as depicted in FIG. 6, the CTB size is still equal to MxN, however, the bottom boundary/right boundary of the CTB is outside the picture.

### 3.4 Intra Prediction

To capture the arbitrary edge directions presented in natural video, the number of directional intra modes is extended from 33, as used in HEVC, to 65. The extended directional modes are depicted in FIG. 7, and the planar and direct current (DC) modes remain the same. These denser directional intra prediction modes apply for all block sizes and for both luma and chroma intra predictions.

Angular intra prediction directions may be defined from 45 degrees to −135 degrees in clockwise direction as shown in FIG. 7. In VTM, several angular intra prediction modes are adaptively replaced with wide-angle intra prediction modes for the non-square blocks. The replaced modes are signaled and remapped to the indexes of wide angular modes after parsing. The total number of intra prediction modes is unchanged, e.g., 67, and the intra mode coding is unchanged.

In the HEVC, every intra-coded block has a square shape and the length of each of the block's sides is a power of 2. Thus, no division operations are required to generate an intra-predictor using DC mode. In VVC, blocks can have a rectangular shape that necessitates the use of a division operation per block in the general case. To avoid division operations for DC prediction, only the longer side is used to compute the average for non-square blocks.

### 3.5 Inter Prediction

For each inter-predicted CU, motion parameters include motion vectors, reference picture indices, reference picture list usage index, and extended information used for the new coding feature of VVC to be used for inter-predicted sample generation. The motion parameters can be signaled in an explicit or implicit manner. When a CU is coded with skip mode, the CU is associated with one PU and has no significant residual coefficients, no coded motion vector delta, and/or reference picture index. A merge mode is specified whereby the motion parameters for the current CU are obtained from neighboring CUs, including spatial and temporal candidates, and extended schedules introduced in VVC. The merge mode can be applied to any inter-predicted CU, not only for skip mode. The alternative to merge mode is the explicit transmission of motion parameters, where motion vector, corresponding reference picture index for each reference picture list, reference picture list usage flag, and other useful information are signaled explicitly per each CU.

### 3.6 Deblocking Filter

Deblocking filtering is an example in-loop filter in video codec. In VVC, the deblocking filtering process is applied on CU boundaries, transform subblock boundaries, and prediction subblock boundaries. The prediction subblock boundaries include the prediction unit boundaries introduced by the Subblock based Temporal Motion Vector prediction (SbTMVP) and affine modes. The transform subblock boundaries include the transform unit boundaries introduced by Subblock transform (SBT) and Intra Sub-Partitions (ISP) modes and transforms due to implicit split of large CUs. The processing order of the deblocking filter is defined as horizontal filtering for vertical edges for the entire picture first, followed by vertical filtering for horizontal edges. This specific order enables either multiple horizontal filtering or vertical filtering processes to be applied in parallel threads. Filtering processes can also be implemented on a CTB-by-CTB basis with only a small processing latency.

The vertical edges in a picture are filtered first. Then the horizontal edges in a picture are filtered with samples modified by the vertical edge filtering process as input. The vertical and horizontal edges in the CTBs of each CTU are processed separately on a coding unit basis. The vertical edges of the coding blocks in a coding unit are filtered starting with the edge on the left-hand side of the coding blocks proceeding through the edges towards the right-hand side of the coding blocks in their geometrical order. The horizontal edges of the coding blocks in a coding unit are filtered starting with the edge on the top of the coding blocks proceeding through the edges towards the bottom of the coding blocks in their geometrical order.

### 3.6.1 Boundary Decision

Filtering is applied to 8×8 block boundaries. In addition, such boundaries must be a transform block boundary or a coding subblock boundary, for example due to usage of Affine motion prediction (ATMVP). For other boundaries, deblocking filtering is disabled.

### 3.6.2 Boundary Strength Calculation

For a transform block boundary/coding subblock boundary, if the boundary is located in the 8×8 grid, the boundary may be filtered and the setting of bS[xDi][yDj](wherein [xDi][yDj] denotes the coordinate) for this edge as defined in Table 2 and Table 3, respectively.

TABLE 2
Boundary strength (when SPS intra block copy (IBC) is disabled)

| Priority | Conditions | Y | U | V |
|---|---|---|---|---|
| 5 | At least one of the adjacent blocks is intra | 2 | 2 | 2 |
| 4 | TU boundary and at least one of the adjacent blocks has non-zero | 1 | 1 | 1 |
| | transform coefficients | | | |
| 3 | Reference pictures or number of MVs (1 for uni-prediction, 2 for bi- | 1 | N/A | N/A |
| | prediction) of the adjacent blocks are different | | | |
| 2 | Absolute difference between the motion vectors of same reference | 1 | N/A | N/A |
| | picture that belong to the adjacent blocks is greater than or equal to one | | | |
| | integer luma sample | | | |
| 1 | Otherwise | 0 | 0 | 0 |

TABLE 3
Boundary strength (when SPS IBC is enabled)

| Priority | Conditions | Y | U | V |
|---|---|---|---|---|
| 8 | At least one of the adjacent blocks is intra | 2 | 2 | 2 |
| 7 | TU boundary and at least one of the adjacent blocks has non-zero | 1 | 1 | 1 |
| | transform coefficients | | | |
| 6 | Prediction mode of adjacent blocks is different (e.g., one is IBC, one is | 1 | | |
| | inter) | | | |
| 5 | Both IBC and absolute difference between the motion vectors that | 1 | N/A | N/A |
| | belong to the adjacent blocks is greater than or equal to one integer luma | | | |
| | sample | | | |
| 4 | Reference pictures or number of MVs (1 for uni-prediction, 2 for bi- | 1 | N/A | N/A |
| | prediction) of the adjacent blocks are different | | | |
| 3 | Absolute difference between the motion vectors of same reference | 1 | N/A | N/A |
| | picture that belong to the adjacent blocks is greater than or equal to one | | | |
| | integer luma sample | | | |
| 1 | Otherwise | 0 | 0 | 0 |

### 3.6.3 Deblocking Decision for Luma Component

Wider-stronger luma filter is filters are used only if all the Condition1, Condition2 and Condition 3 are TRUE. The condition 1 is the “large block condition”. This condition detects whether the samples at P-side and Q-side belong to large blocks, which are represented by the variable bSidePisLargeBlk and bSideQisLargeBlk respectively. The bSidePisLargeBlk and bSideQisLargeBlk are defined as follows.

$$bSidePisLargeBlk = ( ( edge type is vertical and {p}_{0} belongs to CU with width >= 32 ) ‖ ( edge type is horizontal and {p}_{0} belongs to CU with height >= 32 ) ) ? TRUE : FALSE$$

$$bSideQisLargeBlk = ( ( edge type is vertical and {q}_{0} belongs to CU with width >= 32 ) ‖ ( edge type is horizontal and {q}_{0} belongs to CU with height >= 32 ) ) ? TRUE : FALSE$$

Based on bSidePisLargeBlk and bSideQisLargeBlk, the condition 1 is defined as follows:

$$Condition 1 = ( bSidePisLargeBlk ‖ bSidePisLargeBlk ) ? TRUE : FALSE$$

Next, if Condition 1 is true, the condition 2 will be further checked. First, the following variables are derived:

```
dp0, dp3, dq0, dq3 are first derived as in HEVC
if (p side is greater than or equal to 32)
  dp0 = ( dp0 + Abs( p50 − 2 * p40 + p30 ) + 1 ) >> 1
  dp3 = ( dp3 + Abs( p53 − 2 * p43 + p33 ) + 1 ) >> 1
if (q side is greater than or equal to 32)
  dq0 = ( dq0 + Abs( q50 − 2 * q40 + q30 ) + 1 ) >> 1
  dq3 = ( dq3 + Abs( q53 − 2 * q43 + q33 ) + 1 ) >> 1
Condition2 = (d <β) ? TRUE: FALSE
    where d= dp0 + dq0 + dp3 + dq3.
```

If Condition1 and Condition2 are valid, whether any of the blocks uses sub-blocks is further checked:

```
If (bSidePisLargeBlk)
  {
        If (mode block P == SUBBLOCKMODE)
              Sp =5
          else
              Sp =7
}
else
  Sp = 3
If (bSideQisLargeBlk)
    {
        If (mode block Q == SUBBLOCKMODE)
                Sq =5
            else
                Sq =7
      }
else
    Sq = 3
```

Finally, if both the Condition 1 and Condition 2 are valid, the deblocking method will check the condition 3 (the large block strong filter condition), which is defined as follows. In the Condition3 StrongFilterCondition, the following variables are derived:

```
dpq is derived as in HEVC.
sp3 = Abs( p3 − p0 ), derived as in HEVC
if (p side is greater than or equal to 32)
    if(Sp==5)
      sp3 = ( sp3 + Abs( p5 − p3 ) + 1) >> 1
    else
      sp3 = ( sp3 + Abs( p7 − p3 ) + 1) >> 1
sq3 = Abs( q0 − q3 ), derived as in HEVC
if (q side is greater than or equal to 32)
  If(Sq==5)
    sq3 = ( sq3 + Abs( q5 − q3 ) + 1) >> 1
  else
    sq3 = ( sq3 + Abs( q7 − q3 ) + 1) >> 1
```

As in HEVC, StrongFilterCondition=(dpq is less than (β>>2), sp3+sq3 is less than (3*β>>5), and Abs(p0−q0) is less than (5*tC+1)>>1)? TRUE: FALSE.

### 3.6.4 Stronger Deblocking Filter for Luma

Bilinear filter is used when samples at either one side of a boundary belong to a large block. A sample belonging to a large block is defined as when the width>=32 for a vertical edge, and when height>=32 for a horizontal edge. The bilinear filter is listed below. Block boundary samples pi for i=0 to Sp-1 and qi for j=0 to Sq-1 (pi and qi are the i-th sample within a row for filtering vertical edge, or the i-th sample within a column for filtering horizontal edge) in HEVC deblocking described above) are then replaced by linear interpolation as follows:

$${p}_{i}^{′} = ( {f}_{i} * {Middle}_{s , t} + ( 64 - {f}_{i} ) * {P}_{s} + 32 ) ≫ 6 ) , clipped to {p}_{i} \pm {tcPD}_{i}$$

$${q}_{i}^{′} = ( {g}_{j} * {Middle}_{s , t} + ( 64 - {g}_{i} ) * {Q}_{s} + 32 ) ≫ 6 ) , clipped to {q}_{j} \pm {tcPD}_{j}$$

where tcPDᵢ and tcPDⱼ term is a position dependent clipping described above and gⱼ, fᵢ, Middle_{s,t}, Pₛ and Qₛ are given below.

### 3.6.5 Deblocking Decision for Chroma

The chroma strong filters are used on both sides of the block boundary. Here, the chroma filter is selected when both sides of the chroma edge are greater than or equal to 8 (chroma position), and the following decision with three conditions are satisfied: the first one is for decision of boundary strength as well as large block. The filter can be applied when the block width or height which orthogonally crosses the block edge is equal to or larger than 8 in chroma sample domain. The second and third one is basically the same as for HEVC luma deblocking decision, which are on/off decision and strong filter decision, respectively.

In the first decision, boundary strength (bS) is modified for chroma filtering and the conditions are checked sequentially. If a condition is satisfied, then the remaining conditions with lower priorities are skipped. Chroma deblocking is performed when bS is equal to 2, or bS is equal to 1 when a large block boundary is detected. The second and third condition is basically the same as HEVC luma strong filter decision as follows.

In the second condition d is then derived as in HEVC luma deblocking. The second condition will be TRUE when d is less than β. In the third condition StrongFilterCondition is derived as follows:

$$dpq is derived as in HEVC .$$

$${sp}_{3} = Abs ( {p}_{3} - {p}_{0} ) , derived as in HEVC$$

$${sp}_{3} = Abs ( {p}_{3} - {p}_{0} ) , derived as in HEVC$$

As in HEVC design, StrongFilterCondition=(dpq is less than (β>>2), sp3+sq3 is less than (β >>3), and Abs(p0−q0) is less than (5*tC+1)>>1)

### 3.6.6 Strong Deblocking Filter for Chroma

The following strong deblocking filter for chroma is defined:

$$p {2}^{′} = ( 3 * p 3 + 2 * p 2 + p 1 + p 0 + q 0 + 4 ) ≫ 3$$

$$p {1}^{′} = ( 2 * p 3 + p 2 + 2 * p 1 + p 0 + q 0 + q 1 + 4 ) ≫ 3$$

$$p {0}^{′} = ( p 3 + p 2 + p1 + 2 * p 0 + q 0 + q 1 + q 2 + 4 ) ≫ 3$$

An example chroma filter performs deblocking on a 4×4 chroma sample grid.

### 3.6.7 Position Dependent Clipping

The position dependent clipping tcPD is applied to the output samples of the luma filtering process involving strong and long filters that are modifying 7, 5 and 3 samples at the boundary. Assuming quantization error distribution, a clipping value may be increased for samples which are expected to have higher quantization noise, thus expected to have higher deviation of the reconstructed sample value from the true sample value.

For each P or Q boundary filtered with asymmetrical filter, depending on the result of decision-making process, position dependent threshold table is selected from two tables (e.g., Tc7 and Tc3 tabulated below) that are provided to decoder as a side information:

$$Tc 7 = \{ 6 , 5 , 4 , 3 , 2 , 1 , 1 \} ; Tc 3 = \{ 6 , 4 , 2 \} ;$$

$$tcPD = ( Sp == 3 ) ? Tc 3 : Tc 7 ;$$

$$tcQD = ( Sq == 3 ) ? Tc 3 : Tc 7 ;$$

For the P or Q boundaries being filtered with a short symmetrical filter, position dependent threshold of lower magnitude is applied:

$$Tc 3 = \{ 3 , 2 , 1 \} ;$$

Following defining the threshold, filtered p′i and q′i sample values are clipped according to tcP and tcQ clipping values:

$$p ” i = Clip 3 ( p ’ i + tcPi , p ’ i - tcPi , p ’ i ) ;$$

$$p ” j = Clip 3 ( p ’ j + tcQj , p ’ j - tcQj , p ’ j ) ;$$

where p′i and q′i are filtered sample values, p″i and q″j are output sample value after the clipping and tcPi tcPi are clipping thresholds that are derived from the VVC tc parameter and tcPD and tcQD. The function Clip3 is a clipping function as it is specified in VVC.

### 3.6.8 Sub-block Deblocking Adjustment

To enable parallel friendly deblocking using both long filters and sub-block deblocking the long filters is restricted to modify at most 5 samples on a side that uses sub-block deblocking (AFFINE or ATMVP or decoder side motion vector refinement (DMVR)) as shown in the luma control for long filters. Extendedly, the sub-block deblocking is adjusted such that that sub-block boundaries on an 8×8 grid that are close to a CU or an implicit TU boundary is restricted to modify at most two samples on each side.

The following applies to sub-block boundaries that not are aligned with the CU boundary.

```
If (mode block Q == SUBBLOCKMODE && edge !=0) {
  if (!(implicitTU && (edge == (64 / 4))))
    if (edge == 2 || edge == (orthogonalLength − 2) || edge == (56 / 4) || edge == (72 / 4))
        Sp = Sq = 2;
      else
        Sp = Sq = 3;
  else
      Sp = Sq = bSideQisLargeBlk ? 5:3
}
```

where edge equal to 0 corresponds to CU boundary, edge equal to 2 or equal to orthogonalLength-2 corresponds to sub-block boundary 8 samples from a CU boundary etc. Where implicit TU is true if implicit split of TU is used.

### 3.7 Sample Adaptive Offset

Sample adaptive offset (SAO) is applied to the reconstructed signal after the deblocking filter by using offsets specified for each CTB by the encoder. The video encoder first makes the decision on whether or not the SAO process is to be applied for current slice. If SAO is applied for the slice, each CTB is classified as one of five SAO types as shown in Table 4. The concept of SAO is to classify pixels into categories and reduces the distortion by adding an offset to pixels of each category. SAO operation includes edge offset (EO) which uses edge properties for pixel classification in SAO type 1 to 4 and band offset (BO) which uses pixel intensity for pixel classification in SAO type 5. Each applicable CTB has SAO parameters including sao_merge_left_flag, sao_merge_up_flag, SAO type and four offsets. If sao merge_left_flag is equal to 1, the current CTB will reuse the SAO type and offsets of the CTB to the left. If sao_merge_up_flag is equal to 1, the current CTB will reuse SAO type and offsets of the CTB above.

TABLE 4
Specification of SAO type

| | sample adaptive offset type to be | Number of |
|---|---|---|
| SAO type | used | categories |
| 0 | None | 0 |
| 1 | 1-D 0-degree pattern edge offset | 4 |
| 2 | 1-D 90-degree pattern edge offset | 4 |
| 3 | 1-D 135-degree pattern edge offset | 4 |
| 4 | 1-D 45-degree pattern edge offset | 4 |
| 5 | band offset | 4 |

### 3.8 Adaptive Loop Filter

Adaptive loop filtering for video coding is to minimize the mean square error between original samples and decoded samples by using Wiener-based adaptive filter. The ALF is located at the last processing stage for each picture and can be regarded as a tool to catch and fix artifacts from previous stages. The suitable filter coefficients are determined by the encoder and explicitly signaled to the decoder. To achieve better coding efficiency, especially for high resolution videos, local adaptation is used for luma signals by applying different filters to different regions or blocks in a picture. In addition to filter adaptation, filter on/off control at coding tree unit (CTU) level is also helpful for improving coding efficiency. Syntax-wise, filter coefficients are sent in a picture level header called adaptation parameter set, and filter on/off flags of CTUs are interleaved at CTU level in the slice data. This syntax design not only supports picture level optimization but also achieves a low encoding latency.

### 3.8.1 Signaling of Parameters

According to ALF design in VTM, filter coefficients and clipping indices are carried in ALF APSs. An ALF APS can include up to 8 chroma filters and one luma filter set with up to 25 filters. An index is also included for each of the 25 luma classes. Classes having the same index share the same filter. By merging different classes, the num of bits required to represent the filter coefficients is reduced. The absolute value of a filter coefficient is represented using a 0th order Exp-Golomb code followed by a sign bit for a non-zero coefficient. When clipping is enabled, a clipping index is also signaled for each filter coefficient using a two-bit fixed-length code. Up to 8 ALF APSs can be used by the decoder at the same time.

Filter control syntax elements of ALF in VTM include two types of information. First, ALF on/off flags are signaled at sequence, picture, slice and CTB levels. Chroma ALF can be enabled at picture and slice level only if luma ALF is enabled at the corresponding level. Second, filter usage information is signaled at picture, slice and CTB level, if ALF is enabled at that level. Referenced ALF APSs identifiers (IDs) are coded at a slice level or at a picture level if all the slices within the picture use the same APSs. Luma component can reference up to 7 ALF APSs and chroma components can reference 1 ALF APS. For a luma CTB, an index is signalled indicating which ALF APS or offline trained luma filter set is used. For a chroma CTB, the index indicates which filter in the referenced APS is used.

The data syntax elements of ALF associated to LUMA component in VTM are listed as follows:

| | Descriptor |
|---|---|
| alf_data( ) { | |
| alf_luma_filter_signal_flag | u(1) |
| if( alf_luma_filter_signal_flag ) { | |
| alf_luma_clip_flag | u(1) |
| alf_luma_num_filters_signalled_minus1 | ue(v) |
| if( alf_luma_num_filters_signalled_minus1 > 0 ) | |
| for( filtIdx = 0; filtIdx < NumAlfFilters; filtIdx++ ) | |
| alf_luma_coeff_delta_idx[ filtIdx ] | u(v) |
| for( sfIdx = 0; sfIdx <= alf_luma_num_filters_signalled_minus1; sfIdx++ ) | |
| for( j = 0; j < 12; j++ ) { | |
| alf_luma_coeff_abs[ sfIdx ][ j ] | ue(v) |
| if( alf_luma_coeff_abs[ sfIdx ][ j ] ) | |
| alf_luma_coeff_sign[ sfIdx ][ j ] | u(1) |
| } | |
| if( alf_luma_clip_flag ) | |
| for( sfIdx = 0; sfIdx <= alf_luma_num_filters_signalled_minus1; sfIdx++ ) | |
| for( j = 0; j < 12; j++ ) | |
| alf_luma_clip_idx[ sfIdx ][ j ] | u(2) |
| } | |

alf_luma_filter_signal flag equal to 0 specifies that a luma filter set is not signalled. alf_luma_clip_flag equal to o specifies that linear adaptive loop filtering is applied to the luma component. alf_luma_clip_flag equal to 1 specifies that non-linear adaptive loop filtering could be applied to the luma component. alf_luma_num_filters_signalled_minus1 plus 1 specifies the number of adpative loop filter classes for which luma coefficients can be signalled. The value of alf_luma_num_filters_signalled_minus1 shall be in the range of o to NumAlffilters−1, inclusive. alf_luma_coeff_delta_idx[filtIdx] specifies the indices of the signalled adaptive loop filter luma coefficient deltas for the filter class indicated by filtIdx ranging from 0 to NumAlffilters−1. When alf_luma_coeff_delta_idx[filtIdx] is not present, it is inferred to be equal to 0. The length of alf_luma_coeff_delta_idx[filtIdx] is Ceil(Log 2(alf_luma_num_filters_signalled_minus1+1)) bits. The value of alf_luma_coeff_delta_idx[filtIdx] shall be in the range of 0 to alf_luma_num_filters_signalled_minus1, inclusive.

alf_luma_coeff_abs[sfIdx][j] specifies the absolute value of the j-th coefficient of the signalled luma filter indicated by sfIdx. When alf_luma_coeff_abs[sfIdx]L[ij] is not present, it is inferred to be equal 0. The value of alf_luma_coeff_abs[sfIdx]L[j] shall be in the range of 0 to 128, inclusive. alf_luma_coeff_sign[sfIdx][j] specifies the sign of the j-th luma coefficient of the filter indicated by sfIdx as follows:

If alf_luma_coeff_sign[ sfIdx ][ j ] is equal to 0, the corresponding luma filter coefficient has a positive
value.
Otherwise ( alf_luma_coeff_sign[ sfIdx ][ j ] is equal to 1 ), the corresponding luma filter coefficient has
a negative value.

When alf_luma_coeff_sign[sfIdx][j] is not present, it is iferred to be equal to 0.

alf_luma_clip_idx[sfIdx][i] specifies the clipping index of the clipping value to use before multiplying by the j-th coefficient of the signalled luma filter indicated by sfIdx. When alf_luma_clip_idx[sfIdx][j] is not present, it is inferred to be equal to 0. The coding tree unit syntax elements of ALF associated to LUMA component in VTM are listed as follows:

| | Descriptor |
|---|---|
| coding_tree_unit( ) { | |
| xCtb = CtbAddrX << CtbLog2SizeY | |
| yCtb = CtbAddrY << CtbLog2SizeY | |
| if( sh_alf_enabled_flag ){ | |
| alf_ctb_flag[ 0 ][ CtbAddrX ][ CtbAddrY ] | ae(v) |
| if( alf_ctb_flag[ 0 ][ CtbAddrX ][ CtbAddrY ] ) { | |
| if( sh_num_alf_aps_ids_luma > 0 ) | |
| alf_use_aps_flag | ae(v) |
| if( alf_use_aps_flag ) { | |
| if( sh_num_alf_aps_ids_luma > 1 ) | |
| alf_luma_prev_filter_idx | ae(v) |
| } else | |
| alf_luma_fixed_filter_idx | ae(v) |
| } | |
| } | |

alf_ctb_flag[cIdx][xCtb>>CtbLog 2SizeY][yCtb>>CtbLog 2SizeY] equal to 1 specifies that the adaptive loop filter is applied to the coding tree block of the colour component indicated by cIdx of the coding tree unit at luma location (xCtb, yCtb). alf_ctb_flag[cIdx][xCtb>>CtbLog 2SizeY][yCtb>>CtbLog 2SizeY] equal to 0 specifies that the adaptive loop filter is not applied to the coding tree block of the colour component indicated by cIdx of the coding tree unit at luma location (xCtb, yCtb).

When alf_ctb_flag[cIdx][xCtb>>CtbLog 2SizeY][yCtb CtbLog 2SizeY] is not present, it is inferred to be equal to 0. alf_use_aps_flag equal to 0 specifies that one of the fixed filter sets is applied to the luma CTB. alf_use_aps_flag equal to 1 specifies that a filter set from an APS is applied to the luma CTB. When alf_use_aps_flag is not present, it is inferred to be equal to 0. alf_luma_prev_filter_idx specifies the previous filter that is applied to the luma CTB. The value of alf_luma_prev_filter_idx shall be in a range of 0 to sh_num_alf_aps_ids_luma−1, inclusive. When alf_luma_prev_filter_idx is not present, it is inferred to be equal to 0.

The variable AlfCtbFiltSetIdxY[xCtb>>CtbLog 2SizeY][yCtb>>CtbLog 2SizeY] specifying the filter set index for the luma CTB at location (xCtb, yCtb) is derived as follows:

If alf_use_aps_flag is equal to 0,
AlfCtbFiltSetIdxY[ xCtb >> CtbLog2SizeY ][ yCtb >> CtbLog2SizeY ] is set equal to
alf_luma_fixed_filter_idx.
Otherwise, AlfCtbFiltSetIdxY[ xCtb >> CtbLog2SizeY ][ yCtb >> CtbLog2SizeY ] is set equal to
16 + alf_luma_prev_filter_idx.

alf_luma_fixed_filter_idx specifies the fixed filter that is applied to the luma CTB. The value of alf_luma_fixed_filter_idx shall be in a range of 0 to 15, inclusive.

Based on the ALF design of VTM, the ALF design of ECM further introduces the concept of alternative filter sets into luma filters. The luma filters are be trained multiple alternatives/rounds based on the updated luma CTU ALF on/off decisions of each alternative/rounds. In such way, there will be multiple filter sets that associated to each training alternative and the class merging results of each filter set may be different. Each CTU could select the best filter set by RDO and the related alternative information will be signaled. The data syntax elements of ALF associated to LUMA component in ECM are listed as follows:

| | Descriptor |
|---|---|
| alf_data( ) { | |
| alf_luma_filter_signal_flag | u(1) |
| if( alf_luma_filter_signal_flag ) { | |
| alf_luma_num_alts_minus1 | ue(v) |
| for(altIdx = 0; altIdx < alf_luma_num_alts_minus1 +1; altIdx++){ | |
| alf_luma_clip_flag[altIdx] | u(1) |
| alf_luma_num_filters_signalled_minus1[altIdx] | ue(v) |
| if(alf_luma_num_filters_signalled_minus1[altIdx] > 0){ | |
| for( filtIdx = 0; filtIdx < NumAlfFilters; filtIdx++ ) | |
| alf_luma_coeff_delta_idx[altIdx][filtIdx] | u(v) |
| } | |
| for(sfIdx = 0; sfIdx <= alf_luma_num_filters_signalled_minus1[altIdx]; | |
| sfIdx++){ | |
| for(j = 0; j < 19; j++){ | |
| alf_luma_coeff_abs[altIdx][ sfIdx ][ j ] | ue(v) |
| if( alf_luma_coeff_abs[altIdx][ sfIdx ][ j ] ) | |
| alf_luma_coeff_sign[altIdx][ sfIdx ][ j ] | u(1) |
| } | |
| } | |
| if( alf_luma_clip_flag [altIdx]) | |
| for( sfIdx = 0; sfIdx <= alf_luma_num_filters_signalled_minus1[altIdx]; | |
| sfIdx++ ) | |
| for( j = 0; j <19; j++ ) | |
| alf_luma_clip_idx[altIdx][ sfIdx ][ j ] | u(2) |
| } | |
| } | |

alf_luma_num_alts_minus1 plus 1 specifies the number of alternative filter sets for luma component. The value of alf_luma_num_alts_minus1 shall be in the range of 0 to 3, inclusive. alf_luma_clip_flag[altIdx] equal to 0 specifies that linear adaptive loop filtering is applied to the alternative luma filter set with index altIdxluma component. alf_luma_clip_flag[altIdx] equal to 1 specifies that non-linear adaptive loop filtering could be applied to the alternative luma filter set with index altIdx luma component. alf_luma_num_filters_signalled_minus1[altIdx] plus 1 specifies the number of adpative loop filter classes for which luma coefficients can be signalled of the alternative luma filter set with index altIdx. The value of alf_luma_num_filters_signalled_minus1[altIdx] shall be inthe range of 0 to NumAlffilters−1, inclusive.

alf_luma_coeff_delta_idx[altIdx][filtIdx] specifies the indices of the signalled adaptive loop filter luma coefficient deltas for the filter class indicated by filtIdx ranging from 0 to NumAlffilters−1 for the alternative luma filter set with index altIdx. When alf_luma_coeff_delta_idx[filtIdx][altIdx] is not present, it is inferred to be equal to 0. The length of alf_luma_coeff_delta_idx[altIdx][filtIdx] is Ceil(Log 2(alf_luma_num_filters_signalled_minus1[altIdx]+1)) bits. The value of alf_luma_coeff_delta_idx[altIdx][filtIdx] shall be in the range of 0 to alf_luma_num_filters_signalled_minus1[altIdx], inclusive. alf_luma_coeff_abs[altIdx][sfIdx][j] specifies the absolute value of the j-th coefficient of the signalled luma filter indicated by sfIdx of the alternative luma filter set with index altIdx. When alf_luma_coeff_abs[altIdx][sfIdx][j] is not present, it is inferred to be equal 0. The value of alf_luma_coeff_abs[altIdx][sfIdx][j] shall be in the range of 0 to 128, inclusive.

alf_luma_coeff_sign[altIdx][sfIdx][j] specifies the sign of the j-th luma coefficient of the filter indicated by sfIdx of the alternative luma filter set with index altIdx as follows:

If alf_luma_coeff_sign[altIdx][ sfIdx ][ j ] is equal to 0, the corresponding luma filter coefficient has a
positive value.
Otherwise (alf_luma_coeff_sign[altIdx][ sfIdx ][ j ] is equal to 1), the corresponding luma filter
coefficient has a negative value.

When alf_luma_coeff_sign[altIdx][sfIdx][j] is not present, it is inferred to be equal to 0.

alf_luma_clip_idx[altIdx][sfIdx][i] specifies the clipping index of the clipping value to use before multiplying by the j-th coefficient of the signalled luma filter indicated by sfIdx of the alternative luma filter set with index altIdx. When alf_luma_clip_idx[altIdx][sfIdx][j] is not present, it is inferred to be equal to 0. The coding tree unit syntax elements of ALF associated to LUMA component in ECM are listed as follows:

| | Descriptor |
|---|---|
| coding_tree_unit( ) { | |
| xCtb = CtbAddrX << CtbLog2SizeY | |
| yCtb = CtbAddrY << CtbLog2SizeY | |
| if( sh_alf_enabled_flag ){ | |
| alf_ctb_flag[ 0 ][ CtbAddrX ][ CtbAddrY ] | ae(v) |
| if( alf_ctb_flag[ 0 ][ CtbAddrX ][ CtbAddrY ] ) { | |
| if( sh_num_alf_aps_ids_luma > 0 ) | |
| alf_use_aps_flag | ae(v) |
| if( alf_use_aps_flag ) { | |
| if( sh_num_alf_aps_ids_luma > 1 ) | |
| alt_ctb_luma_filter_alt_idx[CtbAddrX][CtbAddrY] | ae(v) |
| alf_luma_prev_filter_idx | ae(v) |
| } else | |
| alf_luma_fixed_filter_idx | ae(v) |
| } | |
| } | |

alf_ctb_luma_filter_alt_idx[xCtb>>CtbLog 2SizeY][yCtb>>CtbLog 2SizeY] specifies the index of the alternative luma filters applied to the coding tree block of the luma component, of the coding tree unit at luma location (xCtb, yCtb). When alf_ctb_luma_filter_alt_idx[xCtb>>CtbLog 2SizeY][yCtb>>CtbLog 2SizeY] is not present, it is inferred to be equal to zero.

### 3.8.2 Filter Shapes

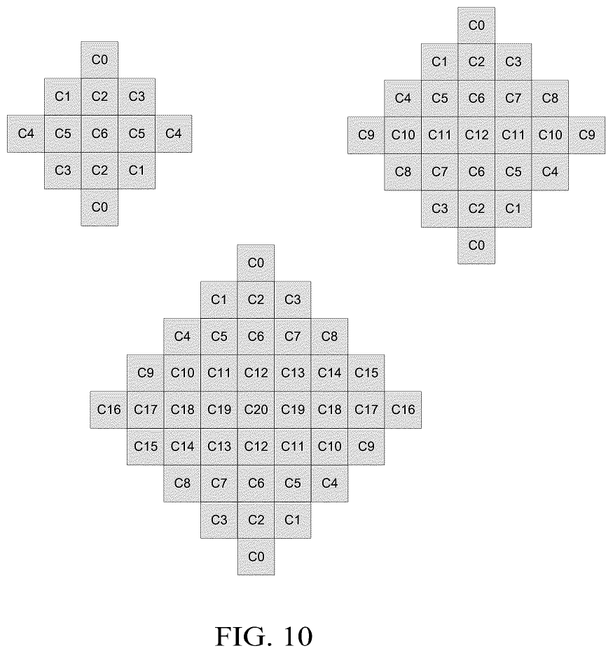

In the JEM, up to three diamond filter shapes (as shown in FIG. 10) can be selected for the luma component. An index is signalled at the picture level to indicate the filter shape used for the luma component. Each square represents a sample, and Ci (i being 0˜6 (left), 0˜12 (middle), 0˜20 (right)) denotes the coefficient to be applied to the sample. For chroma components in a picture, the 5×5 diamond shape is always used. In VVC, the 7×7 diamond shape is always used for Luma while the 5×5 diamond shape is always used for Chroma.

### 3.8.3 Classification for ALF

Each 2×2 (or 4×4) block is categorized into one out of 25 classes. The classification index C is derived based on its directionality D and a quantized value of activity Â, as follows:

$$C = 5 D + \hat{A} .$$

To calculate D and Â, gradients of the horizontal, vertical and two diagonal direction are first calculated using 1-D Laplacian:

$${g}_{v} = {\sum }_{k = i - 2}^{i + 3} {\sum }_{l = j - 2}^{j + 3} {V}_{k , l} , {V}_{k , l} = \vert 2 R ( k , l ) - R ( k , l - 1 ) - R ( k , l + 1 ) \vert ,$$

$${g}_{h} = {\sum }_{k = i - 2}^{i + 3} {\sum }_{l = j - 2}^{j + 3} {H}_{k , l} , {H}_{k , l} = \vert 2 R ( k , l ) - R ( k - 1 , l ) - R ( k + 1 , l ) \vert ,$$

$${g}_{d 1} = {\sum }_{k = i - 2}^{i + 3} {\sum }_{l = j - 3}^{j + 3} D {1}_{k , l} , D {1}_{k , l} = \vert 2 R ( k , l ) - R ( k - 1 , l - 1 ) - R ( k + 1 , l + 1 ) \vert$$

$${g}_{d 2} = {\sum }_{k = i - 2}^{i + 3} {\sum }_{j = j - 2}^{j + 3} D {2}_{k , l} , D {2}_{k , l} = \vert 2 R ( k , l ) - R ( k - 1 , l + 1 ) - R ( k + 1 , l - 1 ) \vert$$

Indices i and j refer to the coordinates of the upper left sample in the 2×2 block and R(i, j) indicates a reconstructed sample at coordinate (i, j). Then D maximum and minimum values of the gradients of horizontal and vertical directions are set as:

$${g}_{h , v}^{max} = max ( {g}_{h} , {g}_{v} ) , {g}_{h , v}^{min} = min ( {g}_{h} , {g}_{v} ) ,$$

and the maximum and minimum values of the gradient of two diagonal directions are set as:

$${g}_{d 0 , d 1}^{max} = max ( {g}_{d 0} , {g}_{d 1} ) , {g}_{d 0 , d 1}^{min} = min ( {g}_{d 0} , {g}_{d 1} ) ,$$

To derive the value of the directionality D, these values are compared against each other and with two thresholds t₁ and t₂:

$$Step 1. If both {g}_{h , v}^{max} \leq {t}_{1} \cdot {g}_{h , v}^{min} and {g}_{d 0 , d 1}^{max} \leq {t}_{1} \cdot {g}_{d 0 , d 1}^{min} are true , D is set to 0.$$

$$Step 2. If {g}_{h , v}^{max} / {g}_{h , v}^{min} > {g}_{d 0 , d 1}^{max} / {g}_{d 0 , d 1}^{min} , continue from Step 3 ; otherwise continue from Step 4.$$

$$Step 3. If {g}_{h , v}^{max} > {t}_{2} \cdot {g}_{h , v}^{min} , D is set to 2 ; otherwise D is set to 1.$$

$$Step 4. If {g}_{d 0 , d 1}^{max} > {t}_{2} \cdot {g}_{d 0 , d 1}^{min} , D is set to 4 ; otherwise D is set to 3.$$

The activity value A is calculated as:

$$A = {\sum }_{k = i - 2}^{i + 3} {\sum }_{l = j - 2}^{j + 3} ( {V}_{k , l} + {H}_{k , l} ) .$$

A is further quantized to the range of 0 to 4, inclusively, and the quantized value is denoted as Â. For both chroma components in a picture, no classification method is applied, i.e. a single set of ALF coefficients is applied for each chroma component.

### 3.8.4 Geometric Transformations of Filter Coefficients

Before filtering each 2×2 block, geometric transformations such as rotation or diagonal and vertical flipping are applied to the filter coefficients f(k, l), which is associated with the coordinate (k, l), depending on gradient values calculated for that block. This is equivalent to applying these transformations to the samples in the filter support region. The idea is to make different blocks to which ALF is applied more similar by aligning their directionality.

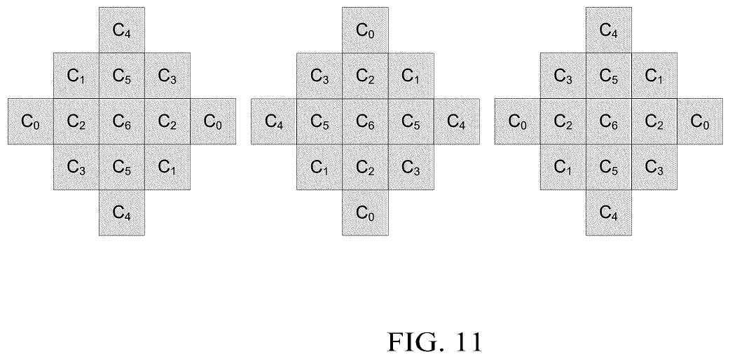

Three geometric transformations, including diagonal, vertical flip and rotation are introduced:

$$Diagonal : {f}_{D} ( k , l ) = f ( l , k ) ,$$

$$Vertical Flip : {f}_{V} ( k , l ) = f ( k , K - l - 1 ) ,$$

$$Rotation : {f}_{R} ( k , l ) = f ( K - l - 1 , k ) .$$

where K is the size of the filter and 0≤k, l≤K−1 are coefficients coordinates, such that location (0,0) is at the upper left corner and location (K−1, K−1) is at the lower right corner. The transformations are applied to the filter coefficients f (k, l) depending on gradient values calculated for that block. The relationship between the transformation and the four gradients of the four directions are summarized in Table 5. FIG. 11 shows the transformed coefficients for each position based on the 5×5 diamond.

TABLE 5
Mapping of the gradient calculated for
one block and the transformations.

| Gradient values | Transformation |
|---|---|
| g_{d2} < g_{d1} and gₕ < gᵥ | No transformation |
| g_{d2} < g_{d1} and gᵥ < gₕ | Diagonal |
| g_{d1} < g_{d2} and gₕ < gᵥ | Vertical flip |
| g_{d1} < g_{d2} and gᵥ < gₕ | Rotation |

### 3.8.5 Filtering Process

At decoder side, when ALF is enabled for a block, each sample R(i, j) within the block is filtered, resulting in sample value R′(i, j) as shown below, where L denotes filter length, f_{m,n} represents filter coefficient, and f(k, l) denotes the decoded filter coefficients.

$${R}^{′} ( i , j ) = {\sum }_{k = - L / 2}^{L / 2} {\sum }_{l = - L / 2}^{L / 2} f ( k , l ) \times R ( i + k , j + l )$$

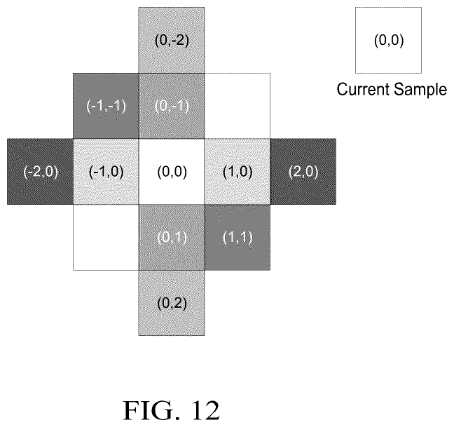

FIG. 12 shows an example of relative coordinates used for 5×5 diamond filter support supposing the current sample's coordinate (i, j) to be (0, 0). Samples in different coordinates filled with the same color are multiplied with the same filter coefficients.

### 3.8.6 Non-Linear Filtering Reformulation

Linear filtering can be reformulated, without coding efficiency impact, in the following expression:

$$O ( x , y ) = I ( x , y ) + {\sum }_{( i , j ) \neq ( 0 , 0 )} w ( i , j ) \cdot ( I ( x + i , y + j ) - I ( x , y ) )$$

where w(i, j) are the same filter coefficients.

VVC introduces the non-linearity to make ALF more efficient by using a simple clipping function to reduce the impact ofneighbor sample values (l(x+i, y+j)) when they are too different with the current sample value (l(x, y)) being filtered. More specifically, the ALF filter is modified as follows:

$${O}^{′} ( x , y ) = I ( x , y ) + {\sum }_{( i , j ) \neq ( 0 , 0 )} w ( i , j ) \cdot K ( I ( x + i , y + j ) - I ( x , y ) , k ( i , j ) )$$

where K(d, b)=min(b, max(−b, d)) is the clipping function, and k(i,j) are clipping parameters, which depends on the (i, j) filter coefficient. The encoder performs the optimization to find the best k(i, j).

The clipping parameters k(i, j) are specified for each ALF filter, one clipping value is signaled per filter coefficient. It means that up to 12 clipping values can be signaled in the bitstream per Luma filter and up to 6 clipping values for the Chroma filter. In order to limit the signaling cost and the encoder complexity, only 4 fixed values which are the same for INTER and INTRA slices are used.

Because the variance of the local differences is often higher for Luma than for Chroma, two different sets for the Luma and Chroma filters are applied. The maximum sample value (here 1024 for 10 bits bit-depth) in each set is also introduced, so that clipping can be disabled if it is not necessary. The 4 values have been selected by roughly equally splitting, in the logarithmic domain, the full range of the sample values (coded on 10 bits) for Luma, and the range from 4 to 1024 for Chroma. More precisely, the Luma table of clipping values have been obtained by the following formula:

$${AlfClip}_{L} = \{ round ( {( {( M )}^{\frac{1}{N}} )}^{N - n + 1} ) for n ∈ 1 ... N ] \} , with M = {2}^{10} and N = 4$$

Similarly, the Chroma tables of clipping values is obtained according to the following formula:

$${AlfClip}_{C} = \{ round ( A \cdot {( {( \frac{M}{A} )}^{\frac{1}{N - 1}} )}^{N - n} ) for n ∈ 1 ... N ] \} , with M = {2}^{10} , N = 4 and A = 4$$

### 3.9 Bilateral in-Loop Filter

### 3.9.1 Bilateral Image Filter

Bilateral image filter is a nonlinear filter that smooths the noise while preserving edge structures. The bilateral filtering is a technique to make the filter weights decrease not only with the distance between the samples but also with increasing difference in intensity. This way, over-smoothing of edges can be ameliorated. A weight is defined as

$$w ( Δ x , Δ y , Δ I ) = {e}^{- \frac{Δ {x}^{2} + Δ {y}^{2}}{2 {σ}_{d}^{2}} - \frac{Δ {I}^{2}}{2 {σ}_{r}^{2}}}$$

where Δx and Δy is the distance in the vertical and horizontal and ΔI is the difference in intensity between the samples.

The edge-preserving de-noising bilateral filter adopts a low-pass Gaussian filter for both the domain filter and the range filter. The domain low-pass Gaussian filter gives higher weight to pixels that are spatially close to the center pixel. The range low-pass Gaussian filter gives higher weight to pixels that are similar to the center pixel. Combining the range filter and the domain filter, a bilateral filter at an edge pixel becomes an elongated Gaussian filter that is oriented along the edge and is greatly reduced in gradient direction. This is the reason why the bilateral filter can smooth the noise while preserving edge structures.

### 3.9.2 Bilateral Filter in Video Coding

The bilateral filter in video coding is a coding tool for the VVC [2]. The filter acts as a loop filter in parallel with the sample adaptive offset (SAO) filter. Both the bilateral filter and SAO act on the same input samples, each filter produces an offset, and these offsets are then added to the input sample to produce an output sample that, after clipping, goes to the next stage. The spatial filtering strength σ_{d} is determined by the block size, with smaller blocks filtered more strongly, and the intensity filtering strength σᵣ is determined by the quantization parameter, with stronger filtering being used for higher QPs. Only the four closest samples are used, so the filtered sample intensity I_{F} can be calculated as

$${I}_{F} = {I}_{C} + \frac{{W}_{A} Δ {I}_{A} + {W}_{B} Δ {I}_{B} + {W}_{L} Δ {I}_{L} + {W}_{R} Δ {I}_{R}}{{W}_{C} + {W}_{A} + {W}_{B} + {W}_{L} + {W}_{R}}$$

where I_{C} denotes the intensity of the center sample, ΔI_{A}=I_{A}−I_{C} the intensity difference between the center sample and the sample above. ΔI_{B}, ΔI_{L} and ΔI_{R} denote the intensity difference between the center sample and that of the sample below, to the left and to the right respectively.

### 4. TECHNICAL PROBLEMS SOLVED BY DISCLOSED TECHNICAL SOLUTIONS

Example designs for adaptive loop filters (ALF) in video coding have the following problems:

First, in an example ALF design, the filtering unit is always equal to CTU size. The neighbor CTUs may have similar texture features. They may share the same filter parameters and save bits cost in signaling.

Second, in an example ALF design, the filtering unit is always equal to CTU size. The co-variance matrix build for each CTU may increase a lot of memory cost. Reduce the filtering unit number by adjusting the filtering unit may be more friendly to memory cost.

### 5. A LISTING OF SOLUTIONS AND EMBODIMENTS

To solve the above-described problems, methods as summarized below are disclosed. The embodiments should be considered as examples to explain the general concepts and should not be interpreted in a narrow way. Furthermore, these embodiments can be applied individually or combined in any manner.

It should be noted that described methods may be used as in-loop filters or post-processing.

In this disclosure, a video unit may refer to a sequence, a picture, a sub-picture, a slice, a CTU, a block, and/or a region. The video unit may comprise one color component or multiple color components.

In this disclosure, an ALF processing unit may refer to a sequence, a picture, a sub-picture, a slice, a CTU, a block, a region, or a sample. The ALF processing unit may comprise one color component or it may comprise multiple color components.
1) It is proposed that the shape and/or size of the filtering unit may be changed in different sequences or different pictures or different slices or different sub-pictures.
   a. The filtering unit may be for Luma-ALF or cross component adaptive loop filter (CCALF) or Chroma-ALF.
   b. The filtering unit which may be changed may be denoted as “adaptive filtering unit”.
   c. The shape and/or size of a filtering unit may depend on color component/color format.
   d. The shape and/or size of a filtering unit may be signaled with at least one syntax element (SE), such as in SPS/PPS/picture header/slice header/CTU/etc.
      a) The SE may be an index reflecting the shape and/or size of a filtering unit.
      b) The SE may be coded be binarized as a flag, a fixed length code, an exponential Golomb (EG(x)) code, a unary code, a truncated unary code, a truncated binary code, etc. It can be signed or unsigned.
      c) The syntax element disclosed above may be coded with at least one context model. Or it may be bypass coded.
      d) The syntax element disclosed above may be signaled in a conditional way.
2) It is proposed to use adaptive filtering unit for ALF.
   a. In one example, the adaptive filtering unit may apply to different color components.
      a) In one example, the adaptive filtering unit may only apply to luma component.
      b) In one example, the adaptive filtering unit may only apply to chroma components.
      c) In one example, the adaptive filtering unit may apply to both luma and chroma components.
   b. In one example, the filtering unit size of ALF may depend on CTU/CU/TU/PU size.
      a) In one example, the filtering unit width may be up-scaled from CTU/CU/TU/PU width by factor uw (i.e., fw=2).
      b) In one example, the filtering unit height may be up-scaled from CTU/CU/TU/PU height by factor uh (i.e., fh=2).
      c) In one example, the filtering unit width may be down-scaled from CTU/CU/TU/PU width by factor dw (i.e., dw=0.5).
      d) In one example, the filtering unit height may be down-scaled from CTU/CU/TU/PU height by factor dh (i.e., dh=0.5).
   c. In one example, the filtering unit size of ALF may depend on pre-defined values.
      a) In one example, the filtering unit width may be M (i.e., M=128/256/512).
      b) In one example, the filtering unit height may be N (i.e., N=128/256/512).
   d. In one example, the filtering unit of ALF may depend on picture/slice/tile size.
      a) In one example, the filtering unit size may be different for different picture/slice/tile size or shape.
      b) In one example, the filtering unit size may be equal for different picture/slice/tile size or shape.
      c) In one example, the filtering unit shape may be different for different picture/slice/tile size or shape.
      d) In one example, the filtering unit shape may be equal for different picture/slice/tile size or shape.
   e. In one example, the filtering unit shape may be different shapes.
      a) In one example, the filtering unit shape may be a square.
      b) In one example, the filtering unit shape may be a diamond.
      c) In one example, the filtering unit shape may be a rectangle.
      d) In one example, the filtering unit shape may be other shapes.
   f. In one example, the enable/disable decision may be applied to each filtering unit.
      a) In one example, the on/off decision may be signaled/derived/pre-defined for each filtering unit.
      b) In one example, the on/off decision of Luma-ALF may be signaled/derived/pre-defined for each Luma-ALF filtering unit.
      c) In one example, the on/off decision of Chroma-ALF may be signaled/derived/pre-defined for each Chroma-ALF filtering unit.
   g. In one example, the filter parameters may be shared inside each filtering unit.
      a) In one example, the parameter/parameter-set/parameter-set-index/other parameter settings may be signaled/derived/pre-defined for each filtering unit.
      b) In one example, the parameter-set index (i.e., APS index) may be signaled/derived/pre-defined for each Luma-ALF filtering unit.
      c) In one example, the parameter index (i.e., filter-set index, classifier index or clipping index) may be signaled/derived/pre-defined for each Luma-ALF filtering unit.
      d) In one example, the parameter-set index (i.e., APS index) may be signaled/derived/pre-defined for each Chroma-ALF filtering unit.
      e) In one example, the parameter index (i.e., filter-set index, classifier index or clipping index) may be signaled/derived/pre-defined for each Chroma-ALF filtering unit.
   h. In one example, the filter reference decision may be applied to each filtering unit.
      a) In one example, the parameter reference decision (i.e., APS index/filter index) may be signaled/derived/pre-defined for each filtering unit.
   i. In one example, one or more syntax element may be signaled/derived/pre-defined to indicate whether the adaptive filtering unit is applied to ALF
      a) In one example, one or more syntax element at SPS level may be signaled/derived/pre-defined to indicate whether the adaptive filtering unit is applied to ALF.
      b) In one example, one or more syntax element at SPS/picture header/slice header/APS/CTU/CU/TU/PU level may be signaled/derived/pre-defined to indicate whether the adaptive filtering unit is applied to ALF.
3) It is proposed to use adaptive filtering unit for CCALF.
   a. In one example, the adaptive filtering unit may apply to different color components.
      a) In one example, the adaptive filtering unit may only apply to one of the chroma components (i.e., only Cb or Cr).
      b) In one example, the adaptive filtering unit may apply to both chroma components.
   b. In one example, the filtering unit size of CCALF may depend on CTU/CU/TU/PU size.
      a) In one example, the filtering unit width may be up-scaled from CTU/CU/TU/PU width by factor uw (i.e., fw=2).
      b) In one example, the filtering unit height may be up-scaled from CTU/CU/TU/PU height by factor uh (i.e., fh=2).
      c) In one example, the filtering unit width may be down-scaled from CTU/CU/TU/PU width by factor dw (i.e., dw=0.5).
      d) In one example, the filtering unit height may be down-scaled from CTU/CU/TU/PU height by factor dh (i.e., dh=0.5).
   c. In one example, the filtering unit size of CCALF may depend on pre-defined values.
      a) In one example, the filtering unit width may be M (i.e., M=128/256/512).
      b) In one example, the filtering unit height may be N (i.e., N=128/256/512).
   d. In one example, the filtering unit of CCALF may depend on picture/slice/tile size.
      a) In one example, the filtering unit size may be different for different picture/slice/tile size or shape.
      b) In one example, the filtering unit size may be equal for different picture/slice/tile size.
      c) In one example, the filtering unit shape may be different for different picture/slice/tile size.
      d) In one example, the filtering unit shape may be equal for different picture/slice/tile size.
   e. In one example, the filtering unit shape may be different shapes.
      a) In one example, the filtering unit shape may be a square.
      b) In one example, the filtering unit shape may be a diamond.
      c) In one example, the filtering unit shape may be a rectangle.
      d) In one example, the filtering unit shape may be other shapes.
   f. In one example, the enable/disable decision may be applied to each filtering unit.
      a) In one example, the on/off decision may be signaled/derived/pre-defined for each filtering unit.
      b) In one example, the on/off decision of Cb-CCALF may be signaled/derived/pre-defined for each Cb-CCALF filtering unit.
      c) In one example, the on/off decision of Cr-CCALF may be signaled/derived/pre-defined for each Cr-CCALF filtering unit.
   g. In one example, the filter parameters may be shared inside each filtering unit.
      a) In one example, the parameter/parameter-set/parameter-set-index/other parameter settings may be signaled/derived/pre-defined for each filtering unit.
   h. In one example, the filter reference decision may be applied to each filtering unit.
      a) In one example, the parameter reference decision (i.e., APS index/Filter index) may be signaled/derived/pre-defined for each filtering unit.
   i. In one example, one or more syntax element may be signaled/derived/pre-defined to indicate whether the adaptive filtering unit is applied to CCALF
      a) In one example, one or more syntax element at SPS level may be signaled/derived/pre-defined to indicate whether the adaptive filtering unit is applied to CCALF.
      b) In one example, one or more syntax element at SPS/picture header/slice header/APS/CTU/CU/TU/PU level may be signaled/derived/pre-defined to indicate whether the adaptive filtering unit is applied to CCALF.
4) It is proposed to use adaptive filtering unit for SAO.
   a. In one example, the adaptive filtering unit may apply to different color components.
      a) In one example, the adaptive filtering unit may only apply to luma component.
      b) In one example, the adaptive filtering unit may only apply to chroma components.
      c) In one example, the adaptive filtering unit may apply to both luma and chroma components.
   b. In one example, the filtering unit size of SAO may depend on CTU/CU/TU/PU size.
      a) In one example, the filtering unit width may be up-scaled from CTU/CU/TU/PU width by factor uw (i.e., fw=2).
      b) In one example, the filtering unit height may be up-scaled from CTU/CU/TU/PU height by factor uh (i.e., fh=2).
      c) In one example, the filtering unit width may be down-scaled from CTU/CU/TU/PU width by factor dw (i.e., dw=0.5).
      d) In one example, the filtering unit height may be down-scaled from CTU/CU/TU/PU height by factor dh (i.e., dh=0.5).
   c. In one example, the filtering unit size of SAO may depend on pre-defined values.
      a) In one example, the filtering unit width may be M (i.e., M=128/256/512).
      b) In one example, the filtering unit height may be N (i.e., N=128/256/512).
   d. In one example, the filtering unit of SAO may depend on picture/slice/tile size.
      a) In one example, the filtering unit size may be different for different picture/slice/tile size or shape.
      b) In one example, the filtering unit size may be equal for different picture/slice/tile size or shape.
      c) In one example, the filtering unit shape may be different for different picture/slice/tile size or shape.
      d) In one example, the filtering unit shape may be equal for different picture/slice/tile size or shape.
   e. In one example, the filtering unit shape may be different shapes.
      a) In one example, the filtering unit shape may be a square.
      b) In one example, the filtering unit shape may be a diamond.
      c) In one example, the filtering unit shape may be a rectangle.
      d) In one example, the filtering unit shape may be other shapes.
   f. In one example, the enable/disable decision may be applied to each filtering unit.
      a) In one example, the on/off decision may be signaled/derived/pre-defined for each filtering unit.
   g. In one example, the filter parameters may be shared inside each filtering unit.
      a) In one example, the parameter/parameter-set/parameter-set-index/other parameter settings may be signaled/derived/pre-defined for each filtering unit.
   h. In one example, the filter reference decision may be applied to each filtering unit.
      a) In one example, the parameter reference decision (i.e., merge left/merge top) may be signaled/derived/pre-defined for each filtering unit.
   i. In one example, one or more syntax element may be signaled/derived/pre-defined to indicate whether the adaptive filtering unit is applied to SAO
      a) In one example, one or more syntax element at SPS level may be signaled/derived/pre-defined to indicate whether the adaptive filtering unit is applied to SAO.
      b) In one example, one or more syntax element at SPS/picture header/slice header/APS/CTU/CU/TU/PU level may be signaled/derived/pre-defined to indicate whether the adaptive filtering unit is applied to SAO.
5) It is proposed to use adaptive filtering unit for CCSAO.
   a. In one example, the adaptive filtering unit may apply to different color components.
      a) In one example, the adaptive filtering unit may only apply to luma component.
      b) In one example, the adaptive filtering unit may only apply to chroma components.
      c) In one example, the adaptive filtering unit may apply to both luma and chroma components.
   b. In one example, the filtering unit size of CCSAO may depend on CTU/CU/TU/PU size.
      a) In one example, the filtering unit width may be up-scaled from CTU/CU/TU/PU width by factor uw (i.e., fw=2).
      b) In one example, the filtering unit height may be up-scaled from CTU/CU/TU/PU height by factor uh (i.e., fh=2).
      c) In one example, the filtering unit width may be down-scaled from CTU/CU/TU/PU width by factor dw (i.e., dw=0.5).
      d) In one example, the filtering unit height may be down-scaled from CTU/CU/TU/PU height by factor dh (i.e., dh=0.5).
   c. In one example, the filtering unit size of CCSAO may depend on pre-defined values.
      a) In one example, the filtering unit width may be M (i.e., M=128/256/512).
      b) In one example, the filtering unit height may be N (i.e., N=128/256/512).
   d. In one example, the filtering unit of CCSAO may depend on picture/slice/tile size.
      a) In one example, the filtering unit size may be different for different picture/slice/tile size or shape.
      b) In one example, the filtering unit size may be equal for different picture/slice/tile size or shape.
      c) In one example, the filtering unit shape may be different for different picture/slice/tile size or shape.
      d) In one example, the filtering unit shape may be equal for different picture/slice/tile size or shape.
   e. In one example, the filtering unit shape may be different shapes.
      a) In one example, the filtering unit shape may be a square.
      b) In one example, the filtering unit shape may be a diamond.
      c) In one example, the filtering unit shape may be a rectangle.
      d) In one example, the filtering unit shape may be other shapes.
   f. In one example, the enable/disable decision may be applied to each filtering unit.
      a) In one example, the on/off decision may be signaled/derived/pre-defined for each filtering unit.
   g. In one example, the filter parameters may be shared inside each filtering unit.
      a) In one example, the parameter/parameter-set/parameter-set-index/other parameter settings may be signaled/derived/pre-defined for each filtering unit.
   h. In one example, the filter reference decision may be applied to each filtering unit.
      a) In one example, the parameter reference decision (i.e., merge left/merge top) may be signaled/derived/pre-defined for each filtering unit.
   i. In one example, one or more syntax element may be signaled/derived/pre-defined to indicate whether the adaptive filtering unit is applied to CCSAO.
      a) In one example, one or more syntax element at SPS level may be signaled/derived/pre-defined to indicate whether the adaptive filtering unit is applied to CCSAO.
      b) In one example, one or more syntax element at SPS/picture header/slice header/APS/CTU/CU/TU/PU level may be signaled/derived/pre-defined to indicate whether the adaptive filtering unit is applied to CCSAO.
6) It is proposed to use adaptive filtering unit for BF.
   a. In one example, the adaptive filtering unit may apply to different color components.
      a) In one example, the adaptive filtering unit may only apply to luma component.
      b) In one example, the adaptive filtering unit may only apply to chroma components.
      c) In one example, the adaptive filtering unit may apply to both luma and chroma components.
   b. In one example, the filtering unit size of BF may depend on CTU/CU/TU/PU size.
      a) In one example, the filtering unit width may be up-scaled from CTU/CU/TU/PU width by factor uw (i.e., fw=2).
      b) In one example, the filtering unit height may be up-scaled from CTU/CU/TU/PU height by factor uh (i.e., fh=2).
      c) In one example, the filtering unit width may be down-scaled from CTU/CU/TU/PU width by factor dw (i.e., dw=0.5).
      d) In one example, the filtering unit height may be down-scaled from CTU/CU/TU/PU height by factor dh (i.e., dh=0.5).
   c. In one example, the filtering unit size of BF may depend on pre-defined values.
      a) In one example, the filtering unit width may be M (i.e., M=128/256/512).
      b) In one example, the filtering unit height may be N (i.e., N=128/256/512).
   d. In one example, the filtering unit of BF may depend on picture/slice/tile size.
      a) In one example, the filtering unit size may be different for different picture/slice/tile size or shape.
      b) In one example, the filtering unit size may be equal for different picture/slice/tile size or shape.
      c) In one example, the filtering unit shape may be different for different picture/slice/tile size or shape.
      d) In one example, the filtering unit shape may be equal for different picture/slice/tile size or shape.
   e. In one example, the filtering unit shape may be different shapes.
      a) In one example, the filtering unit shape may be a square.
      b) In one example, the filtering unit shape may be a diamond.
      c) In one example, the filtering unit shape may be a rectangle.
      d) In one example, the filtering unit shape may be other shapes.
   f. In one example, the enable/disable decision may be applied to each filtering unit.
      a) In one example, the on/off decision may be signaled/derived/pre-defined for each filtering unit.
   g. In one example, the filter parameters may be shared inside each filtering unit.
      a) In one example, the parameter/parameter-set/parameter-set-index/other parameter settings may be signaled/derived/pre-defined for each filtering unit.
   h. In one example, one or more syntax element may be signaled/derived/pre-defined to indicate whether the adaptive filtering unit is applied to BF
      a) In one example, one or more syntax element at SPS level may be signaled/derived/pre-defined to indicate whether the adaptive filtering unit is applied to BF.
      b) In one example, one or more syntax element at SPS/picture header/slice header/APS/CTU/CU/TU/PU level may be signaled/derived/pre-defined to indicate whether the adaptive filtering unit is applied to BF.
7) In one example, the disclosed methods may be used in post-processing and/or pre-processing.
8) In one example, the above-mentioned methods may be used jointly.
9) Alternatively, the above-mentioned methods may be used individually.
10) In one example, the proposed/described adaptive filtering unit for ALF method may be applied to any in-loop filtering tools, pre-processing, or post-processing filtering method in video coding (including but not limited to ALF/CCALF or any other filtering method).
   a. In one example, the proposed adaptive filtering unit may be applied to an in-loop filtering method.
      a) In one example, the proposed adaptive filtering unit may be applied to ALF.
      b) In one example, the proposed adaptive filtering unit may be applied to CCALF.
      c) In one example, the proposed adaptive filtering unit may be applied to BF.
      d) In one example, the proposed adaptive filtering unit may be applied to SAO.
      e) In one example, the proposed adaptive filtering unit may be applied to CCSAO.
      f) Alternatively, the proposed adaptive filtering unit may be applied to other in-loop filtering methods.
   b. In one example, the proposed adaptive filtering unit may be applied to a pre-processing filtering method.
   c. In one example, the proposed e adaptive filtering unit may be applied to a post-processing filtering method.
11) In above examples, the video unit may refer to sequence/picture/sub-picture/slice/tile/coding tree unit (CTU)/CTU row/groups of CTU/coding unit (CU)/prediction unit (PU)/transform unit (TU)/coding tree block (CTB)/coding block (CB)/prediction block (PB)/transform block (TB)/any other region that contains more than one luma or chroma sample/pixel.
12) Whether to and/or how to apply the disclosed methods above may be signalled in a bitstream.
   a. In one example, they may be signalled at sequence level/group of pictures level/picture level/slice level/tile group level, such as in sequence header/picture header/SPS/VPS/DPS/DCI/PPS/APS/slice header/tile group header.
   b. In one example, they may be signalled at PB/TB/CB/PU/TU/CU/VPDU/CTU/CTU row/slice/tile/sub-picture/other kinds of region contain more than one sample or pixel.
13) Whether to and/or how to apply the disclosed methods above may be dependent on coded information, such as block size, colour format, single/dual tree partitioning, colour component, slice/picture type.

### 6. REFERENCES

[1]J. Strom, P. Wennersten, J. Enhorn, D. Liu, K. Andersson and R. Sjoberg, “Bilateral Loop Filter in Combination with SAO,” in proceeding of IEEE Picture Coding Symposium (PCS), November 2019.

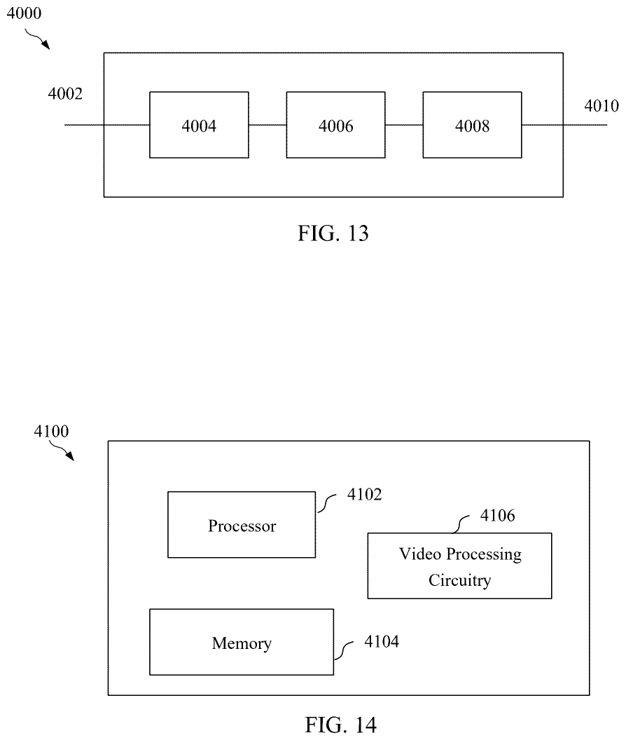

FIG. 13 is a block diagram showing an example video processing system 4000 in which various techniques disclosed herein may be implemented. Various implementations may include some or all of the components of the system 4000. The system 4000 may include input 4002 for receiving video content. The video content may be received in a raw or uncompressed format, e.g., 8 or 10 bit multi-component pixel values, or may be in a compressed or encoded format. The input 4002 may represent a network interface, a peripheral bus interface, or a storage interface. Examples of network interface include wired interfaces such as Ethernet, passive optical network (PON), etc. and wireless interfaces such as wireless fidelity (Wi-Fi) or cellular interfaces.

The system 4000 may include a coding component 4004 that may implement the various coding or encoding methods described in the present document. The coding component 4004 may reduce the average bitrate of video from the input 4002 to the output of the coding component 4004 to produce a coded representation of the video. The coding techniques are therefore sometimes called video compression or video transcoding techniques. The output of the coding component 4004 may be either stored, or transmitted via a communication connected, as represented by the component 4006. The stored or communicated bitstream (or coded) representation of the video received at the input 4002 may be used by a component 4008 for generating pixel values or displayable video that is sent to a display interface 4010. The process of generating user-viewable video from the bitstream representation is sometimes called video decompression. Furthermore, while certain video processing operations are referred to as “coding” operations or tools, it will be appreciated that the coding tools or operations are used at an encoder and corresponding decoding tools or operations that reverse the results of the coding will be performed by a decoder.

Examples of a peripheral bus interface or a display interface may include universal serial bus (USB) or high definition multimedia interface (HDMI) or Displayport, and so on. Examples of storage interfaces include serial advanced technology attachment (SATA), peripheral component interconnect (PCI), integrated drive electronics (IDE) interface, and the like. The techniques described in the present document may be embodied in various electronic devices such as mobile phones, laptops, smartphones or other devices that are capable of performing digital data processing and/or video display.

FIG. 14 is a block diagram of an example video processing apparatus 4100. The apparatus 4100 may be used to implement one or more of the methods described herein. The apparatus 4100 may be embodied in a smartphone, tablet, computer, Internet of Things (IoT) receiver, and so on. The apparatus 4100 may include one or more processors 4102, one or more memories 4104 and video processing circuitry 4106. The processor(s) 4102 may be configured to implement one or more methods described in the present document. The memory (memories) 4104 may be used for storing data and code used for implementing the methods and techniques described herein. The video processing circuitry 4106 may be used to implement, in hardware circuitry, some techniques described in the present document. In some embodiments, the video processing circuitry 4106 may be at least partly included in the processor 4102, e.g., a graphics co-processor.

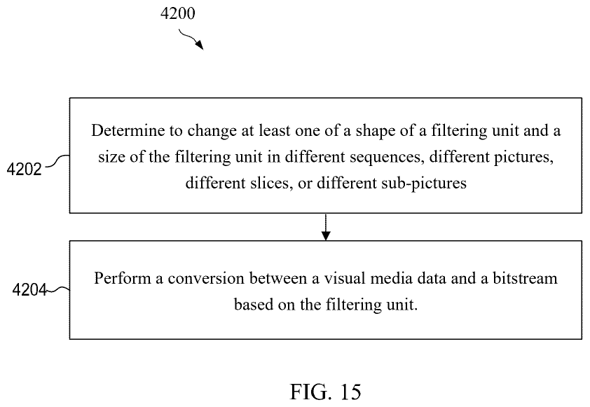

FIG. 15 is a flowchart for an example method 4200 of video processing. In block 4202, the method 4200 includes determining to change at least one of a shape of a filtering unit and a size of the filtering unit in different sequences, different pictures, different slices, or different sub-pictures. In block 4204, a conversion is performed between a visual media data and a bitstream based on the filtering unit. The conversion of step 4204 may include encoding at an encoder or decoding at a decoder, depending on the example.

It should be noted that the method 4200 can be implemented in an apparatus for processing video data comprising a processor and a non-transitory memory with instructions thereon, such as video encoder 4400, video decoder 4500, and/or encoder 4600. In such a case, the instructions upon execution by the processor, cause the processor to perform the method 4200. Further, the method 4200 can be performed by a non-transitory computer readable medium comprising a computer program product for use by a video coding device. The computer program product comprises computer executable instructions stored on the non-transitory computer readable medium such that when executed by a processor cause the video coding device to perform the method 4200.

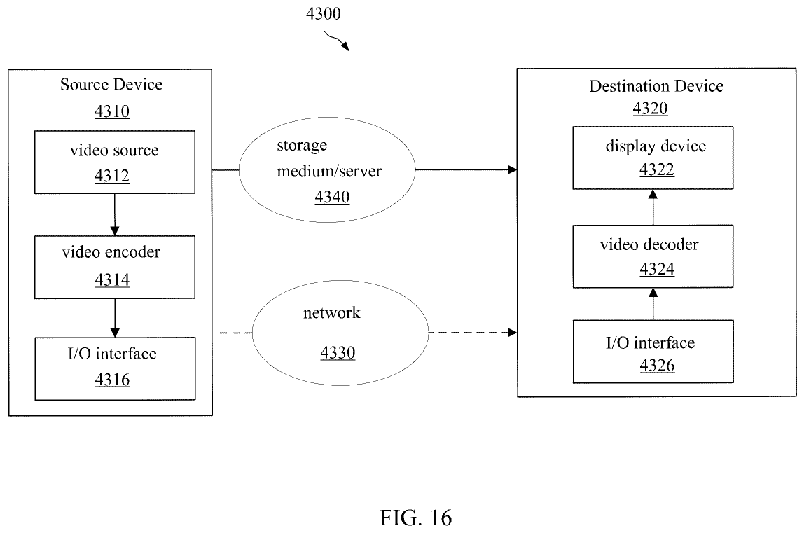

FIG. 16 is a block diagram that illustrates an example video coding system 4300 that may utilize the techniques of this disclosure. The video coding system 4300 may include a source device 4310 and a destination device 4320. Source device 4310 generates encoded video data which may be referred to as a video encoding device. Destination device 4320 may decode the encoded video data generated by source device 4310 which may be referred to as a video decoding device.

Source device 4310 may include a video source 4312, a video encoder 4314, and an input/output (I/O) interface 4316. Video source 4312 may include a source such as a video capture device, an interface to receive video data from a video content provider, and/or a computer graphics system for generating video data, or a combination of such sources. The video data may comprise one or more pictures. Video encoder 4314 encodes the video data from video source 4312 to generate a bitstream. The bitstream may include a sequence of bits that form a coded representation of the video data. The bitstream may include coded pictures and associated data. The coded picture is a coded representation of a picture. The associated data may include sequence parameter sets, picture parameter sets, and other syntax structures. 11O interface 4316 may include a modulator/demodulator (modem) and/or a transmitter. The encoded video data may be transmitted directly to destination device 4320 via I/O interface 4316 through network 4330. The encoded video data may also be stored onto a storage medium/server 4340 for access by destination device 4320.

Destination device 4320 may include an I/O interface 4326, a video decoder 4324, and a display device 4322. I/O interface 4326 may include a receiver and/or a modem. I/O interface 4326 may acquire encoded video data from the source device 4310 or the storage medium/server 4340. Video decoder 4324 may decode the encoded video data. Display device 4322 may display the decoded video data to a user. Display device 4322 may be integrated with the destination device 4320, or may be external to destination device 4320, which can be configured to interface with an external display device.

Video encoder 4314 and video decoder 4324 may operate according to a video compression standard, such as the High Efficiency Video Coding (HEVC) standard, Versatile Video Coding (VVC) standard and other current and/or further standards.

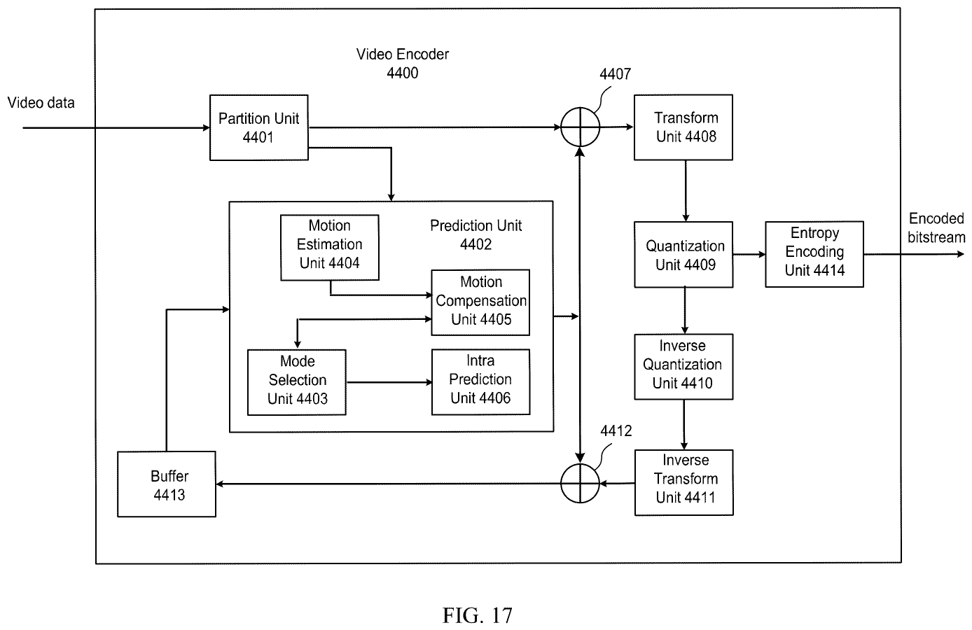

FIG. 17 is a block diagram illustrating an example of video encoder 4400, which may be video encoder 4314 in the system 4300 illustrated in FIG. 16. Video encoder 4400 may be configured to perform any or all of the techniques of this disclosure. The video encoder 4400 includes a plurality of functional components. The techniques described in this disclosure may be shared among the various components of video encoder 4400. In some examples, a processor may be configured to perform any or all of the techniques described in this disclosure.

The functional components of video encoder 4400 may include a partition unit 4401, a prediction unit 4402 which may include a mode select unit 4403, a motion estimation unit 4404, a motion compensation unit 4405, an intra prediction unit 4406, a residual generation unit 4407, a transform processing unit 4408, a quantization unit 4409, an inverse quantization unit 4410, an inverse transform unit 4411, a reconstruction unit 4412, a buffer 4413, and an entropy encoding unit 4414.

In other examples, video encoder 4400 may include more, fewer, or different functional components. In an example, prediction unit 4402 may include an intra block copy (IBC) unit. The IBC unit may perform prediction in an IBC mode in which at least one reference picture is a picture where the current video block is located.

Furthermore, some components, such as motion estimation unit 4404 and motion compensation unit 4405 may be highly integrated, but are represented in the example of video encoder 4400 separately for purposes of explanation.

Partition unit 4401 may partition a picture into one or more video blocks. Video encoder 4400 and video decoder 4500 may support various video block sizes.

Mode select unit 4403 may select one of the coding modes, intra or inter, e.g., based on error results, and provide the resulting intra or inter coded block to a residual generation unit 4407 to generate residual block data and to a reconstruction unit 4412 to reconstruct the encoded block for use as a reference picture. In some examples, mode select unit 4403 may select a combination of intra and inter prediction (CIIP) mode in which the prediction is based on an inter prediction signal and an intra prediction signal. Mode select unit 4403 may also select a resolution for a motion vector (e.g., a sub-pixel or integer pixel precision) for the block in the case of inter prediction.

To perform inter prediction on a current video block, motion estimation unit 4404 may generate motion information for the current video block by comparing one or more reference frames from buffer 4413 to the current video block. Motion compensation unit 4405 may determine a predicted video block for the current video block based on the motion information and decoded samples of pictures from buffer 4413 other than the picture associated with the current video block.

Motion estimation unit 4404 and motion compensation unit 4405 may perform different operations for a current video block, for example, depending on whether the current video block is in an I slice, a P slice, or a B slice.

In some examples, motion estimation unit 4404 may perform uni-directional prediction for the current video block, and motion estimation unit 4404 may search reference pictures of list 0 or list 1 for a reference video block for the current video block. Motion estimation unit 4404 may then generate a reference index that indicates the reference picture in list 0 or list 1 that contains the reference video block and a motion vector that indicates a spatial displacement between the current video block and the reference video block. Motion estimation unit 4404 may output the reference index, a prediction direction indicator, and the motion vector as the motion information of the current video block. Motion compensation unit 4405 may generate the predicted video block of the current block based on the reference video block indicated by the motion information of the current video block.

In other examples, motion estimation unit 4404 may perform bi-directional prediction for the current video block, motion estimation unit 4404 may search the reference pictures in list 0 for a reference video block for the current video block and may also search the reference pictures in list 1 for another reference video block for the current video block. Motion estimation unit 4404 may then generate reference indexes that indicate the reference pictures in list 0 and list 1 containing the reference video blocks and motion vectors that indicate spatial displacements between the reference video blocks and the current video block. Motion estimation unit 4404 may output the reference indexes and the motion vectors of the current video block as the motion information of the current video block. Motion compensation unit 4405 may generate the predicted video block of the current video block based on the reference video blocks indicated by the motion information of the current video block.

In some examples, motion estimation unit 4404 may output a full set of motion information for decoding processing of a decoder. In some examples, motion estimation unit 4404 may not output a full set of motion information for the current video. Rather, motion estimation unit 4404 may signal the motion information of the current video block with reference to the motion information of another video block. For example, motion estimation unit 4404 may determine that the motion information of the current video block is sufficiently similar to the motion information of a neighboring video block.

In one example, motion estimation unit 4404 may indicate, in a syntax structure associated with the current video block, a value that indicates to the video decoder 4500 that the current video block has the same motion information as another video block.

In another example, motion estimation unit 4404 may identify, in a syntax structure associated with the current video block, another video block and a motion vector difference (MVD). The motion vector difference indicates a difference between the motion vector of the current video block and the motion vector of the indicated video block. The video decoder 4500 may use the motion vector of the indicated video block and the motion vector difference to determine the motion vector of the current video block.

As discussed above, video encoder 4400 may predictively signal the motion vector. Two examples of predictive signaling techniques that may be implemented by video encoder 4400 include advanced motion vector prediction (AMVP) and merge mode signaling.

Intra prediction unit 4406 may perform intra prediction on the current video block. When intra prediction unit 4406 performs intra prediction on the current video block, intra prediction unit 4406 may generate prediction data for the current video block based on decoded samples of other video blocks in the same picture. The prediction data for the current video block may include a predicted video block and various syntax elements.

Residual generation unit 4407 may generate residual data for the current video block by subtracting the predicted video block(s) of the current video block from the current video block. The residual data of the current video block may include residual video blocks that correspond to different sample components of the samples in the current video block.

In other examples, there may be no residual data for the current video block for the current video block, for example in a skip mode, and residual generation unit 4407 may not perform the subtracting operation.

Transform processing unit 4408 may generate one or more transform coefficient video blocks for the current video block by applying one or more transforms to a residual video block associated with the current video block.

After transform processing unit 4408 generates a transform coefficient video block associated with the current video block, quantization unit 4409 may quantize the transform coefficient video block associated with the current video block based on one or more quantization parameter (QP) values associated with the current video block.

Inverse quantization unit 4410 and inverse transform unit 4411 may apply inverse quantization and inverse transforms to the transform coefficient video block, respectively, to reconstruct a residual video block from the transform coefficient video block. Reconstruction unit 4412 may add the reconstructed residual video block to corresponding samples from one or more predicted video blocks generated by the prediction unit 4402 to produce a reconstructed video block associated with the current block for storage in the buffer 4413.

After reconstruction unit 4412 reconstructs the video block, the loop filtering operation may be performed to reduce video blocking artifacts in the video block.

Entropy encoding unit 4414 may receive data from other functional components of the video encoder 4400. When entropy encoding unit 4414 receives the data, entropy encoding unit 4414 may perform one or more entropy encoding operations to generate entropy encoded data and output a bitstream that includes the entropy encoded data.

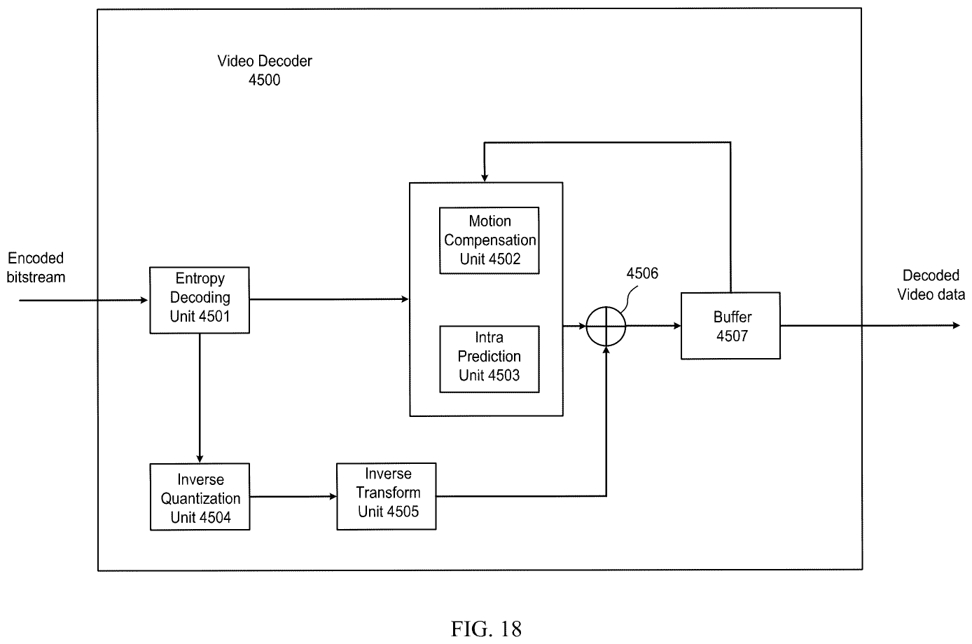

FIG. 18 is a block diagram illustrating an example of video decoder 4500 which may be video decoder 4324 in the system 4300 illustrated in FIG. 16. The video decoder 4500 may be configured to perform any or all of the techniques of this disclosure. In the example shown, the video decoder 4500 includes a plurality of functional components. The techniques described in this disclosure may be shared among the various components of the video decoder 4500. In some examples, a processor may be configured to perform any or all of the techniques described in this disclosure.

In the example shown, video decoder 4500 includes an entropy decoding unit 4501, a motion compensation unit 4502, an intra prediction unit 4503, an inverse quantization unit 4504, an inverse transformation unit 4505, a reconstruction unit 4506, and a buffer 4507. Video decoder 4500 may, in some examples, perform a decoding pass generally reciprocal to the encoding pass described with respect to video encoder 4400.

Entropy decoding unit 4501 may retrieve an encoded bitstream. The encoded bitstream may include entropy coded video data (e.g., encoded blocks of video data). Entropy decoding unit 4501 may decode the entropy coded video data, and from the entropy decoded video data, motion compensation unit 4502 may determine motion information including motion vectors, motion vector precision, reference picture list indexes, and other motion information. Motion compensation unit 4502 may, for example, determine such information by performing the AMVP and merge mode.

Motion compensation unit 4502 may produce motion compensated blocks, possibly performing interpolation based on interpolation filters. Identifiers for interpolation filters to be used with sub-pixel precision may be included in the syntax elements.

Motion compensation unit 4502 may use interpolation filters as used by video encoder 4400 during encoding of the video block to calculate interpolated values for sub-integer pixels of a reference block. Motion compensation unit 4502 may determine the interpolation filters used by video encoder 4400 according to received syntax information and use the interpolation filters to produce predictive blocks.

Motion compensation unit 4502 may use some of the syntax information to determine sizes of blocks used to encode frame(s) and/or slice(s) of the encoded video sequence, partition information that describes how each macroblock of a picture of the encoded video sequence is partitioned, modes indicating how each partition is encoded, one or more reference frames (and reference frame lists) for each inter coded block, and other information to decode the encoded video sequence.

Intra prediction unit 4503 may use intra prediction modes for example received in the bitstream to form a prediction block from spatially adjacent blocks. Inverse quantization unit 4504 inverse quantizes, i.e., de-quantizes, the quantized video block coefficients provided in the bitstream and decoded by entropy decoding unit 4501. Inverse transform unit 4505 applies an inverse transform.

Reconstruction unit 4506 may sum the residual blocks with the corresponding prediction blocks generated by motion compensation unit 4502 or intra prediction unit 4503 to form decoded blocks. If desired, a deblocking filter may also be applied to filter the decoded blocks in order to remove blockiness artifacts. The decoded video blocks are then stored in buffer 4507, which provides reference blocks for subsequent motion compensation/intra prediction and also produces decoded video for presentation on a display device.

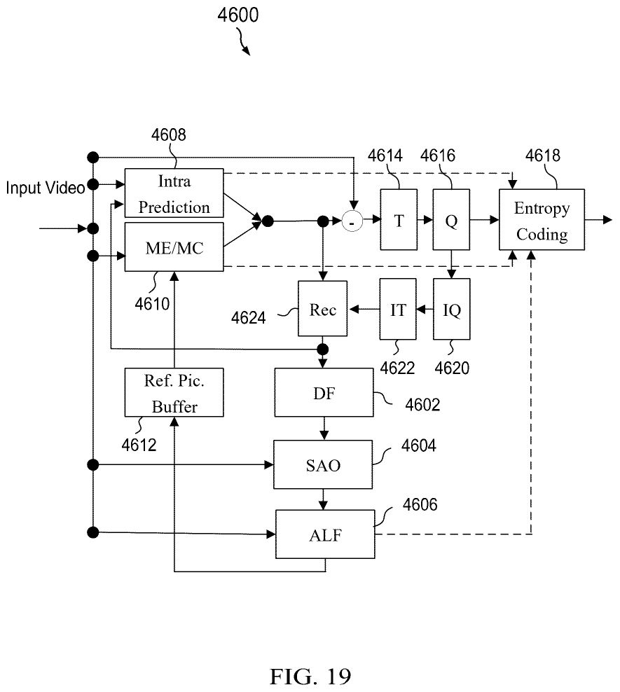

FIG. 19 is a schematic diagram of an example encoder 4600. The encoder 4600 is suitable for implementing the techniques of VVC. The encoder 4600 includes three in-loop filters, namely a deblocking filter (DF) 4602, a sample adaptive offset (SAO) 4604, and an adaptive loop filter (ALF) 4606. Unlike the DF 4602, which uses predefined filters, the SAO 4604 and the ALF 4606 utilize the original samples of the current picture to reduce the mean square errors between the original samples and the reconstructed samples by adding an offset and by applying a finite impulse response (FIR) filter, respectively, with coded side information signaling the offsets and filter coefficients. The ALF 4606 is located at the last processing stage of each picture and can be regarded as a tool trying to catch and fix artifacts created by the previous stages.

The encoder 4600 further includes an intra prediction component 4608 and a motion estimation/compensation (ME/MC) component 4610 configured to receive input video. The intra prediction component 4608 is configured to perform intra prediction, while the ME/MC component 4610 is configured to utilize reference pictures obtained from a reference picture buffer 4612 to perform inter prediction. Residual blocks from inter prediction or intra prediction are fed into a transform (T) component 4614 and a quantization (Q) component 4616 to generate quantized residual transform coefficients, which are fed into an entropy coding component 4618. The entropy coding component 4618 entropy codes the prediction results and the quantized transform coefficients and transmits the same toward a video decoder (not shown). Quantization components output from the quantization component 4616 may be fed into an inverse quantization (IQ) components 4620, an inverse transform component 4622, and a reconstruction (REC) component 4624. The REC component 4624 is able to output images to the DF 4602, the SAO 4604, and the ALF 4606 for filtering prior to those images being stored in the reference picture buffer 4612.

A listing of solutions preferred by some examples is provided next.

The following solutions show examples of techniques discussed herein.
1. A method for processing video data comprising: determining to change a shape or a size of a filtering unit in different sequences, different pictures, different slices, or different sub-pictures; and performing a conversion between a visual media data and a bitstream based on the filtering unit.
2. The method of solution 1, wherein the filtering unit is a Luma-ALF, a CCALF, or a Chroma-ALF, or wherein the filtering unit is an adaptive filtering unit, or wherein the shape and/or size of the filtering unit depends on a color component/color format, or wherein the shape and/or size of a filtering unit is signaled with at least one syntax element (SE) in a SPS, PPS, picture header, slice header, or CTU, or wherein the SE is an index reflecting the shape and/or size of a filtering unit, or wherein the SE is coded be binarized as a flag, a fixed length code, an EG(x) code, a unary code, a truncated unary code, or a truncated binary code, or wherein the SE is signed or unsigned, or wherein the syntax element is coded with at least one context model, or wherein the SE is bypass coded, or wherein the syntax element is signaled in a conditional way.
3. The method of any of solutions 1-2, wherein an adaptive filtering unit is used for ALF.
4. The method of any of solutions 1-3, wherein the adaptive filtering unit applies to different color components, applies to only a luma component, applies to only chroma components, or applies to both luma and chroma components.
5. The method of any of solutions 1-4, wherein the filtering unit size of ALF depends on CTU/CU/TU/PU size, or wherein the filtering unit width is up-scaled from CTU/CU/TU/PU width by factor of fw where fw=2, or wherein the filtering unit height is up-scaled from CTU/CU/TU/PU height by factor fh where fh=2, or wherein the filtering unit width is down-scaled from CTU/CU/TU/PU width by factor dw where dw=0.5, or wherein the filtering unit height is down-scaled from CTU/CU/TU/PU height by factor dh where dh=0.5.
6. The method of any of solutions 1-5, wherein the filtering unit size of ALF depends on pre-defined values, is M where M=128, 256, or 512, or is N where N=128, 256, or 512.
7. The method of any of solutions 1-6, wherein the filtering unit of ALF depends on picture/slice/tile size, or wherein the filtering unit size is different for different picture/slice/tile size or shape, or wherein the filtering unit size is equal for different picture/slice/tile size or shape, or wherein the filtering unit shape is different for different picture/slice/tile size or shape, or wherein the filtering unit shape is equal for different picture/slice/tile size or shape.
8. The method of any of solutions 1-7, wherein the filtering unit shape is different shapes, or wherein the filtering unit shape is a square, a diamond, a rectangle, or other shapes.
9. The method of any of solutions 1-8, wherein the enable/disable decision is applied to each filtering unit, or wherein the on/off decision is signaled/derived/pre-defined for each filtering unit, or wherein the on/off decision of Luma-ALF is signaled/derived/pre-defined for each Luma-ALF filtering unit, or wherein the on/off decision of Chroma-ALF is signaled/derived/pre-defined for each Chroma-ALF filtering unit.
10. The method of any of solutions 1-9, wherein the filter parameters are shared inside each filtering unit, or wherein the parameter/parameter-set/parameter-set-index/other parameter settings are signaled/derived/pre-defined for each filtering unit, or wherein the parameter-set index is signaled/derived/pre-defined for each Luma-ALF filtering unit, or wherein the parameter index is a filter-set index, classifier index or clipping index and is signaled/derived/pre-defined for each Luma-ALF filtering unit, or wherein the parameter-set index is signaled/derived/pre-defined for each Chroma-ALF filtering unit, or wherein the parameter index is a filter-set index, classifier index or clipping index and is signaled/derived/pre-defined for each Chroma-ALF filtering unit.
11. The method of any of solutions 1-10, wherein the filter reference decision is applied to each filtering unit, or wherein the parameter reference decision is an APS index or a filter index and is signaled/derived/pre-defined for each filtering unit.
12. The method of any of solutions 1-11, wherein one or more syntax elements are signaled/derived/pre-defined to indicate whether the adaptive filtering unit is applied to ALF, or wherein one or more syntax element at SPS level are signaled/derived/pre-defined to indicate whether the adaptive filtering unit is applied to ALF, or wherein one or more syntax elements at SPS/picture header/slice header/APS/CTU/CU/TU/PU level are signaled/derived/pre-defined to indicate whether the adaptive filtering unit is applied to ALF.
13. The method of any of solutions 1-12, wherein the adaptive filtering unit is used for CCALF.
14. The method of any of solutions 1-13, wherein the adaptive filtering applies to different color components, or wherein the adaptive filtering unit only applies to one of the chroma components, or wherein the adaptive filtering unit applies to both chroma components.
15. The method of any of solutions 1-14, wherein the filtering unit size of CCALF depends on CTU/CU/TU/PU size, or wherein the filtering unit width is up-scaled from CTU/CU/TU/PU width by factor fw where fw=2, or wherein the filtering unit height is up-scaled from CTU/CU/TU/PU height by factor fh where fh=2, or wherein the filtering unit width is down-scaled from CTU/CU/TU/PU width by factor dw where dw=0.5, or wherein the filtering unit height is down-scaled from CTU/CU/TU/PU height by factor dh where dh=0.5.
16. The method of any of solutions 1-15, wherein the filtering unit size of ALF depends on pre-defined values, is M where M=128, 256, or 512, or is N where N=128, 256, or 512.
17. The method of any of solutions 1-16, wherein the filtering unit of CCALF depends on picture/slice/tile size, or wherein the filtering unit size is different for different picture/slice/tile size or shape, or wherein the filtering unit size is equal for different picture/slice/tile size or shape, or wherein the filtering unit shape is different for different picture/slice/tile size or shape, or wherein the filtering unit shape is equal for different picture/slice/tile size or shape.
18. The method of any of solutions 1-17, wherein the filtering unit shape is different shapes, or wherein the filtering unit shape is a square, a diamond, a rectangle, or other shapes.
19. The method of any of solutions 1-18, wherein the enable/disable decision is applied to each filtering unit, or wherein the on/off decision is signaled/derived/pre-defined for each filtering unit, or wherein the on/off decision of Cb-CCALF is signaled/derived/pre-defined for each Cb-CCALF filtering unit, or wherein the on/off decision of Cr-CCALF is signaled/derived/pre-defined for each Cr-CCALF filtering unit.
20. The method of any of solutions 1-19, wherein the filter parameters are shared inside each filtering unit, or wherein the parameter/parameter-set/parameter-set-index/other parameter settings are signaled/derived/pre-defined for each filtering unit.
21. The method of any of solutions 1-20, wherein the filter reference decision is applied to each filtering unit, or wherein the parameter reference decision is an APS index/Filter index and is signaled/derived/pre-defined for each filtering unit.
22. The method of any of solutions 1-21, wherein one or more syntax element is signaled/derived/pre-defined to indicate whether the adaptive filtering unit is applied to CCALF, or wherein one or more syntax element at SPS level are signaled/derived/pre-defined to indicate whether the adaptive filtering unit is applied to CCALF, or wherein one or more syntax elements at SPS/picture header/slice header/APS/CTU/CU/TU/PU level are signaled/derived/pre-defined to indicate whether the adaptive filtering unit is applied to CCALF.
23. The method of any of solutions 1-22, wherein the adaptive filtering unit is used for SAO.
24. The method of any of solutions 1-23, wherein the adaptive filtering unit applies to different color components, or wherein the adaptive filtering unit only applies to luma component, or wherein the adaptive filtering unit only applies to chroma components, or wherein the adaptive filtering unit applies to both luma and chroma components.
25. The method of any of solutions 1-24, wherein the filtering unit size of SAO depends on CTU/CU/TU/PU size, or wherein the filtering unit width is up-scaled from CTU/CU/TU/PU width by factor of fw where fw=2, or wherein the filtering unit height is up-scaled from CTU/CU/TU/PU height by factor fh where fh=2, or wherein the filtering unit width is down-scaled from CTU/CU/TU/PU width by factor dw where dw=0.5, or wherein the filtering unit height is down-scaled from CTU/CU/TU/PU height by factor dh where dh=0.5.
26. The method of any of solutions 1-25, wherein the filtering unit size of SAO depends on pre-defined values, is M where M=128, 256, or 512, or is N where N=128, 256, or 512.
27. The method of any of solutions 1-26, wherein the filtering unit of SAO depends on picture/slice/tile size, or wherein the filtering unit size is different for different picture/slice/tile size or shape, or wherein the filtering unit size is equal for different picture/slice/tile size or shape, or wherein the filtering unit shape is different for different picture/slice/tile size or shape, or wherein the filtering unit shape is equal for different picture/slice/tile size or shape.
28. The method of any of solutions 1-27, wherein the filtering unit shape is different shapes, or wherein the filtering unit shape is a square, a diamond, a rectangle, or other shapes.
29. The method of any of solutions 1-28, wherein the enable/disable decision is applied to each filtering unit, or wherein the on/off decision is signaled/derived/pre-defined for each filtering unit.
30. The method of any of solutions 1-29, wherein the filter parameters are shared inside each filtering unit, or wherein the parameter/parameter-set/parameter-set-index/other parameter settings are signaled/derived/pre-defined for each filtering unit.
31. The method of any of solutions 1-30, wherein the filter reference decision is applied to each filtering unit, or wherein the parameter reference decision is a merge left/merge top and is signaled/derived/pre-defined for each filtering unit.
32. The method of any of solutions 1-31, wherein the adaptive filtering unit is applied to SAO, or wherein one or more syntax element at SPS level are signaled/derived/pre-defined to indicate whether the adaptive filtering unit is applied to SAO, or wherein one or more syntax element at SPS/picture header/slice header/APS/CTU/CU/TU/PU level are signaled/derived/pre-defined to indicate whether the adaptive filtering unit is applied to SAO.
33. The method of any of solutions 1-32, wherein adaptive filtering unit is used for CCSAO.
34. The method of any of solutions 1-33, wherein the adaptive filtering unit applies to different color components, applies to only a luma component, applies to only chroma components, or applies to both luma and chroma components.
35. The method of any of solutions 1-34, wherein the filtering unit size of CCSAO depends on CTU/CU/TU/PU size, or wherein the filtering unit width is up-scaled from CTU/CU/TU/PU width by factor of fw where fw=2, or wherein the filtering unit height is up-scaled from CTU/CU/TU/PU height by factor fh where fh=2, or wherein the filtering unit width is down-scaled from CTU/CU/TU/PU width by factor dw where dw=0.5, or wherein the filtering unit height is down-scaled from CTU/CU/TU/PU height by factor dh where dh=0.5.
36. The method of any of solutions 1-35, wherein the filtering unit size of CCSAO depends on pre-defined values, is M where M=128, 256, or 512, or is N where N=128, 256, or 512.
37. The method of any of solutions 1-36, wherein the filtering unit of ALF depends on picture/slice/tile size, or wherein the filtering unit size is different for different picture/slice/tile size or shape, or wherein the filtering unit size is equal for different picture/slice/tile size or shape, or wherein the filtering unit shape is different for different picture/slice/tile size or shape, or wherein the filtering unit shape is equal for different picture/slice/tile size or shape.
38. The method of any of solutions 1-37, wherein the filtering unit shape is different shapes, or wherein the filtering unit shape is a square, a diamond, a rectangle, or other shapes.
39. The method of any of solutions 1-38, wherein the enable/disable decision is applied to each filtering unit, or wherein the on/off decision is signaled/derived/pre-defined for each filtering unit.
40. The method of any of solutions 1-39, wherein the filter parameters are shared inside each filtering unit, or wherein the parameter/parameter-set/parameter-set-index/other parameter settings are signaled/derived/pre-defined for each filtering unit.
41. The method of any of solutions 1-40, wherein the filter reference decision is applied to each filtering unit, or wherein the parameter reference decision is merge left/merge top and is signaled/derived/pre-defined for each filtering unit.
42. The method of any of solutions 1-41, wherein one or more syntax elements are signaled/derived/pre-defined to indicate whether the adaptive filtering unit is applied to CCSAO, or wherein one or more syntax element at SPS level are signaled/derived/pre-defined to indicate whether the adaptive filtering unit is applied to CCSAO, or wherein one or more syntax elements at SPS/picture header/slice header/APS/CTU/CU/TU/PU level are signaled/derived/pre-defined to indicate whether the adaptive filtering unit is applied to CCSAO.
43. The method of any of solutions 1-42, wherein the adaptive filtering unit is used for BF.
44. The method of any of solutions 1-43, wherein the adaptive filtering applies to different color components, or wherein the adaptive filtering unit only applies to one of the chroma components, or wherein the adaptive filtering unit applies to both chroma components.
45. The method of any of solutions 1-44, wherein the filtering unit size of BF depends on CTU/CU/TU/PU size, or wherein the filtering unit width is up-scaled from CTU/CU/TU/PU width by factor fw where fw=2, or wherein the filtering unit height is up-scaled from CTU/CU/TU/PU height by factor fh where fh=2, or wherein the filtering unit width is down-scaled from CTU/CU/TU/PU width by factor dw where dw=0.5, or wherein the filtering unit height is down-scaled from CTU/CU/TU/PU height by factor dh where dh=0.5.
46. The method of any of solutions 1-45, wherein the filtering unit size of BF depends on pre-defined values, is M where M=128, 256, or 512, or is N where N=128, 256, or 512.
47. The method of any of solutions 1-46, wherein the filtering unit of BF depends on picture/slice/tile size, or wherein the filtering unit size is different for different picture/slice/tile size or shape, or wherein the filtering unit size is equal for different picture/slice/tile size or shape, or wherein the filtering unit shape is different for different picture/slice/tile size or shape, or wherein the filtering unit shape is equal for different picture/slice/tile size or shape.
48. The method of any of solutions 1-47, wherein the filtering unit shape is different shapes, or wherein the filtering unit shape is a square, a diamond, a rectangle, or other shapes.
49. The method of any of solutions 1-48, wherein the enable/disable decision is applied to each filtering unit, or wherein the on/off decision is signaled/derived/pre-defined for each filtering unit.
50. The method of any of solutions 1-49, wherein the filter parameters are shared inside each filtering unit, or wherein the parameter/parameter-set/parameter-set-index/other parameter settings are signaled/derived/pre-defined for each filtering unit.
51. The method of any of solutions 1-50, wherein one or more syntax element is signaled/derived/pre-defined to indicate whether the adaptive filtering unit is applied to BF, or wherein one or more syntax element at SPS level are signaled/derived/pre-defined to indicate whether the adaptive filtering unit is applied to BF, or wherein one or more syntax elements at SPS/picture header/slice header/APS/CTU/CU/TU/PU level are signaled/derived/pre-defined to indicate whether the adaptive filtering unit is applied to BF.
52. The method of any of solutions 1-51, wherein the filtering unit is used in post-processing and/or pre-processing.
53. The method of any of solutions 1-52, wherein the method is applied jointly or individually.
54. The method of any of solutions 1-53, wherein the adaptive filtering unit for ALF is applied to any in-loop filtering tools, pre-processing, or post-processing filtering in video coding including but not limited to ALF/CCALF or any other filtering, or wherein the adaptive filtering unit is applied to an in-loop filter, to an ALF, to a CCALF, to a BF, to a SAO, to a CCSAO, another in-loop filter, to a pre-processing filter, or to a post-processing filter.
55. The method of any of solutions 1-54, wherein a video unit is to sequence/picture/sub-picture/slice/tile/coding tree unit (CTU)/CTU row/groups of CTU/coding unit (CU)/prediction unit (PU)/transform unit (TU)/coding tree block (CTB)/coding block (CB)/prediction block (PB)/transform block (TB)/any other region that contains more than one luma or chroma sample/pixel.
56. The method of any of solutions 1-55, wherein usage of the method is signaled in a bitstream, or wherein usage is signaled at sequence level/group of pictures level/picture level/slice level/tile group level, or in a sequence header/picture header/SPS/VPS/DPS/DCI/PPS/APS/slice header/tile group header, or wherein usage is signaled at PB/TB/CB/PU/TU/CU/VPDU/CTU/CTU row/slice/tile/sub-picture/other kinds of region that contains more than one sample or pixel.
57. The method of any of solutions 1-56, wherein usage of the method is dependent on coded information including block size, color format, single/dual tree partitioning, color component, or slice/picture type.
58. An apparatus for processing video data comprising: a processor; and a non-transitory memory with instructions thereon, wherein the instructions upon execution by the processor, cause the processor to perform the method of any of solutions 1-57.
59. A non-transitory computer readable medium comprising a computer program product for use by a video coding device, the computer program product comprising computer executable instructions stored on the non-transitory computer readable medium such that when executed by a processor cause the video coding device to perform the method of any of solutions 1-57.
60. A non-transitory computer-readable recording medium storing a bitstream of a video which is generated by a method performed by a video processing apparatus, wherein the method comprises: determining to change a shape or a size of a filtering unit in different sequences, different pictures, different slices, or different sub-pictures; and generating the bitstream based on the determining.
61. A method for storing bitstream of a video comprising: determining to change a shape or a size of a filtering unit in different sequences, different pictures, different slices, or different sub-pictures; generating the bitstream based on the determining; and storing the bitstream in a non-transitory computer-readable recording medium.
62. A method, apparatus, or system described in the present document.

A listing of additional example solutions is provided next.
1. A method for processing video data, comprising: determining to change at least one of a shape of a filtering unit and a size of the filtering unit in different sequences, different pictures, different slices, or different sub-pictures; and performing a conversion between a visual media data and a bitstream based on the filtering unit.
2. The method of solution 1, wherein the filtering unit is a luma-adaptive loop filter (ALF), a cross component ALF (CCALF), or a chroma-ALF.
3. The method of any of solutions 1-2, wherein the filtering unit which is changed is designated an adaptive filtering unit.
4. The method of any of solutions 1-3, wherein at least one of the shape of the filtering unit and the size of the filtering unit depend on a color component or a color format.
5. The method of any of solutions 1-3, wherein at least one of the shape and the size are signaled using at least one syntax element (SE) in a sequence parameter set (SPS), a picture parameter set (PPS), a picture header, a slice header, or a coding tree unit (CTU).
6. The method of solution 5, wherein the SE comprises an index reflecting at least one of the size of the filtering unit and the shape of the filtering unit.
7. The method of solution 5, wherein the SE is coded or binarized as a flag, a fixed length code, an exponential Golomb (EG(x)) code, a unary code, a truncated unary code, or a truncated binary code, and wherein the SE is one of signed and unsigned.
8. The method of solution 5, wherein the SE is coded using at least one context model or is bypass coded.
9. The method of solution 5, wherein the SE is signaled in a conditional way.
10. The method of solution 1, wherein the filtering unit which is changed is designated an adaptive filtering unit, and wherein the adaptive filtering unit is used for an adaptive loop filter (ALF).
11. The method of solution 10, wherein the adaptive filtering unit is applied to different color components.
12. The method of solution 10, wherein the adaptive filtering unit is only applied to luma components.
13. The method of solution 10, wherein the adaptive filtering unit is only applied to chroma components.
14. The method of solution 10, wherein the adaptive filtering unit is applied to both luma components and chroma components.
15. The method of solution 10, wherein a size of the adaptive filtering unit depends on a size of at least one of a coding tree unit (CTU), a coding unit (CU), a transform unit (TU), and a prediction unit (PU).
16. The method of solution 15, wherein a width of the adaptive filtering unit is upscaled from a width of the CTU, CU, TU, or PU by a factor (uw).
17. The method of solution 16, wherein the factor is 2.
18. The method of solution 15, wherein a height of the adaptive filtering unit is upscaled from a height of the CTU, CU, TU, or PU by a factor (uh).
19. The method of solution 18, wherein the factor is 2.
20. The method of solution 15, wherein a width of the adaptive filtering unit is downscaled from a width of the CTU, CU, TU, or PU by a factor (dw).
21. The method of solution 20, wherein the factor is 0.5.
22. The method of solution 15, wherein a height of the adaptive filtering unit is downscaled from a height of the CTU, CU, TU, or PU by a factor (dh).
23. The method of solution 22, wherein the factor is 0.5.
24. The method of solution 10, wherein a size of the adaptive filtering unit depends on one or more pre-defined values.
25. The method of solution 24, wherein a width of the adaptive filtering unit comprises M, where M is one of 128, 256, and 512.
26. The method of solution 24, wherein a height of the adaptive filtering unit comprises M, where M is one of 128, 256, and 512.
27. The method of solution 10, wherein the adaptive filtering unit depends on a size of a picture, slice, or tile.
28. The method of solution 27, wherein a size of the adaptive filtering unit is different for a picture, slice, or tile with a different size or shape.
29. The method of solution 27, wherein a size of the adaptive filtering unit is equal for a picture, slice, or tile with a different size or shape.
30. The method of solution 27, wherein a shape ofthe adaptive filtering unit is different for a picture, slice, or tile with a different size or shape.
31. The method of solution 27, wherein a shape of the adaptive filtering unit is equal for a picture, slice, or tile with a different size or shape.
32. The method of solution 10, wherein a shape of the adaptive filtering unit is one of a plurality of different shapes.
33. The method of solution 32, wherein the shape is square.
34. The method of solution 32, wherein the shape is diamond.
35. The method of solution 32, wherein the shape is rectangle.
36. The method of solution 10, wherein each adaptive filtering unit is selectively enabled or disabled.
37. The method of solution 36, wherein an indication of whether each adaptive filtering unit is on or off is signaled in the bitstream, derived, or pre-defined.
38. The method of solution 36, wherein an indication of whether a luma adaptive loop filter (ALF) is on or off is signaled in the bitstream, derived, or pre-defined for each luma-ALF filtering unit.
39. The method of solution 36, wherein an indication of whether a chroma adaptive loop filter (ALF) is on or off is signaled in the bitstream, derived, or pre-defined for each chroma-ALF filtering unit.
40. The method of solution 10, wherein filter parameters are shared within each filtering unit.
41. The method of solution 40, wherein a parameter, a parameter set, or a parameter set index is signaled in the bitstream, derived, or pre-defined for each adaptive filtering unit.
42. The method of solution 40, wherein a parameter set index is signaled in the bitstream, derived, or pre-defined for each luma ALF filtering unit, and wherein the parameter set index comprises an adaptation parameter set (APS) index.
43. The method of solution 40, wherein a parameter index is signaled in the bitstream, derived, or pre-defined for each luma ALF filtering unit, and wherein the parameter index comprises a filter set index, a classifier index, or a clipping index.
44. The method of solution 40, wherein a parameter set index is signaled in the bitstream, derived, or pre-defined for each chroma ALF filtering unit, and wherein the parameter set index comprises an adaptation parameter set (APS) index.
45. The method of solution 40, wherein a parameter index is signaled in the bitstream, derived, or pre-defined for each chroma ALF filtering unit, and wherein the parameter index comprises a filter set index, a classifier index, or a clipping index.
46. The method of solution 10, wherein a decision whether or not to reference a parameter is made for each adaptive filtering unit.
47. The method of solution 46, wherein the decision is signaled in the bitstream, derived, or pre-defined for each filtering unit, and wherein the parameter comprises an adaptation parameter set (APS) index or a filter index.
48. The method of solution 10, wherein one or more syntax elements (SEs) are signaled in the bitstream, derived, or pre-defined to indicate whether the adaptive filtering unit is applied to the ALF.
49. The method of solution 48, wherein the one or more SEs are signaled in a sequence parameter set (SPS).
50. The method of solution 48, wherein the one or more SEs are signaled in a sequence parameter set (SPS), a picture header, a slice header, an adaptation parameter set (APS), a coding tree unit (CTU), a coding unit (CU), a transform unit (TU), or a prediction unit (PU).
51. The method of solution 1, wherein the filtering unit which is changed is designated an adaptive filtering unit, and wherein the adaptive filtering unit is used for a cross component adaptive loop filter (CCALF).
52. The method of solution 51, wherein the adaptive filtering unit is applied to different color components.
53. The method of solution 51, wherein the adaptive filtering unit is only applied to one of a blue difference chroma component (Cb) and a red difference chroma component (Cr).
54. The method of solution 51, wherein the adaptive filtering unit is applied to both a blue difference chroma component (Cb) and a red difference chroma component (Cr).
55. The method of solution 51, wherein a size of the adaptive filtering unit depends on a size of at least one of a coding tree unit (CTU), a coding unit (CU), a transform unit (TU), and a prediction unit (PU).
56. The method of solution 55, wherein a width of the adaptive filtering unit is upscaled from a width of the CTU, CU, TU, or PU by a factor (uw).
57. The method of solution 56, wherein the factor is 2.
58. The method of solution 55, wherein a height of the adaptive filtering unit is upscaled from a height of the CTU, CU, TU, or PU by a factor (uh).
59. The method of solution 58, wherein the factor is 2.
60. The method of solution 55, wherein a width of the adaptive filtering unit is downscaled from a width of the CTU, CU, TU, or PU by a factor (dw).
61. The method of solution 60, wherein the factor is 0.5.
62. The method of solution 55, wherein a height of the adaptive filtering unit is downscaled from a height of the CTU, CU, TU, or PU by a factor (dh).
63. The method of solution 62, wherein the factor is 0.5.
64. The method of solution 55, wherein a size of the adaptive filtering unit depends on one or more pre-defined values.
65. The method of solution 64, wherein a width of the adaptive filtering unit comprises M, where M is one of 128, 256, and 512.
66. The method of solution 64, wherein a height of the adaptive filtering unit comprises M, where M is one of 128, 256, and 512.
67. The method of solution 55, wherein the adaptive filtering unit depends on a size of a picture, slice, or tile.
68. The method of solution 67, wherein a size of the adaptive filtering unit is different for a picture, slice, or tile with a different size or shape.
69. The method of solution 67, wherein a size of the adaptive filtering unit is equal for a picture, slice, or tile with a different size or shape.
70. The method of solution 67, wherein a shape ofthe adaptive filtering unit is different for a picture, slice, or tile with a different size or shape.
71. The method of solution 67, wherein a shape of the adaptive filtering unit is equal for a picture, slice, or tile with a different size or shape.
72. The method of solution 55, wherein a shape of the adaptive filtering unit is one of a plurality of different shapes.
73. The method of solution 72, wherein the shape is square.
74. The method of solution 72, wherein the shape is diamond.
75. The method of solution 72, wherein the shape is rectangle.
76. The method of solution 51, wherein each adaptive filtering unit is selectively enabled or disabled.
77. The method of solution 76, wherein an indication of whether each adaptive filtering unit is on or off is signaled in the bitstream, derived, or pre-defined.
78. The method of solution 76, wherein an indication of whether a blue difference chroma cross component adaptive loop filter (Cb-CCALF) is on or off is signaled in the bitstream, derived, or pre-defined for each Cb-CCALF filtering unit.
79. The method of solution 76, wherein an indication of whether a red difference chroma cross component adaptive loop filter (Cr-CCALF) is on or off is signaled in the bitstream, derived, or pre-defined for each Cr-CCALF filtering unit.
80. The method of solution 51, wherein filter parameters are shared within each filtering unit.
81. The method of solution 80, wherein a parameter, a parameter set, or a parameter set index is signaled in the bitstream, derived, or pre-defined for each adaptive filtering unit.
82. The method of solution 51, wherein a decision whether or not to reference a parameter is made for each adaptive filtering unit.
83. The method of solution 82, wherein the decision is signaled in the bitstream, derived, or pre-defined for each filtering unit, and wherein the parameter comprises an adaptation parameter set (APS) index or a filter index.
84. The method of solution 51, wherein one or more syntax elements (SEs) are signaled in the bitstream, derived, or pre-defined to indicate whether the adaptive filtering unit is applied to the CCALF.
85. The method of solution 84, wherein the one or more SEs are signaled in a sequence parameter set (SPS).
86. The method of solution 84, wherein the one or more SEs are signaled in a sequence parameter set (SPS), a picture header, a slice header, an adaptation parameter set (APS), a coding tree unit (CTU), a coding unit (CU), a transform unit (TU), or a prediction unit (PU).
87. The method of solution 1, wherein the filtering unit which is changed is designated an adaptive filtering unit, and wherein the adaptive filtering unit is used for a sample adaptive offset (SAO) filter.
88. The method of solution 87, wherein the adaptive filtering unit is applied to different color components.
89. The method of solution 88, wherein the adaptive filtering unit is only applied to a luma component.
90. The method of solution 88, wherein the adaptive filtering unit is only applied to a chroma component.
91. The method of solution 88, wherein the adaptive filtering unit is applied to both a luma component and a chroma component.
92. The method of solution 87, wherein a size of the adaptive filtering unit depends on a size of at least one of a coding tree unit (CTU), a coding unit (CU), a transform unit (TU), and a prediction unit (PU).
93. The method of solution 87, wherein a width of the adaptive filtering unit is upscaled from a width of the CTU, CU, TU, or PU by a factor (uw).
94. The method of solution 93, wherein the factor is 2.
95. The method of solution 87, wherein a height of the adaptive filtering unit is upscaled from a height of the CTU, CU, TU, or PU by a factor (uh).
96. The method of solution 95, wherein the factor is 2.
97. The method of solution 87, wherein a width of the adaptive filtering unit is downscaled from a width of the CTU, CU, TU, or PU by a factor (dw).
98. The method of solution 97, wherein the factor is 0.5.
99. The method of solution 87, wherein a height of the adaptive filtering unit is downscaled from a height of the CTU, CU, TU, or PU by a factor (dh).
100. The method of solution 99, wherein the factor is 0.5.
101. The method of solution 87, wherein a size of the adaptive filtering unit depends on one or more pre-defined values.
102. The method of solution 101, wherein a width of the adaptive filtering unit comprises M, where M is one of 128, 256, and 512.
103. The method of solution 101, wherein a height of the adaptive filtering unit comprises M, where M is one of 128, 256, and 512.
104. The method of solution 87, wherein the adaptive filtering unit depends on a size of a picture, slice, or tile.
105. The method of solution 104, wherein a size of the adaptive filtering unit is different for a picture, slice, or tile with a different size or shape.
106. The method of solution 104, wherein a size of the adaptive filtering unit is equal for a picture, slice, or tile with a different size or shape.
107. The method of solution 104, wherein a shape of the adaptive filtering unit is different for a picture, slice, or tile with a different size or shape.
108. The method of solution 104, wherein a shape of the adaptive filtering unit is equal for a picture, slice, or tile with a different size or shape.
109. The method of solution 87, wherein a shape of the adaptive filtering unit is one of a plurality of different shapes.
110. The method of solution 109, wherein the shape is square.
111. The method of solution 109, wherein the shape is diamond.
112. The method of solution 109, wherein the shape is rectangle.
113. The method of solution 87, wherein each adaptive filtering unit is selectively enabled or disabled.
114. The method of solution 113, wherein an indication of whether each adaptive filtering unit is on or off is signaled in the bitstream, derived, or pre-defined.
115. The method of solution 87, wherein filter parameters are shared within each filtering unit.
116. The method of solution 115, wherein a parameter, a parameter set, or a parameter set index is signaled in the bitstream, derived, or pre-defined for each adaptive filtering unit.
117. The method of solution 87, wherein a decision whether or not to reference a parameter is made for each adaptive filtering unit.
118. The method of solution 117, wherein the decision is signaled in the bitstream, derived, or pre-defined for each filtering unit, and wherein the parameter comprises a merge left or a merge top.
119. The method of solution 87, wherein one or more syntax elements (SEs) are signaled in the bitstream, derived, or pre-defined to indicate whether the adaptive filtering unit is applied to the SAO filter.
120. The method of solution 119, wherein the one or more SEs are signaled in a sequence parameter set (SPS).
121. The method of solution 119, wherein the one or more SEs are signaled in a sequence parameter set (SPS), a picture header, a slice header, an adaptation parameter set (APS), a coding tree unit (CTU), a coding unit (CU), a transform unit (TU), or a prediction unit (PU).
122. The method of solution 1, wherein the filtering unit which is changed is designated an adaptive filtering unit, and wherein the adaptive filtering unit is used for a cross component sample adaptive offset (CCSAO) filter.
123. The method of solution 122, wherein the adaptive filtering unit is applied to different color components.
124. The method of solution 123, wherein the adaptive filtering unit is only applied to a luma component.
125. The method of solution 123, wherein the adaptive filtering unit is only applied to a chroma component.
126. The method of solution 123, wherein the adaptive filtering unit is applied to both a luma component and a chroma component.
127. The method of solution 122, wherein a size of the adaptive filtering unit depends on a size of at least one of a coding tree unit (CTU), a coding unit (CU), a transform unit (TU), and a prediction unit (PU).
128. The method of solution 127, wherein a width of the adaptive filtering unit is upscaled from a width of the CTU, CU, TU, or PU by a factor (uw).
129. The method of solution 128, wherein the factor is 2.
130. The method of solution 127, wherein a height of the adaptive filtering unit is upscaled from a height of the CTU, CU, TU, or PU by a factor (uh).
131. The method of solution 130, wherein the factor is 2.
132. The method of solution 127, wherein a width of the adaptive filtering unit is downscaled from a width of the CTU, CU, TU, or PU by a factor (dw).
133. The method of solution 132, wherein the factor is 0.5.
134. The method of solution 127, wherein a height of the adaptive filtering unit is downscaled from a height of the CTU, CU, TU, or PU by a factor (dh).
135. The method of solution 134, wherein the factor is 0.5.
136. The method of solution 122, wherein a size of the adaptive filtering unit depends on one or more pre-defined values.
137. The method of solution 136, wherein a width of the adaptive filtering unit comprises M, where M is one of 128, 256, and 512.
138. The method of solution 136, wherein a height of the adaptive filtering unit comprises M, where M is one of 128, 256, and 512.
139. The method of solution 122, wherein the adaptive filtering unit depends on a size of a picture, slice, or tile.
140. The method of solution 139, wherein a size of the adaptive filtering unit is different for a picture, slice, or tile with a different size or shape.
141. The method of solution 139, wherein a size of the adaptive filtering unit is equal for a picture, slice, or tile with a different size or shape.
142. The method of solution 139, wherein a shape of the adaptive filtering unit is different for a picture, slice, or tile with a different size or shape.
143. The method of solution 139, wherein a shape of the adaptive filtering unit is equal for a picture, slice, or tile with a different size or shape.
144. The method of solution 122, wherein a shape of the adaptive filtering unit is one of a plurality of different shapes.
145. The method of solution 144, wherein the shape is square.
146. The method of solution 144, wherein the shape is diamond.
147. The method of solution 144, wherein the shape is rectangle.
148. The method of solution 122, wherein each adaptive filtering unit is selectively enabled or disabled.
149. The method of solution 148, wherein an indication of whether each adaptive filtering unit is on or off is signaled in the bitstream, derived, or pre-defined.
150. The method of solution 122, wherein filter parameters are shared within each filtering unit.
151. The method of solution 150, wherein a parameter, a parameter set, or a parameter set index is signaled in the bitstream, derived, or pre-defined for each adaptive filtering unit.
152. The method of solution 122, wherein a decision whether or not to reference a parameter is made for each adaptive filtering unit.
153. The method of solution 152, wherein the decision is signaled in the bitstream, derived, or pre-defined for each filtering unit, and wherein the parameter comprises a merge left or a merge top.
154. The method of solution 122, wherein one or more syntax elements (SEs) are signaled in the bitstream, derived, or pre-defined to indicate whether the adaptive filtering unit is applied to the CCSAO filter.
155. The method of solution 154, wherein the one or more SEs are signaled in a sequence parameter set (SPS).
156. The method of solution 154, wherein the one or more SEs are signaled in a sequence parameter set (SPS), a picture header, a slice header, an adaptation parameter set (APS), a coding tree unit (CTU), a coding unit (CU), a transform unit (TU), or a prediction unit (PU).
157. The method of solution 1, wherein the filtering unit which is changed is designated an adaptive filtering unit, and wherein the adaptive filtering unit is used for a bilateral filter (BF).
158. The method of solution 157, wherein the adaptive filtering unit is applied to different color components.
159. The method of solution 158, wherein the adaptive filtering unit is only applied to a luma component.
160. The method of solution 158, wherein the adaptive filtering unit is only applied to a chroma component.
161. The method of solution 158, wherein the adaptive filtering unit is applied to both a luma component and a chroma component.
162. The method of solution 157, wherein a size of the adaptive filtering unit depends on a size of at least one of a coding tree unit (CTU), a coding unit (CU), a transform unit (TU), and a prediction unit (PU).
163. The method of solution 162, wherein a width of the adaptive filtering unit is upscaled from a width of the CTU, CU, TU, or PU by a factor (uw).
164. The method of solution 163, wherein the factor is 2.
165. The method of solution 162, wherein a height of the adaptive filtering unit is upscaled from a height of the CTU, CU, TU, or PU by a factor (uh).
166. The method of solution 165, wherein the factor is 2.
167. The method of solution 162, wherein a width of the adaptive filtering unit is downscaled from a width of the CTU, CU, TU, or PU by a factor (dw).
168. The method of solution 167, wherein the factor is 0.5.
169. The method of solution 162, wherein a height of the adaptive filtering unit is downscaled from a height of the CTU, CU, TU, or PU by a factor (dh).
170. The method of solution 169, wherein the factor is 0.5.
171. The method of solutions 157, wherein a size of the adaptive filtering unit depends on one or more pre-defined values.
172. The method of solution 171, wherein a width of the adaptive filtering unit comprises M, where M is one of 128, 256, and 512.
173. The method of solution 171, wherein a height of the adaptive filtering unit comprises M, where M is one of 128, 256, and 512.
174. The method of solution 157, wherein adaptive filtering unit depends on a size of a picture, slice, or tile.
175. The method of solution 174, wherein a size of the adaptive filtering unit is different for a picture, slice, or tile with a different size or shape.
176. The method of solution 174, wherein a size of the adaptive filtering unit is equal for a picture, slice, or tile with a different size or shape.
177. The method of solution 174, wherein a shape of the adaptive filtering unit is different for a picture, slice, or tile with a different size or shape.
178. The method of solution 174, wherein a shape of the adaptive filtering unit is equal for a picture, slice, or tile with a different size or shape.
179. The method of solution 157, wherein a shape of the adaptive filtering unit is one of a plurality of different shapes.
180. The method of solution 179, wherein the shape is square.
181. The method of solution 180, wherein the shape is diamond.
182. The method of solution 181, wherein the shape is rectangle.
183. The method of solution 157, wherein each adaptive filtering unit is selectively enabled or disabled.
184. The method of solution 183, wherein an indication of whether each adaptive filtering unit is on or off is signaled in the bitstream, derived, or pre-defined.
185. The method of solution 157, wherein filter parameters are shared within each filtering unit.
186. The method of solution 185, wherein a parameter, a parameter set, or a parameter set index is signaled in the bitstream, derived, or pre-defined for each adaptive filtering unit.
187. The method of solution 157, wherein one or more syntax elements (SEs) are signaled in the bitstream, derived, or pre-defined to indicate whether the adaptive filtering unit is applied to the CCSAO filter.
188. The method of solution 187, wherein the one or more SEs are signaled in a sequence parameter set (SPS).
189. The method of solution 187, wherein the one or more SEs are signaled in a sequence parameter set (SPS), a picture header, a slice header, an adaptation parameter set (APS), a coding tree unit (CTU), a coding unit (CU), a transform unit (TU), or a prediction unit (PU).
190. The method of any of solutions 1-189, wherein one or more of the methods are used in at least one of post-processing and pre-processing.
191. The method of any of solutions 1-190, wherein one or more of the methods are used jointly.
192. The method of any of solutions 1-190, wherein one or more of the methods are used individually.
193. The method of any of solutions 1-190, wherein one or more of the methods are applied to one or more of in-loop filtering tools, pre-processing, and post-processing filtering methods in video coding.
194. The method of solution 193, wherein the adaptive filtering unit is applied to an in-loop filtering method.
195. The method of solution 194, wherein the adaptive filtering unit is applied to the ALF.
196. The method of solution 194, wherein the adaptive filtering unit is applied to the CCALF.
197. The method of solution 194, wherein the adaptive filtering unit is applied to the BF.
198. The method of solution 194, wherein the adaptive filtering unit is applied to the SAO filter.
199. The method of solution 194, wherein the adaptive filtering unit is applied to the CCSAO filter.
200. The method of solution 193, wherein the adaptive filtering unit is applied to a pre-processing filtering method.
201. The method of solution 193, wherein the adaptive filtering unit is applied to a post-processing filtering method.
202. The method of any of solutions 1-201, wherein the filtering unit is applied to a video unit, and wherein the video unit comprises a sequence, picture, sub-picture, slice, tile, coding tree unit (CTU), CTU row, group of CTUs, coding unit (CU), prediction unit (PU), transform unit (TU), coding tree block (CTB), coding block (CB), prediction block (PB), transform block (TB), or any other region that contains more than one luma or chroma sample or pixel.
203. The method of any of solutions 1-202, wherein whether to and/or how to apply the one or more of the methods is signalled in the bitstream.
204. The method of solution 203, wherein whether to and/or how to apply the one or more of the methods is signalled at a sequence level, group of pictures level, picture level, slice level, or tile group level, or is signalled in a sequence header, picture header, sequence parameter set (SPS), video parameter set (VPS), decoding parameter set (DPS), decoding capability information (DCI), picture parameter set (PPS), adaptation parameter set (APS), slice header, or tile group header.
205. The method of solution 203, wherein whether to and/or how to apply the one or more of the methods is signalled in a prediction block (PB), transform block (TB), coding block (CB), prediction unit (PU), transform unit (TU), coding unit (CU), virtual pipeline data unit (VPDU), coding tree unit (CTU), CTU row, slice, tile, sub-picture, or other region that contains more than one sample or pixel.
206. The method of any of solutions 1-205, wherein whether to and/or how to apply the one or more ofthe methods is dependent on coded information, and wherein the coded information comprises a block size, a color format, a single tree partitioning, a dual tree partitioning, a color component, a slice type, or a picture type.
207. The method of any of solutions 1-206, wherein the conversion includes encoding the media data into the bitstream.
208. The method of any of solutions 1-206, wherein the conversion includes decoding the media data from the bitstream.
209. An apparatus for processing video data comprising: a processor; and a non-transitory memory with instructions thereon, wherein the instructions upon execution by the processor, cause the processor to perform the method of any of solutions 1-208.
210. A non-transitory computer readable medium comprising a computer program product for use by a video coding device, the computer program product comprising computer executable instructions stored on the non-transitory computer readable medium such that when executed by a processor cause the video coding device to perform the method of any of solutions 1-208.
211. A non-transitory computer-readable recording medium storing a bitstream of a video which is generated by a method performed by a video processing apparatus, wherein the method comprises: determining to change at least one of a shape of a filtering unit and a size of the filtering unit in different sequences, different pictures, different slices, or different sub-pictures; and generating the bitstream with the filtering unit as changed.
212. A method for storing bitstream of a video comprising: determining to change at least one of a shape of a filtering unit and a size of the filtering unit in different sequences, different pictures, different slices, or different sub-pictures; generating the bitstream with the filtering unit as changed; and storing the bitstream in a non-transitory computer-readable recording medium.
213. A method, apparatus, or system described in the present disclosure.

In the solutions described herein, an encoder may conform to the format rule by producing a coded representation according to the format rule. In the solutions described herein, a decoder may use the format rule to parse syntax elements in the coded representation with the knowledge of presence and absence of syntax elements according to the format rule to produce decoded video.

In the present document, the term “video processing” may refer to video encoding, video decoding, video compression or video decompression. For example, video compression algorithms may be applied during conversion from pixel representation of a video to a corresponding bitstream representation or vice versa. The bitstream representation of a current video block may, for example, correspond to bits that are either co-located or spread in different places within the bitstream, as is defined by the syntax. For example, a macroblock may be encoded in terms of transformed and coded error residual values and also using bits in headers and other fields in the bitstream. Furthermore, during conversion, a decoder may parse a bitstream with the knowledge that some fields may be present, or absent, based on the determination, as is described in the above solutions. Similarly, an encoder may determine that certain syntax fields are or are not to be included and generate the coded representation accordingly by including or excluding the syntax fields from the coded representation.

The disclosed and other solutions, examples, embodiments, modules and the functional operations described in this document can be implemented in digital electronic circuitry, or in computer software, firmware, or hardware, including the structures disclosed in this document and their structural equivalents, or in combinations of one or more of them. The disclosed and other embodiments can be implemented as one or more computer program products, i.e., one or more modules of computer program instructions encoded on a computer readable medium for execution by, or to control the operation of, data processing apparatus. The computer readable medium can be a machine-readable storage device, a machine-readable storage substrate, a memory device, a composition of matter effecting a machine-readable propagated signal, or a combination of one or more them. The term “data processing apparatus” encompasses all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of one or more of them. A propagated signal is an artificially generated signal, e.g., a machine-generated electrical, optical, or electromagnetic signal, that is generated to encode information for transmission to suitable receiver apparatus.

A computer program (also known as a program, software, software application, script, or code) can be written in any form of programming language, including compiled or interpreted languages, and it can be deployed in any form, including as a stand-alone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this document can be performed by one or more programmable processors executing one or more computer programs to perform functions by operating on input data and generating output. The processes and logic flows can also be performed by, and apparatus can also be implemented as, special purpose logic circuitry, e.g., a field programmable gate array (FPGA) or an application specific integrated circuit (ASIC).

Processors suitable for the execution of a computer program include, by way of example, both general and special purpose microprocessors, and any one or more processors of any kind of digital computer. Generally, a processor will receive instructions and data from a read only memory or a random-access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Computer readable media suitable for storing computer program instructions and data include all forms of non-volatile memory, media and memory devices, including by way of example semiconductor memory devices, e.g., erasable programmable read-only memory (EPROM), electrically erasable programmable read-only memory (EEPROM), and flash memory devices; magnetic disks, e.g., internal hard disks or removable disks; magneto optical disks; and compact disc read-only memory (CD ROM) and digital versatile disc-read only memory (DVD-ROM) disks. The processor and the memory can be supplemented by, or incorporated in, special purpose logic circuitry.

While this patent document contains many specifics, these should not be construed as limitations on the scope of any subject matter or of what may be claimed, but rather as descriptions of features that may be specific to particular embodiments of particular techniques. Certain features that are described in this patent document in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Moreover, the separation of various system components in the embodiments described in this patent document should not be understood as requiring such separation in all embodiments.

Only a few implementations and examples are described and other implementations, enhancements and variations can be made based on what is described and illustrated in this patent document.

A first component is directly coupled to a second component when there are no intervening components, except for a line, a trace, or another medium between the first component and the second component. The first component is indirectly coupled to the second component when there are intervening components other than a line, a trace, or another medium between the first component and the second component. The term “coupled” and its variants include both directly coupled and indirectly coupled. The use of the term “about” means a range including+10% of the subsequent number unless otherwise stated.

While several embodiments have been provided in the present disclosure, it should be understood that the disclosed systems and methods might be embodied in many other specific forms without departing from the spirit or scope of the present disclosure. The present examples are to be considered as illustrative and not restrictive, and the intention is not to be limited to the details given herein. For example, the various elements or components may be combined or integrated in another system or certain features may be omitted, or not implemented.

In addition, techniques, systems, subsystems, and methods described and illustrated in the various embodiments as discrete or separate may be combined or integrated with other systems, modules, techniques, or methods without departing from the scope of the present disclosure. Other items shown or discussed as coupled may be directly connected or may be indirectly coupled or communicating through some interface, device, or intermediate component whether electrically, mechanically, or otherwise. Other examples of changes, substitutions, and alterations are ascertainable by one skilled in the art and could be made without departing from the spirit and scope disclosed herein.

What is claimed is:

1. A method for processing video data, comprising:
performing a conversion between video data and a bitstream; and
applying at least one in-loop filtering tool to a filtering unit to process reconstructed samples within the filtering unit during the conversion, wherein a processing result of the at least one in-loop filtering tool is utilized to optimize generation of the bitstream or the video data.

2. The method of claim 1, wherein the filtering unit is an adaptive filtering unit, the adaptive filtering unit indicating a filtering unit which can be changed, wherein the adaptive filtering unit is used for the at least one in-loop filtering tool, and wherein the at least one in-loop filtering tool includes at least one of: adaptive loop filter (ALF), cross component ALF (CCALF), sample adaptive offset (SAO), cross component SAO (CCSAO), or bilateral filter (BF).

3. The method of claim 2, wherein a shape or a size of the filtering unit for the at least one in-loop filtering tool is signaled using at least one syntax element (SE) in a sequence parameter set (SPS), a picture parameter set (PPS), a picture header, a slice header, or a coding tree unit (CTU).

4. The method of claim 2, wherein when the adaptive filtering unit is used for the ALF, the adaptive filtering unit is only applied to luma component.

5. The method of claim 2, wherein when the adaptive filtering unit is used for the CCALF, the adaptive filtering unit is applied to both a blue difference chroma component (Cb) and a red difference chroma component (Cr).

6. The method of claim 2, wherein when the adaptive filtering unit is used for at least one of the ALF, the SAO, the CCSAO, or the BF, the adaptive filtering unit is applied to both luma component and chroma components.

7. The method of claim 2, wherein a width of the adaptive filtering unit is upscaled from a width of at least one of a coding tree unit (CTU), a coding unit (CU), a transform unit (TU), or a prediction unit (PU) by a first factor.

8. The method of claim 2, wherein a height of the adaptive filtering unit is upscaled from a height of a coding tree unit (CTU), a coding unit (CU), a transform unit (TU), or a prediction unit (PU) by a second factor.

9. The method of claim 2, wherein a width of the adaptive filtering unit is downscaled from a width of a coding tree unit (CTU), a coding unit (CU), a transform unit (TU), or a prediction unit (PU) by a third factor.

10. The method of claim 2, wherein a height of the adaptive filtering unit is downscaled from a height of a coding tree unit (CTU), a coding unit (CU), a transform unit (TU), or a prediction unit (PU) by a fourth factor.

11. The method of claim 2, wherein a size of the adaptive filtering unit is different for a different picture, different slice, or different tile with a different size or a different shape.

12. The method of claim 2, wherein a shape of the adaptive filtering unit is different for a different picture, different slice, or different tile with a different size or a different shape when the adaptive filtering unit is used for at least one of the ALF, the SAO, the CCSAO, or the BF, and
wherein the shape of the adaptive filtering unit is different for a different picture, different slice, or different tile with a different size when the adaptive filtering unit is used for the CCALF.

13. The method of claim 2, wherein the adaptive filtering unit has a square shape or a rectangle shape.

14. The method of claim 2, wherein an indication of whether each adaptive filtering unit is on or off is signaled in the bitstream, or derived, or pre-defined, and
wherein at least one of filter parameters, a parameter set, a parameter set index, or parameter settings for the at least one in-loop filtering tool is signaled in the bitstream, or derived, or pre-defined for each adaptive filtering unit.

15. The method of claim 2, wherein a parameter reference decision for the ALF or the CCALF is signaled in the bitstream, derived, or pre-defined for each adaptive filtering unit, and wherein the parameter reference decision comprises an adaptation parameter set (APS) index or a filter index, and
wherein the parameter reference decision for the SAO or the CCSAO is signaled in the bitstream, derived, or pre-defined for each adaptive filtering unit, and wherein the parameter reference decision comprises a merge left or a merge top.

16. The method of claim 2, wherein one or more syntax elements (SEs) are signaled in the bitstream, derived, or pre-defined to indicate whether the adaptive filtering unit is applied to the at least one in-loop filtering tool, and wherein the one or more SEs are signaled in a sequence parameter set (SPS).

17. The method of claim 1, wherein the conversion includes encoding the video data into the bitstream.

18. The method of claim 1, wherein the conversion includes decoding the video data from the bitstream.

19. An apparatus for processing video data comprising:
a processor; and
a non-transitory memory with instructions thereon, wherein the instructions upon execution by the processor, cause the processor to:
perform a conversion between video data and a bitstream; and
apply at least one in-loop filtering tool to a filtering unit to process reconstructed samples within the filtering unit during the conversion, wherein a processing result of the at least one in-loop filtering tool is utilized to optimize generation of the bitstream or the video data.

20. A non-transitory computer-readable recording medium storing a bitstream of a video which is generated by a method performed by a video processing apparatus, wherein the method comprises:
generating the bitstream from video data; and
applying at least one in-loop filtering tool to a filtering unit to process reconstructed samples within the filtering unit during the generation of the bitstream, wherein a processing result of the at least one in-loop filtering tool is utilized to optimize the generation of the bitstream.
